(19) United States
(12) Patent Application Publication
(10) Pub. No.: US 2005/0246682 A1
(43) Pub. Date: Nov. 3, 2005

(54) Behavioral abstractions for debugging coordination-centric software designs

(76) Inventor: Kenneth J. Hines, Bothell, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/096,425

(22) Filed: Jul. 15, 2005

Related U.S. Application Data
(62) Division of application No. 09/885,448, filed on Jun. 19, 2001.
(60) Provisional application No. 60/213,496, filed on Jun. 23, 2000.

(51) Int. Cl. G06F 9/44

(52) U.S. Cl. 717/109

(57) ABSTRACT

A behavioral abstraction is, in an abstract sense, a generalization of an event cluster. Behavioral abstraction is a technique where a predetermined behavioral sequence is automatically recognized by the simulator in a concurrent stream of system events. A behavioral sequence is at its most basic level a partial order of events. However, the events considered in a behavioral sequence are subject to configuration-based filtering and clustering. This allows a designer to create a model for a particular behavior and then set up a tool to find instances of the particular behavior in an execution trace. Behavior models are representations of partially ordered event sequences and can include events from several components.

### RELATED APPLICATIONS

This application is a continuations of U.S. Provisional Application No. 60/213,496 filed Jun. 23, 2000, incorporated herein by reference.

### TECHNICAL FIELD

The present invention relates to a system and method for debugging concurrent software systems.

### BACKGROUND OF THE INVENTION

A system design and programming methodology is most effective when it is closely integrated and coheres tightly with its corresponding debugging techniques. In distributed and embedded system methodologies, the relationship between debugging approaches and design methodologies has traditionally been one-sided in favor of the design and programming methodologies. Design and programming methodologies are typically developed without any consideration for the debugging techniques that will later be applied to software systems designed using that design and programming methodology. While these typical debugging approaches attempt to exploit features provided by the design and programming methodologies, the debugging techniques will normally have little or no impact on what the design and programming features are in the first place. This lack of input from debugging approaches to design and programming methodologies serves to maintain the role of debugging as an afterthought, even though in a typical system design, debugging consumes a majority of the design time. The need remains for a design and programming methodology that reflects input from, and consideration of, potential debugging approaches in order to enhance the design and reduce the implementation time of software systems.

1. Packaging of Software Elements

Packaging refers to the set of interfaces a software element presents to other elements in a system. Software packaging has many forms in modern methodologies. Some examples are programming language procedure call interfaces (as with libraries), TCP/IP socket interfaces with scripting languages (as with mail and Web servers), and file formats. Several typical prior art packaging styles are described below, beginning with packaging techniques used in object-oriented programming languages and continuing with a description of more generalized approaches to packaging.

A. Object-Oriented Approaches to Packaging

One common packaging style is based on object-oriented programming languages and provides procedure-based (method-based) packaging for software elements (objects within this framework). These procedure-based packages allow polymorphism (in which several types of objects can have identical interfaces) through subtyping, and code sharing through inheritance (deriving a new class of objects from an already existing class of objects). In a typical object-oriented programming language, an object's interface is defined by the object's methods.

Object-oriented approaches are useful in designing concurrent systems (systems with task level parallelism and multiple processing resources?) because of the availability of active objects (objects with a thread of control). Some common, concurrent object-oriented approaches are shown in actor languages and in concurrent Eiffel.

Early object-oriented approaches featured anonymity of objects through dynamic typechecking. This anonymity of objects meant that a first object did not need to know anything about a second object in order to send a message to the second object. One unfortunate result of this anonymity of objects was that the second object could unexpectedly respond to the first object that the sent message was not understood, resulting in a lack of predictability, due to this disruption of system executions, for systems designed with this object-oriented approach.

Most modern object-oriented approaches opt to sacrifice the benefits flowing from anonymity of objects in order to facilitate stronger static typing (checking to ensure that objects will properly communicate with one another before actually executing the software system). The main result of stronger static typing is improved system predictability. However, an unfortunate result of sacrificing the anonymity of objects is a tighter coupling between those objects, whereby each object must explicitly classify, and include knowledge about, other objects to which it sends messages. In modern object-oriented approaches the package (interface) has become indistinguishable from the object and the system in which the object is a part.

The need remains for a design and programming methodology that combines the benefits of anonymity for the software elements with the benefits derived from strong static typing of system designs.

B. Other Approaches to Packaging

Other packaging approaches provide higher degrees of separation between software elements and their respective packages than does the packaging in object-oriented systems. For example, the packages in event-based frameworks are interfaces with ports for transmitting and receiving events. These provide loose coupling for interelement communication. However, in an event-based framework, a software designer must explicitly implement interelement state coherence between software elements as communication between those software elements. This means that a programmer must perform the error-prone task of designing, optimizing, implementing, and debugging a specialized communication protocol for each state coherence requirement in a particular software system.

The common object request broker architecture (CORBA) provides an interface description language (IDL) for building packages around software elements written in a variety of languages. These packages are remote procedure call (RPC) based and provide no support for coordinating state between elements. With flexible packaging, an element's package is implemented as a set of co-routines that can be adapted for use with applications through use of adapters with interfaces complementary to the interface for the software element. These adapters can be application-specific-used only when the elements are composed into a system.

The use of co-routines lets a designer specify transactions or sequences of events as part of an interface, rather than just as atomic events. Unfortunately, co-routines must be executed in lock-step, meaning a transition in one routine corresponds to a transition in the other co-routine. If there is an error in one or if an expected event is lost, the interface will fail because its context will be incorrect to recover from the lost event and the co-routines will be out of sync.

The need remains for a design and programming methodology that provides software packaging that supports the implementation of state coherence in distributed concurrent systems without packaging or interface failure when an error or an unexpected event occurs.

2. Approaches to Coordination

Coordination, within the context of this application, means the predetermined ways through which software components interact. In a broader sense, coordination refers to a methodology for composing concurrent components into a complete system. This use of the term coordination differs slightly from the use of the term in the parallelizing compiler literature, in which coordination refers to a technique for maintaining programwide semantics for a sequential program decomposed into parallel subprograms.

A. Coordination Languages

Coordination languages are usually a class of tuple-space programming languages, such as Linda. A tuple is a data object containing two or more types of data that are identified by their tags and parameter lists. In tuple-space languages, coordination occurs through the use of tuple spaces, which are global multisets of tagged tuples stored in shared memory. Tuple-space languages extend existing programming languages by adding six operators: out, in, read, eval, inp, and readp. The out, in, and read operators place, fetch and remove, and fetch without removing tuples from tuple space. Each of these three operators blocks until its operation is complete. The out operator creates tuples containing a tag and several arguments. Procedure calls can be included in the arguments, but since out blocks, the calls must be performed and the results stored in the tuple before the operator can return.

The operators eval, inp, and readp are nonblocking versions of out, in, and read, respectively. They increase the expressive power of tuple-space languages. Consider the case of eval, the nonblocking version of out. Instead of evaluating all arguments of the tuple before returning, it spawns a thread to evaluate them, creating, in effect, an active tuple (whereas tuples created by out are passive). As with out, when the computation is finished, the results are stored in a passive tuple and left in tuple space. Unlike out, however, the eval call returns immediately, so that several active tuples can be left outstanding.

Tuple-space coordination can be used in concise implementations of many common interaction protocols. Unfortunately, tuple-space languages do not separate coordination issues from programming issues. Consider the annotated Linda implementation of RPC in Listing 1.

Listing 1: Linda used to emulate RPC:

| | |
|---|---|
| rpcCall(args) { | /* C */ |
| out(“RPCToServer”, “Client”, args...); | |
| in(“Client, “ReturnFromServer”, &returnValue); | |
| return returnValue; | /* C */ |
| } | /* C */ |
| Server: | |
| ... | |
| while(true) { | /* C */ |
| in(“RPCToServer”, &returnAddress, args...); | |
| returnValue = functionCall(args); | /* C */ |
| out(returnAddress, “ReturnFromServer”, returnValue); | |
| } | /* C */ |

Although the implementation depicted in Listing 1 is a compact representation of an RPC protocol, the implementation still depends heavily on an accompanying programming language (in this case, C). This dependency prevents designers from creating a new Linda RPC operator for arbitrary applications of RPC. Therefore, every time a designer uses Linda for RPC, they must copy the source code for RPC or make a C-macro. This causes tight coupling, because the client must know the name of the RPC server. If the server name is passed in as a parameter, flexibility increases; however, this requires a binding phase in which the name is obtained and applied outside of the Linda framework.

The need remains for a design and programming methodology that allows implementation of communication protocols without tight coupling between the protocol implementation and the software elements with which the protocol implementation works.

A tuple space can require large quantities of dynamically allocated memory. However, most systems, and especially embedded systems, must operate within predictable and sometimes small memory requirements. Tuple-space systems are usually not suitable for coordination in systems that must operate within small predictable memory requirements because once a tuple has been generated, it remains in tuple space until it is explicitly removed or the software element that created it terminates. Maintaining a global tuple space can be very expensive in terms of overall system performance. Although much work has gone into improving the efficiency of tuple-space languages, system performance remains worse with tuple-space languages than with message-passing techniques.

The need remains for a design and programming methodology that can effectively coordinate between software elements while respecting performance and predictable memory requirements.

B. Fixed Coordination Models

In tuple-space languages, much of the complexity of coordination remains entangled with the functionality of computational elements. An encapsulating coordination formalism decouples intercomponent interactions from the computational elements.

This type of formalism can be provided by fixed coordination models in which the coordination style is embodied in an entity and separated from computational concerns. Synchronous coordination models coordinate activity through relative schedules. Typically, these approaches require the coordination protocol to be manually constructed in advance. In addition, computational elements must be tailored to the coordination style used for a particular system (which may require intrusive modification of the software elements).

The need remains for a design and programming methodology that allows for coordination between software elements without tailoring the software elements to the specific coordination style used in a particular software system while allowing for interactions between software elements is a way that facilitates debugging complex systems.

### SUMMARY OF THE INVENTION

A behavioral abstraction is, in an abstract sense, a generalization of an event cluster. Behavioral abstraction is a technique where a predetermined behavioral sequence is automatically recognized by the simulator in a concurrent stream of system events. A behavioral sequence is at its most basic level a partial order of events. However, the events considered in a behavioral sequence are subject to configuration-based filtering and clustering. This allows a designer to create a model for a particular behavior and then set up a tool to find instances of the particular behavior in an execution trace. Behavior models are representations of partially ordered event sequences and can include events from several components.

In the coordination-centric design methodology, designers can model behaviors in a number of ways. One system for modeling behavior involves the use of a visual prototype, which is a user-specified evolution diagram. A second system for modeling behavior involves the use of a behavioral expression, which is similar to a regular expression but contains additional information relating to concurrent system behaviors.

Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 is a component in accordance with the present invention.

FIG. 2 is the component of FIG. 1 further having a set of coordination interfaces.

FIG. 3A is a prior art round-robin resource allocation protocol with a centralized controller.

FIG. 3B is a prior art round-robin resource allocation protocol implementing a token passing scheme.

FIG. 4A is a detailed view of a component and a coordination interface connected to the component for use in round-robin resource allocation in accordance with the present invention.

FIG. 4B depicts a round-robin coordinator in accordance with the present invention.

FIG. 5 shows several typical ports for use in a coordination interface in accordance with the present invention.

FIG. 6A is a unidirectional data transfer coordinator in accordance with the present invention.

FIG. 6B is a bidirectional data transfer coordinator in accordance with the present invention.

FIG. 6C is a state unification coordinator in accordance with the present invention.

FIG. 6D is a control state mutex coordinator in accordance with the present invention.

FIG. 7 is a system for implementing subsumption resource allocation having components, a shared resource, and a subsumption coordinator.

FIG. 8 is a barrier synchronization coordinator in accordance with the present invention.

FIG. 9 is a rendezvous coordinator in accordance with the present invention.

FIG. 10 depicts a dedicated RPC system having a client, a server, and a dedicated RPC coordinator coordinating the activities of the client and the server.

FIG. 11 is a compound coordinator with both preemption and round-robin coordination for controlling the access of a set of components to a shared resource.

FIG. 12A is software system with two data transfer coordinators, each having constant message consumption and generation rules and each connected to a separate data-generating component and connected to the same data-receiving component.

FIG. 12B is the software system of FIG. 12A in which the two data transfer coordinators have been replaced with a merged data transfer coordinator.

FIG. 13 is a system implementing a first come, first served resource allocation protocol in accordance with the present invention.

FIG. 14 is a system implementing a multiclient RPC coordination protocol formed by combining the first come, first served protocol of FIG. 13 with the dedicated RPC coordinator of FIG. 10.

FIG. 15 depicts a large system in which the coordination-centric design methodology can be employed having a wireless device interacting with a cellular network.

FIG. 16 shows a top-level view of the behavior and components for a system for a cell phone.

FIG. 17A is a detailed view of a GUI component of the cell phone of FIG. 16.

FIG. 17B is a detailed view of a call log component of the cell phone of FIG. 16.

FIG. 18A is a detailed view of a voice subsystem component of the cell phone of FIG. 16.

FIG. 18B is a detailed view of a connection component of the cell phone of FIG. 16.

FIG. 19 depicts the coordination layers between a wireless device and a base station, and between the base station and a switching center, of FIG. 15.

FIG. 20 depicts a cell phone call management component, a master switching center call management component, and a call management coordinator connecting the respective call management components.

FIG. 21A is a detailed view of a transport component of the connection component of FIG. 18B.

FIG. 21B is a CDMA data modulator of the transport component of FIG. 18B.

FIG. 22 is a detailed view of a typical TDMA and a typical CDMA signal for the cell phone of FIG. 16.

FIG. 23A is a LCD touch screen component for a Web browser GUI for a wireless device.

FIG. 23B is a Web page formatter component for the Web browser GUI for the wireless device.

FIG. 24A is a completed GUI system for a handheld Web browser.

FIG. 24B shows the GUI system for the handheld Web browser combined with the connection subsystem of FIG. 18B in order to access the cellular network of FIG. 15.

FIG. 25 is a typical space/time diagram with space represented on a vertical axis and time represented on a horizontal axis.

FIG. 26 is a space/time diagram depicting a set of system events and two different observations of those system events.

FIG. 27 is a space/time diagram depicting a set of system events and an ideal observation of the events taken by a real-time observer.

FIG. 28 is a space/time diagram depicting two different yet valid observations of a system execution.

FIG. 29 is a space/time diagram depicting a system execution and an observation of that execution take by a discrete lamport observer.

FIG. 30 is a space/time diagram depicting a set of events that each include a lamport time stamp.

FIG. 31 is a space/time diagram illustrating the insufficiency of scalar timestamps to characterize causality between events.

FIG. 32 is a space/time diagram depicting a set of system events that each a vector time stamp.

FIG. 33 depicts a display from a partial order event tracer (POET).

FIG. 34 is a space/time diagram depicting two compound events that are neither causal nor concurrent.

FIG. 35 is a POET display of two convex event clusters.

FIG. 36 is a basis for distributed event environments (BEE) abstraction facility for a single client.

FIG. 37 is a hierarchical tree construction of process clusters.

FIG. 38A depicts a qualitative measure of cohesion and coupling between a set of process clusters that have heavy communication or are instantiated from the same source code.

FIG. 38B depicts a qualitative measure of cohesion and coupling between a set of process clusters that do not have heavy communication or are not instances of the same source code.

FIG. 38C depicts a qualitative measure of cohesion and coupling between an alternative set of process clusters that have heavy communication or are instantiated from the same source code.

FIG. 39 depicts a consistent and an inconsistent cut of a system execution on a space/time diagram.

FIG. 40A is a space/time diagram depicting a system execution.

FIG. 40B is a lattice representing all possible consistent cuts of the space/time diagram of FIG. 40A.

FIG. 40C is a graphical representation of the possible consistent cuts of FIG. 40B.

FIG. 41A is a space/time diagram depicting a system execution.

FIG. 41B is the space/time diagram of FIG. 41A after performing a global-step.

FIG. 41C is the space/time diagram of FIG. 41A after performing a step-over.

FIG. 41D is the space/time diagram of FIG. 41A after performing a step-in.

FIG. 42 is a space/time diagram depicting a system that is subject to a domino effect whenever the system is rolled back in time to a checkpoint.

FIG. 56A depicts an initiate call transaction for a cell phone system designed using the coordination centric design methodology.

FIG. 56B depicts a visual prototype for the initiate call transaction of FIG. 56A.

FIG. 57A depicts a selection of events and state changes that determine a system behavior.

FIG. 57B depicts refining the system behavior of FIG. 57A.

FIG. 57C depicts the system behavior of FIG. 57B represented as a single event during a subsequent system execution.

FIG. 58A depicts a non-convex set of abstract events.

FIG. 58B shows a causal relationship between the abstract events of FIG. 58A.

FIG. 59A illustrates causal intermediates in interactions between a set of leaf components.

FIG. 59B depicts the system of FIG. 59A with processes and events clustered to show a causal relationship between two of the leaf components.

FIG. 60A depicts a visual prototype of the initiate call transaction of FIG. 56A.

FIG. 60B depicts an event graph for the visual prototype of FIG. 60A.

FIG. 60C depicts the event graph of FIG. 60B with causally redundant edges removed.

FIG. 60D depicts the event graph of FIG. 60C with events clustered according to progressive concurrence.

FIG. 61 is a space/time graph that illustrates that event causality does not always follow event parse order.

FIG. 62 depicts several automata segments along with the behavioral operator corresponding to each automata segment.

FIG. 63A depicts a full system of behavioral automata.

FIG. 63B depicts a generalized behavioral automata of the full system automata of FIG. 63A.

FIG. 64A depicts three behavioral expressions.

FIG. 64B depicts the automatons corresponding to the behavioral expression of FIG. 64A.

FIG. 64C is a space/time diagram of the system described in FIGS. 64A and 64B.

FIG. 65A is a space/time diagram of a system with branching behavior.

FIG. 65B is a behavioral automata for the system of FIG. 65A.

FIG. 66A is a space time diagram of system with branching behavior.

FIG. 66B is a behavioral automata for one branch of the system in FIG. 66A.

### DETAILED DESCRIPTION OF PREFERRED EMBODIMENTS

Coordination-Centric Software Design

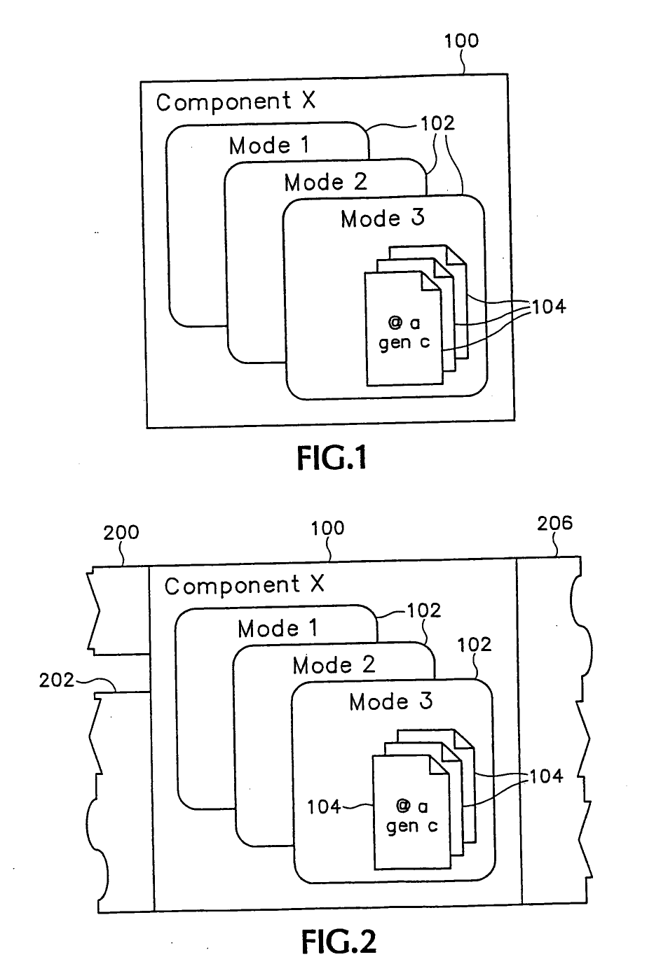

FIG. 1 is an example of a component 100, which is the basic software element within the coordination-centric design framework, in accordance with the present invention. With reference to FIG. 1, component 100 contains a set of modes 102. Each mode 102 corresponds to a specific behavior associated with component 100. Each mode 102 can either be active or inactive, respectively enabling or disabling the behavior corresponding to that mode 102. Modes 102 can make the conditional aspects of the behavior of component 100 explicit. The behavior of component 100 is encapsulated in a set of actions 104, which are discrete, event-triggered behavioral elements within the coordination-centric design methodology. Component 100 can be copied and the copies of component 100 can be modified, providing the code-sharing benefits of inheritance.

Actions 104 are enabled and disabled by modes 102, and hence can be thought of as effectively being properties of modes 102. An event (not shown) is an instantaneous condition, such as a timer tick, a data departure or arrival, or a mode change. Actions 104 can activate and deactivate modes 102, thereby selecting the future behavior of component 100. This is similar to actor languages, in which methods are allowed to replace an object's behavior.

In coordination-centric design, however, all possible behaviors must be identified and encapsulated before runtime. For example, a designer building a user interface component for a cell phone might define one mode for looking up numbers in an address book (in which the user interface behavior is to display complete address book entries in formatted text) and another mode for displaying the status of the phone (in which the user interface behavior is to graphically display the signal power and the battery levels of the phone). The designer must define both the modes and the actions for the given behaviors well before the component can be executed.

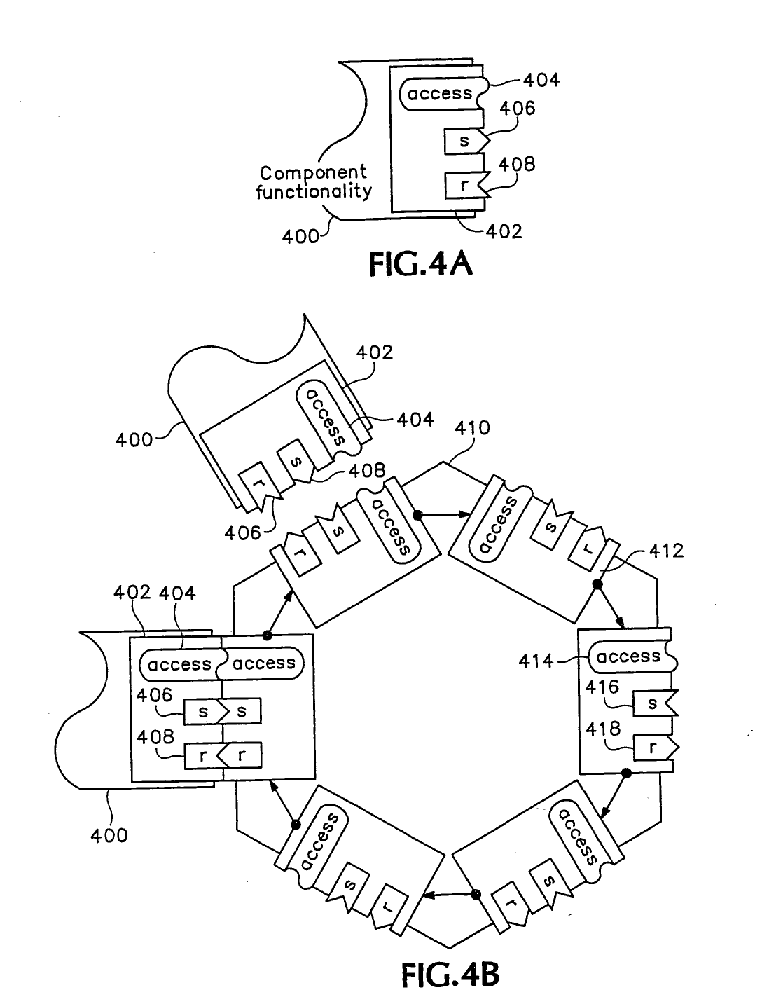

FIG. 2 is component 100 further including a first coordination interface 200, a second coordination interface 202, and a third coordination interface 204. Coordination-centric design's components 100 provide the code-sharing capability of object-oriented inheritance through copying. Another aspect of object-oriented inheritance is polymorphism through shared interfaces. In object-oriented languages, an object's interface is defined by its methods. Although coordination-centric design's actions 104 are similar to methods in object-oriented languages, they do not define the interface for component 100. Components interact through explicit and separate coordination interfaces, in this figure coordination interfaces 200, 202, and 204. The shape of coordination interfaces 200, 202, and 204 determines the ways in which component 100 may be connected within a software system. The way coordination interfaces 200, 202, and 204 are connected to modes 102 and actions 104 within component 100 determines how the behavior of component 100 can be managed within a system. Systemwide behavior is managed through coordinators (see FIG. 4B and subsequent).

For our approach to be effective, several factors in the design of software elements must coincide: packaging, internal organization, and how elements coordinate their behavior. Although these are often treated as independent issues, conflicts among them can exacerbate debugging. We handle them in a unified framework that separates the internal activity from the external relationship of component 100. This lets designers build more modular components and encourages them to specify distributable versions of coordination protocols. Components can be reused in a variety of contexts, both distributed, and single processor.

1. Introduction to Coordination

Within this application, coordination refers to the predetermined ways by which components interact. Consider a common coordination activity: resource allocation. One simple protocol for this is round-robin: participants are lined up, and the resource is given to each participant in turn. After the last participant is served, the resource is given back to the first. There is a resource-scheduling period during which each participant gets the resource exactly once, whether or not it is needed.

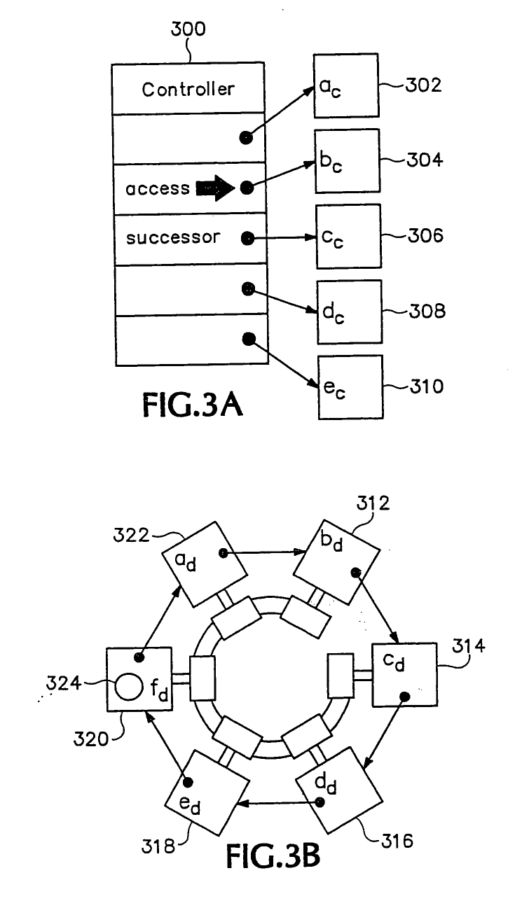

FIG. 3A is prior art round-robin resource allocation protocol with a centralized controller 300, which keeps track of and distributes the shared resource (not shown) to each of software elements 302, 304, 306, 308, and 310 in turn. With reference to FIG. 3A, controller 300 alone determines which software element 302, 304, 306, 308, or 310 is currently allowed to use the resource and which has it next. This implementation of a round-robin protocol permits software elements 302, 304, 306, 308, and 310 to be modular, because only controller 300 keeps track of the software elements. Unfortunately, when this implementation is implemented on a distributed architecture (not shown), controller 300 must typically be placed on a single processing element (not shown). As a result, all coordination requests must go through that processing element, which can cause a communication performance bottleneck. For example, consider the situation in which software elements 304 and 306 are implemented on a first processing element (not shown) and controller 300 is implemented on a second processing element. Software element 304 releases the shared resource and must send a message indicating this to controller 300. Controller 300 must then send a message to software element 306 to inform software element 306 that it now has the right to the shared resource. If the communication channel between the first processing element and the second processing element is in use or the second processing element is busy, then the shared resource must remain idle, even though both the current resource holder and the next resource holder (software elements 304 and 306 respectively) are implemented on the first processing element (not shown). The shared resource must typically remain idle until communication can take place and controller 300 can respond. This is an inefficient way to control access to a shared resource.

FIG. 3B is a prior art round-robin resource allocation protocol implementing a token passing scheme. With reference to FIG. 3B, this system consists of a shared resource 311 and a set of software elements 312, 314, 316, 318, 320, and 322. In this system a logical token 324 symbolizes the right to access resource 311, i.e., when a software element holds token 324, it has the right to access resource 311. When one of software elements 312, 314, 316, 318, 320, or 322 finishes with resource 311, it passes token 324, and with token 324 the access right, to a successor. This implementation can be distributed without a centralized controller, but as shown in FIG. 3B, this is less modular, because it requires each software element in the set to keep track of a successor.

Not only must software elements 312, 314, 316, 318, 320, and 322 keep track of successors, but each must implement a potentially complicated and error-prone protocol for transferring token 324 to its successor. Bugs can cause token 324 to be lost or introduce multiple tokens 324. Since there is no formal connection between the physical system and complete topology maps (diagrams that show how each software element is connected to others within the system), some software elements might erroneously be serviced more than once per cycle, while others are completely neglected. However, these bugs can be extremely difficult to track after the system is completed. The protocol is entangled with the functionality of each software element, and it is difficult to separate the two for debugging purposes. Furthermore, if a few of the software elements are located on the same machine, performance of the implementation can be poor. The entangling of computation and coordination requires intrusive modification to optimize the system.

2. Coordination-Centric Design's Approach to Coordination

The coordination-centric design methodology provides an encapsulating formalism for coordination. Components such as component 100 interact using coordination interfaces, such as first, second, and third coordination interfaces 200, 202, and 204, respectively. Coordination interfaces preserve component modularity while exposing any parts of a component that participate in coordination. This technique of connecting components provides polymorphism in a similar fashion to subtyping in object-oriented languages.

FIG. 4A is a detailed view of a component 400 and a resource access coordination interface 402 connected to component 400 for use in a round-robin coordination protocol in accordance with the present invention. With reference to FIG. 4A, resource access coordination interface 402 facilitates implementation of a round-robin protocol that is similar to the token-passing round-robin protocol described above. Resource access coordination interface 402 has a single bit of control state, called access, which is shown as an arbitrated control port 404 that indicates whether or not component 400 is holding a virtual token (not shown). Component 400 can only use a send message port 406 on access coordination interface 402 when arbitrated control port 404 is true. Access coordination interface 402 further has a receive message port 408.

FIG. 4B show a round-robin coordinator 410 in accordance with the present invention. With reference to FIG. 4B, round-robin coordinator 410 has a set of coordinator coordination interfaces 412 for connecting to a set of components 400. Each component 400 includes a resource access coordination interface 402. Each coordinator coordination interface 412 has a coordinator arbitrated control port 414, an incoming send message port 416 and an outgoing receive message port 418. Coordinator coordination interface 412 in complimentary to resource access coordination interface 402, and vice versa, because the ports on the two interfaces are compatible and can function to transfer information between the two interfaces.

The round-robin protocol requires round-robin coordinator 410 to manage the coordination topology. Round-robin coordinator 410 is an instance of more general abstractions called coordination classes, in which coordination classes define specific coordination protocols and a coordinator is a specific implementation of the coordination class. Round-robin coordinator 410 contains all information about how components 400 are supposed to coordinate. Although round-robin coordinator 410 can have a distributed implementation, no component 400 is required to keep references to any other component 400 (unlike the distributed round-robin implementation shown in FIG. 3B). All required references are maintained by round-robin coordinator 410 itself, and components 400 do not even need to know that they are coordinating through round-robin. Resource access coordination interface 402 can be used with any coordinator that provides the appropriate complementary interface. A coordinator's design is independent of whether it is implemented on a distributed platform or on a monolithic single processor platform.

3. Coordination Interfaces

Coordination interfaces are used to connect components to coordinators. They are also the principle key to a variety of useful runtime debugging techniques. Coordination interfaces support component modularity by exposing all parts of the component that participate in the coordination protocol. Ports are elements of coordination interfaces, as are guarantees and requirements, each of which will be described in turn.

A. Ports

A port is a primitive connection point for interconnecting components. Each port is a five-tuple (T; A; Q; D; R) in which:
T represents the data type of the port. T can be one of int, boolean, char, byte, float, double, or cluster, in which cluster represents a cluster of data types (e.g., an int followed by a float followed by two bytes).
A is a boolean value that is true if the port is arbitrated and false otherwise.
Q is an integer greater than zero that represents logical queue depth for a port.
D is one of in, out, inout, or custom and represents the direction data flows with respect to the port.
R is one of discard-on-read, discard-on-transfer, or hold and represents the policy for data removal on the port. Discard-on-read indicates that data is removed immediately after it is read (and any data in the logical queue are shifted), discard-on-transfer indicates that data is removed from a port immediately after being transferred to another port, and hold indicates that data should be held until it is overwritten by another value.

Hold is subject to arbitration.

Custom directionality allows designers to specify ports that accept or generate only certain specific values. For example, a designer may want a port that allows other components to activate, but not deactivate, a mode. While many combinations of port attributes are possible, we normally encounter only a few. The three most common are message ports (output or input), state ports (output, input, or both; sometimes arbitrated), and control ports (a type of state port). FIG. 5 illustrates the visual syntax used for several common ports throughout this application. With reference to FIG. 5, this figure depicts an exported state port 502, an imported state port 504, an arbitrated state port 506, an output data port 508, and an input data port 510.

1. Message Ports

Message ports (output and input) data ports 508 and 510 respectively) are either send (T; false; 1; out; discard-on-transfer) or receive (T; false; Q; in; discard-on-read). Their function is to transfer data between components. Data passed to a send port is transferred immediately to the corresponding receive port, thus it cannot be retrieved from the send port later. Receive data ports can have queues of various depths. Data arrivals on these ports are frequently used to trigger and pass data parameters into actions. Values remain on receive ports until they are read.

2. State Ports

State ports take one of three forms:
1. (T; false; 1; out; hold)
2. (T; false; 1; in; hold)
3. (T; true; 1; inout; hold)

State ports, such as exported state port 502, imported state port 504, and arbitrated state port 506, hold persistent values, and the value assigned to a state port may be arbitrated. This means that, unlike message ports, values remain on the state ports until changed. When multiple software elements simultaneously attempt to alter the value of arbitrated state port 506, the final value is determined based on arbitration rules provided by the designer through an arbitration coordinator (not shown).

State ports transfer variable values between scopes. In coordination-centric design, all variables referenced by a component are local to that component, and these variables must be explicitly declared in the component's scope. Variables can, however, be bound to state ports that are connected to other components. In this way a variable value can be transferred between components and the variable value achieves the system-level effect of a multivariable.

3. Control Ports

Control ports are similar to state ports, but a control port is limited to having the boolean data type. Control ports are typically bound to modes. Actions interact with a control port indirectly, by setting and responding to the values of a mode that is bound to the control port.

For example, arbitrated control port 404 shown in FIG. 4A is a control port that can be bound to a mode (not shown) containing all actions that send data on a shared channel. When arbitrated control port 404 is false, the mode is inactive, disabling all actions that send data on the channel.

B. Guarantees

Guarantees are formal declarations of invariant properties of a coordination interface. There can be several types of guarantees, such as timing guarantees between events, guarantees between control state (e.g., state A and state B are guaranteed to be mutually exclusive), etc. Although a coordination interface's guarantees reflect properties of the component to which the coordination interface is connected, the guarantees are not physically bound to any internal portions of the component. Guarantees can often be certified through static analysis of the software system. Guarantees are meant to cache various properties that are inherent in a component or a coordinator in order to simplify static analysis of the software system.

A guarantee is a promise provided by a coordination interface. The guarantee takes the form of a predicate promised to be invariant. In principle, guarantees can include any type of predicate (e.g., x>3, in which x is an integer valued state port, or tₑₐ−t_{eb}<2 ms). Throughout the remainder of this application, guarantees will be only event-ordering guarantees (guarantees that specify acceptable orders of events) or control-relationship guarantees (guarantees pertaining to acceptable relative component behaviors).

C. Requirements

A requirement is a formal declaration of the properties necessary for correct software system functionality. An example of a requirement is a required response time for a coordination interface—the number of messages that must have arrived at the coordination interface before the coordination interface can transmit, or fire, the messages. When two coordination interfaces are bound together, the requirements of the first coordination interface must be conservatively matched by the guarantees of the second coordination interface (e.g., x<7 as a guarantee conservatively matches x<8 as a requirement). As with guarantees, requirements are not physically bound to anything within the component itself. Guarantees can often be verified to be sufficient for the correct operation of the software system in which the component is used. In sum, a requirement is a predicate on a first coordination interface that must be conservatively matched with a guarantee on a complementary second coordination interface.

D. Conclusion Regarding Coordination Interfaces

A coordination interface is a four-tuple (P; G; R; I) in which:
P is a set of named ports.
G is a set of named guarantees provided by the interface.
R is a set of named requirements that must be matched by guarantees of connected interfaces.
I is a set of named coordination interfaces.

As this definition shows, coordination interfaces are recursive. Coordinator coordination interface 412, shown in FIG. 4B, used for round-robin coordination is called AccessInterface and is defined in Table 1.

| Constituent | Value |
|---|---|
| Ports | P = { access:StatePort, s:outMessagePort, |
| | r:inMessagePort } |
| Guarantees | G = { [symbol] access [symbol] [symbol] s.gen } |
| Requirement | R = Ø |
| Interfaces | I = Ø |

Related to coordination interfaces is a recursive coordination interface descriptor, which is a five-tuple (Pₐ; Gₐ; Rₐ; I_{d}; N_{d}) in which:
Pₐ is a set of abstract ports, which are ports that may be incomplete in their attributes (i.e., they do not yet have a datatype).
Gₐ is a set of abstract guarantees, which are guarantees between abstract ports.
Rₐ is a set of abstract requirements, which are requirements between abstract ports.
I_{d} is a set of coordination interface descriptors.
N_{d} is an element of Q×Q, where Q={∞} ∪Z+ and Z+ denotes the set of positive integers. Nd indicates the number or range of numbers of permissible interfaces.

Allowing coordination interfaces to contain other coordination interfaces is a powerful feature. It lets designers use common coordination interfaces as complex ports within other coordination interfaces. For example, the basic message ports described above are nonblocking, but we can build a blocking coordination interface (not shown) that serves as a blocking port by combining a wait state port with a message port.

4. Coordinators

A coordinator provides the concrete representations of intercomponent aspects of a coordination protocol. Coordinators allow a variety of static analysis debugging methodologies for software systems created with the coordination-centric design methodology. A coordinator contains a set of coordination interfaces and defines the relationships between the coordination interfaces. The coordination interfaces complement the component coordination interfaces provided by components operating within the protocol. Through matched interface pairs, coordinators effectively describe connections between message ports, correlations between control states, and transactions between components.

For example, round-robin coordinator 410, shown in FIG. 4B, must ensure that only one component 400 has its component control port 404's value, or its access bit, set to true. Round-robin coordinator 410 must further ensure that the correct component 400 has its component control port 404 set to true for the chosen sequence. This section presents formal definitions of the parts that comprise coordinators: modes, actions, bindings, action triples, and constraints. These definitions culminate in a formal definition of coordinators.

A. Modes

A mode is a boolean value that can be used as a guard on an action. In a coordinator, the mode is most often bound to a control port in a coordination interface for the coordinator. For example, in round-robin coordinator 410, the modes of concern are bound to a coordinator control port 414 of each coordinator coordination interface 412.

B. Actions

An action is a primitive behavioral element that can:
Respond to events.
Generate events.
Change modes.

Actions can range in complexity from simple operations up to complicated pieces of source code. An action in a coordinator is called a transparent action because the effects of the action can be precomputed and the internals of the action are completely exposed to the coordination-centric design tools.

C. Bindings

Bindings connect input ports to output ports, control ports to modes, state ports to variables, and message ports to events. Bindings are transparent and passive. Bindings are simply conduits for event notification and data transfer. When used for event notification, bindings are called triggers.

D. Action Triples

To be executed, an action must be enabled by a mode and triggered by an event. The combination of a mode, trigger, and action is referred to as an action triple, which is a triple (m; t; a) in which:
m is a mode.
t is a trigger.
a is an action.

The trigger is a reference to an event type, but it can be used to pass data into the action. Action triples are written: mode: trigger: action

A coordinator's actions are usually either pure control, in which both the trigger and action performed affect only control state, or pure data, in which both the trigger and action performed occur in the data domain. In the case of round-robin coordinator 410, the following set of actions is responsible for maintaining the appropriate state:
accessᵢ: −accessᵢ: +access_{(i+1) mod n}

The symbol “+” signifies a mode's activation edge (i.e., the event associated with the mode becoming true), and the symbol “−” signifies its deactivation edge. When any coordinator coordination interface 412 deactivates its arbitrated control port 404's, access bit, the access bit of the next coordinator coordination interface 412 is automatically activated.

E. Constraints

In this application, constraints are boolean relationships between control ports. They take the form:
Condition [symbol] Effect
   This essentially means that the Condition (on the left side of the arrow) being true implies that Effect (on the right side of the arrow) is also true. In other words, if Condition is true, then Effect should also be true.

A constraint differs from a guarantee in that the guarantee is limited to communicating in-variant relationships between components without providing a way to enforce the in-variant relationship. The constraint, on the other hand, is a set of instructions to the runtime system dealing with how to enforce certain relationships between components. When a constraint is violated, two corrective actions are available to the system: (1) modify the values on the left-hand side to make the left-hand expression evaluate as false (an effect termed backpressure or (2) alter the right-hand side to make it true. We refer to these techniques as LHM (left-hand modify) and RHM (right-hand modify). For example, given the constraint x [symbol] [symbol] y and the value X [symbol] y, with RHM semantics the runtime system must respond by disabling y or setting y to false. Thus the value of [symbol] y is set to true.

The decision of whether to use LHM, to use RHM, or even to suspend enforcement of a constraint in certain situations can dramatically affect the efficiency and predictability of the software system. Coordination-centric design does not attempt to solve simultaneous constraints at runtime. Rather, runtime algorithms use local ordered constraint solutions. This, however, can result in some constraints being violated and is discussed further below.

Round-robin coordinator 410 has a set of safety constraints to ensure that there is never more than one token in the system:
accessᵢ [symbol] ∀_{j≠i} [symbol] accessⱼ

The above equation translates roughly as accessᵢ implies not accessⱼ for the set of all accessⱼ where j is not equal to i. Even this simple constraint system can cause problems with local resolution semantics (as are LHM and RHM). If the runtime system attempted to fix all constraints simultaneously, all access modes would be shut down. If they were fixed one at a time, however, any duplicate tokens would be erased on the first pass, satisfying all other constraints and leaving a single token in the system.

Since high-level protocols can be built from combinations of lower-level protocols, coordinators can be hierarchically composed. A coordinator is a six-tuple (I; M; B; N; A; X) in which:
I is a set of coordination interfaces.
M is a set of modes.
B is a set of bindings between interface elements (e.g., control ports and message ports) and internal elements (e.g., modes and triggers).
N is a set of constraints between interface elements.
A is a set of action triples for the coordinator.
X is a set of subcoordinators.

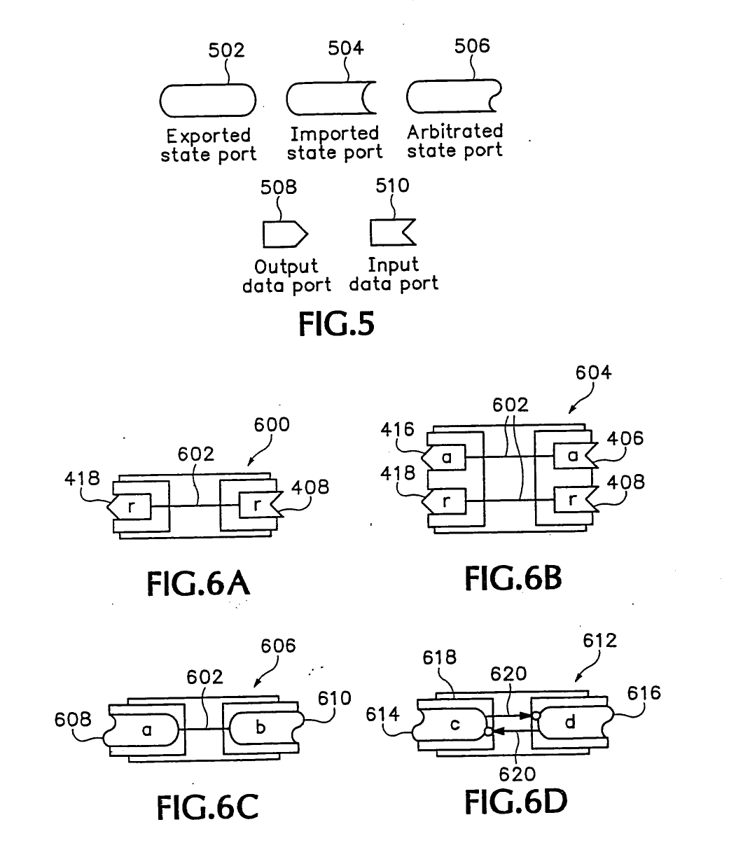

FIGS. 6A, 6B, 6C, and 6D show a few simple coordinators highlighting the bindings and constraints of the respective coordinators. With reference to FIG. 6A, a unidirectional data transfer coordinator 600 transfers data in one direction between two components (not shown) by connecting incoming receive message port 408 to outgoing receive message port 418 with a binding 602. With reference to FIG. 6B, bidirectional data transfer coordinator 604 transfers data back and forth between two components (not shown) by connecting incoming receive message port 408 to outgoing receive message port 418 with binding 602 and connecting send message port 406 to incoming send message port 416 with a second binding 602. Unidirectional data transfer coordinator 600 and bidirectional data transfer coordinator 604 simply move data from one message port to another. Thus each coordinator consists of bindings between corresponding ports on separate coordination interfaces.

With reference to FIG. 6C, state unification coordinator 606 ensures that a state port a 608 and a state port b 610 are always set to the same value. State unification coordinator 606 connects state port a 608 to state port b 610 with binding 602. With reference to FIG. 6D, control state mutex coordinator 612 has a first constraint 618 and a second constraint 620 as follows:
(1) c [symbol] [symbol] d and
(2) d [symbol] [symbol] c.
   Constraints 618 and 620 can be restated as follows:
(1) A state port c 614 having a true value implies that a state port d 616 has a false value, and
(2) State port d 616 having a true value implies that state port c 614 has a false value.

A coordinator has two types of coordination interfaces: up interfaces that connect the coordinator to a second coordinator, which is at a higher level of design hierarchy and down interfaces that connect the coordinator either to a component or to a third coordinator, which is at a lower level of design hierarchy. Down interfaces have names preceded with “˜”. Round-robin coordinator 410 has six down coordination interfaces (previously referred to as coordinator coordination interface 412), with constraints that make the turning off of any coordinator control port 414 (also referred to as access control port) turn on the coordinator control port 414 of the next coordinator coordination interface 412 in line. Table 2 presents all constituents of the round-robin coordinator.

| Constituent | Value |
|---|---|
| Coordination | I = AccessInterface₁₋₆ |
| interfaces | |
| Modes | M = access₁₋₆ |
| Bindings | B = ∀_{1≦i≦6}(˜AccessInterfaceᵢ.access, accessᵢ) ∪ |
| Constraints | N = ∀_{1≦i≦6}(∀_{(1≦j≦6)}_{(i≠j)} accessᵢ [symbol] [symbol] accessⱼ) |
| Actions | A = ∀_{1≦i≦6}accessᵢ: −accessᵢ: +access₍ᵢ₊₁₎ mod 6 |
| Subcoordinators | X = Ø |

This tuple describes an implementation of a round-robin coordination protocol for a particular system with six components, as shown in round-robin coordinator 410. We use a coordination class to describe a general coordination protocol that may not have a fixed number of coordinator coordination interfaces. The coordination class is a six-tuple (Ic; Mc; Bc; Nc; Ac; Xc) in which:
Ic is a set of coordination interface descriptors in which each descriptor provides a type of coordination interface and specifies the number of such interfaces allowed within the coordination class.
Mc is a set of abstract modes that supplies appropriate modes when a coordination class is instantiated with a fixed number of coordinator coordination interfaces.
Bc is a set of abstract bindings that forms appropriate bindings between elements when the coordination class is instantiated.
Nc is a set of abstract constraints that ensures appropriate constraints between coordination interface elements are in place as specified at instantiation.
Ac is a set of abstract action triples for the coordinator.
Xc is a set of coordination classes (hierarchy).

While a coordinator describes coordination protocol for a particular application, it requires many aspects, such as the number of coordination interfaces and datatypes, to be fixed. Coordination classes describe protocols across many applications. The use of the coordination interface descriptors instead of coordination interfaces lets coordination classes keep the number of interfaces and datatypes undetermined until a particular coordinator is instantiated. For example, a round-robin coordinator contains a fixed number of coordinator coordination interfaces with specific bindings and constraints between the message and state ports on the fixed number of coordinator coordination interfaces. A round-robin coordination class contains descriptors for the coordinator coordination interface type, without stating how many coordinator coordination interfaces, and instructions for building bindings and constraints between ports on the coordinator coordination interfaces when a particular round-robin coordinator is created.

5. Components

A component is a six-tuple (I; A; M; V; S; X) in which:
I is a set of coordination interfaces.
A is a set of action triples.
M is a set of modes.
V is a set of typed variables.
S is a set of subcomponents.
X is a set of coordinators used to connect the subcomponents to each other and to the coordination interfaces.

Actions within a coordinator are fairly regular, and hence a large number of actions can be described with a few simple expressions. However, actions within a component are frequently diverse and can require distinct definitions for each individual action. Typically a component's action triples are represented with a table that has three columns: one for the mode, one for the trigger, and one for the action code. Table 3 shows some example actions from a component that can use round-robin coordination.

| Mode | Trigger | Action |
|---|---|---|
| Access | tick | AccessInterface.s.send(“Test message”); |
| | | −access; |
| [symbol] access | tick | waitCount++; |

A component resembles a coordinator in several ways (for example, the modes and coordination interfaces in each are virtually the same). Components can have internal coordinators, and because of the internal coordinators, components do not always require either bindings or constraints. In the following subsections, various aspects of components are described in greater detail. Theses aspects of components include variable scope, action transparency, and execution semantics for systems of actions.

A. Variable Scope

To enhance a component's modularity, all variables accessed by an action within the component are either local to the action, local to the immediate parent component of the action, or accessed by the immediate parent component of the action via state ports in one of the parent component's coordination interfaces. For a component's variables to be available to a hierarchical child component, they must be exported by the component and then imported by the child of the component.

B. Action Transparency

An action within a component can be either a transparent action or an opaque action. Transparent and opaque actions each have different invocation semantics. The internal properties, i.e. control structures, variable, changes in state, operators, etc., of transparent actions are visible to all coordination-centric design tools. The design tools can separate, observe, and analyze all the internal properties of opaque actions. Opaque actions are source code. Opaque actions must be executed directly, and looking at the internal properties of opaque actions can be accomplished only through traditional, source-level debugging techniques. An opaque action must explicitly declare any mode changes and coordination interfaces that the opaque action may directly affect.

C. Action Execution

An action is triggered by an event, such as data arriving or departing a message port, or changes in value being applied to a state port. An action can change the value of a state port, generate an event, and provide a way for the software system to interact with low-level device drivers. Since actions typically produce events, a single trigger can be propagated through a sequence of actions.

6. Protocols Implemented with Coordination Classes

In this section, we describe several coordinators that individually implement some common protocols: subsumption, barrier synchronization, rendezvous, and dedicated RPC.

A. Subsumption Protocol

A subsumption protocol is a priority-based, preemptive resource allocation protocol commonly used in building small, autonomous robots, in which the shared resource is the robot itself.

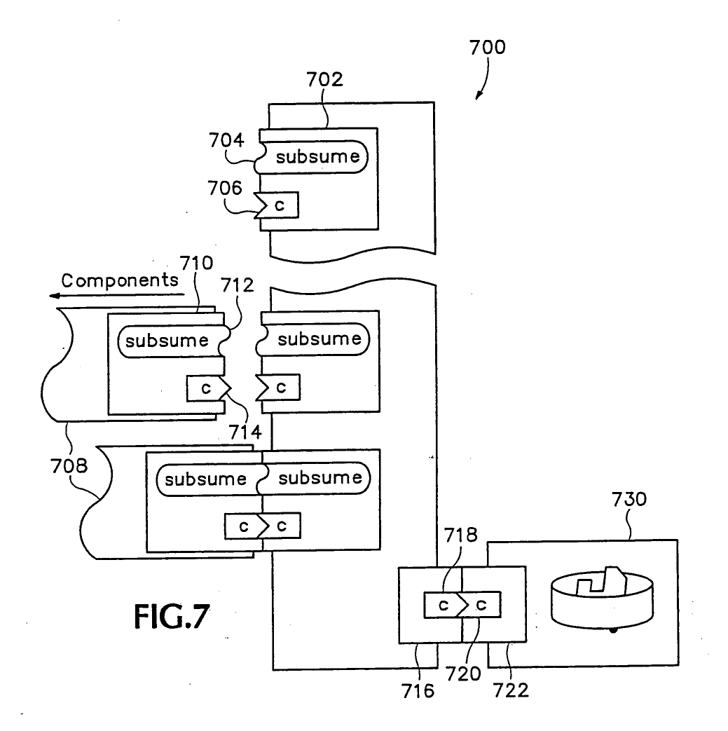

FIG. 7 shows a set of coordination interfaces and a coordinator for implementing the subsumption protocol. With reference to FIG. 7, a subsumption coordinator 700 has a set of subsumption coordinator coordination interfaces 702, which have a subsume arbitrated coordinator control port 704 and an incoming subsume message port 706. Each subsume component 708 has a subsume component coordination interface 710. Subsume component coordination interface 710 has a subsume arbitrated component control port 712 and an outgoing subsume message port 714. Subsumption coordinator 700 and each subsume component 708 are connected by their respective coordination interfaces, 702 and 710. Each subsumption coordinator coordination interface 702 in subsumption coordinator 700 is associated with a priority. Each subsume component 708 has a behavior that can be applied to a robot (not shown). At any time, any subsume component 708 can attempt to assert its behavior on the robot. The asserted behavior coming from the subsume component 708 connected to the subsumption coordinator coordination interface 702 with the highest priority is the asserted behavior that will actually be performed by the robot. Subsume components 708 need not know anything about other components in the system. In fact, each subsume component 708 is designed to perform independently of whether their asserted behavior is performed or ignored.

Subsumption coordinator 700 further has a slave coordinator coordination interface 716, which has an outgoing slave message port 718. Outgoing slave message port 718 is connected to an incoming slave message port 720. Incoming slave message port 720 is part of a slave coordination interface 722, which is connected to a slave 730. When a subsume component 708 asserts a behavior and that component has the highest priority, subsumption coordinator 700 will control slave 730 (which typically controls the robot) based on the asserted behavior.

The following constraint describes the basis of the subsumption coordinator 700's behavior:

$${subsume}_{p} ⇒ {{⩓}_{i = 1}}^{p - 1} ⫬ {subsume}_{i}$$

This means that if any subsume component 708 has a subsume arbitrated component control port 712 that has a value of true, then all lower-priority subsume arbitrated component control ports 712 are set to false. An important difference between round-robin and subsumption is that in round-robin, the resource access right is transferred only when surrendered. Therefore, round-robin coordination has cooperative release semantics. However, in subsumption coordination, a subsume component 708 tries to obtain the resource whenever it needs to and succeeds only when it has higher priority than any other subsume component 708 that needs the resource at the same time. A lower-priority subsume component 708 already using the resource must surrender the resource whenever a higher-priority subsume component 708 tries to access the resource. Subsumption coordination uses preemptive release semantics, whereby each subsume component 708 must always be prepared to relinquish the resource.

Table 4 presents the complete tuple for the subsumption coordinator.

| Constituent | Value |
|---|---|
| Coordination interfaces | I = (Subsume₁₋ₙ) ∪ (Output) |
| Modes | M = subsume₁₋ₙ |
| Bindings | B = ∀_{1≦i≦n} (Subsumeᵢ.subsume, subsumeᵢ) ∪ |
| Constraints | N = ∀_{1≦i≦n} (∀_{(1≦j≦i)} subsumeᵢ [symbol] [symbol] subsumeⱼ) |
| Actions | A = Ø |
| Subcoordinators | X = Ø |

B. Barrier Synchronization Protocol

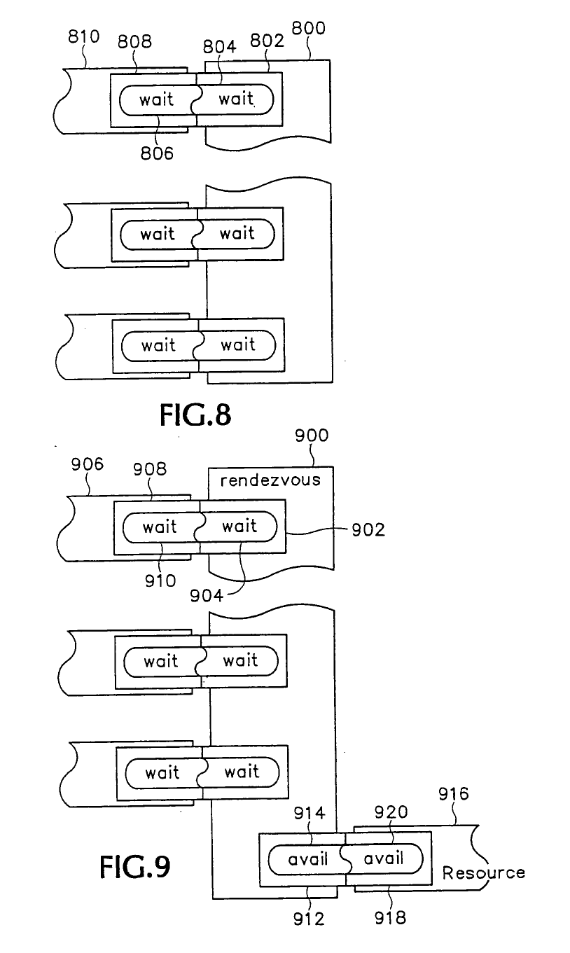

Other simple types of coordination that components might engage in enforce synchronization of activities. An example is barrier synchronization, in which each component reaches a synchronization point independently and waits. FIG. 8 depicts a barrier synchronization coordinator 800. With reference to FIG. 8, barrier synchronization coordinator 800 has a set of barrier synchronization coordination interfaces 802, each of which has a coordinator arbitrated state port 804, named wait. Coordinator arbitrated state port 804 is connected to a component arbitrated state port 806, which is part of a component coordination interface 808. Component coordination interface 808 is connected to a component 810. When all components 810 reach their respective synchronization points, they are all released from waiting. The actions for a barrier synchronization coordinator with n interfaces are:
Λwaitᵢ:: ∇_{0≦j<n}−waitⱼ
0≦i<n
   In other words, when all wait modes (not shown) become active, each one is released. The blank between the two colons indicates that the trigger event is the guard condition becoming true.

C. Rendezvous Protocol

A resource allocation protocol similar to barrier synchronization is called rendezvous. FIG. 9 depicts a rendezvous coordinator 900 in accordance with the present invention. With reference to FIG. 9, rendezvous coordinator 900 has a rendezvous coordination interface 902, which has a rendezvous arbitrated state port 904. A set of rendezvous components 906, each of which may perform different functions or have vastly different actions and modes, has a rendezvous component coordination interface 908, which includes a component arbitrated state port 910. Rendezvous components 906 connect to rendezvous coordinator 900 through their respective coordination interfaces, 908 and 902. Rendezvous coordinator 900 further has a rendezvous resource coordination interface 912, which has a rendezvous resource arbitrated state port 914, also called available. A resource 916 has a resource coordination interface 918, which has a resource arbitrated state port 920. Resource 916 is connected to rendezvous coordinator 900 by their complementary coordination interfaces, 918 and 912 respectively.

With rendezvous-style coordination, there are two types of participants: resource 916 and several resource users, here rendezvous components 916. When resource 916 is available, it activates its resource arbitrated state port 920, also referred to as its available control port. If there are any waiting rendezvous components 916, one will be matched with the resource; both participants are then released. This differs from subsumption and round-robin in that resource 916 plays an active role in the protocol by activating its available control port 920.

The actions for rendezvous coordinator 900 are:
availableᵢ [symbol] waitⱼ:: −availableᵢ, −waitⱼ

This could also be accompanied by other modes that indicate the status after the rendezvous. With rendezvous coordination, it is important that only one component at a time be released from wait mode.

D. Dedicated RPC Protocol

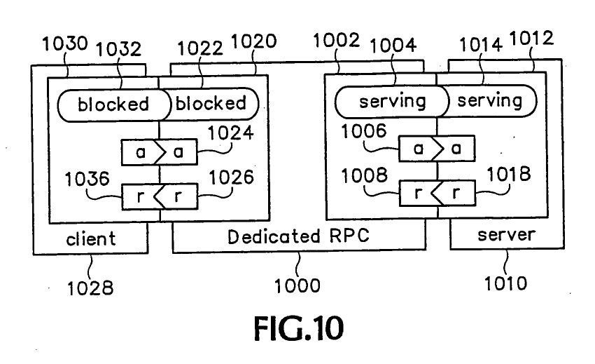

A coordination class that differs from those described above is dedicated RPC. FIG. 10 depicts a dedicated RPC system. With reference to FIG. 10, a dedicated RPC coordinator 1000 has an RPC server coordination interface 1002, which includes an RPC server imported state port 1004, an RPC server output message port 1006, and an RPC server input message port 1008. Dedicated RPC coordinator 1000 is connected to a server 1010. Server 1010 has a server coordination interface 1012, which has a server exported state port 1014, a server input data port 1016, and a server output data port 1018. Dedicated RPC coordinator 1000 is connected to server 1010 through their complementary coordination interfaces, 1002 and 1012 respectively. Dedicated RPC coordinator 1000 further has an RPC client coordination interface 1020, which includes an RPC client imported state port 1022, an RPC client input message port 1024, and an RPC client output message port 1026. Dedicated RPC coordinator 1000 is connected to a client 1028 by connecting RPC client coordination interface 1020 to a complementary client coordination interface 1030. Client coordination interface 1030 has a client exported state port 1032, a client output message port 1034, and a client input message port 1036.

The dedicated RPC protocol has a client/server protocol in which server 1010 is dedicated to a single client, in this case client 1028. Unlike the resource allocation protocol examples, the temporal behavior of this protocol is the most important factor in defining it. The following transaction listing describes this temporal behavior:

Client 1028 enters blocked mode by changing the value stored at client exported state port 1032 to true.

Client 1028 transmits an argument data message to server 1010 via client output message port 1034.

Server 1010 receives the argument (labeled “a”) data message via server input data port 1016 and enters serving mode by changing the value stored in server exported state port 1014 to true.

Server 1010 computes return value.

Server 1010 transmits a return (labeled “r”) message to client 1020 via server output data port 1018 and exits serving mode by changing the value stored in server exported state port 1014 to false.

Client 1028 receives the return data message via client input message port 1036 and exits blocked mode by changing the value stored at client exported state port 1032 to false.

This can be presented more concisely with an expression describing causal relationships:
T_{RPC}=+client.blocked→client.transmits→+server.serving→server.transmits→(−server.serving∥client.receives)→−client.blocked

The transactions above describe what is supposed to happen. Other properties of this protocol must be described with temporal logic predicates.
server.serving [symbol] client.blocked
server.serving [symbol] F(server.r.output)
server.a.input [symbol] F(server.serving)

The r in server.r.output refers to the server output data port 1018, also labeled as the r event port on the server, and the a in serving.a.input refers to server input data port 1016, also labeled as the a port on the server (see FIG. 10).

Together, these predicates indicate that (1) it is an error for server 1010 to be in serving mode if client 1028 is not blocked; (2) after server 1010 enters serving mode, a response message is sent or else an error occurs; and (3) server 1010 receiving a message means that server 1010 must enter serving mode. Relationships between control state and data paths must also be considered, such as:
(client.a [symbol] client.blocked)

In other words, client 1028 must be in blocked mode whenever it sends an argument message.

The first predicate takes the same form as a constraint; however, since dedicated RPC coordinator 1000 only imports the client:blocked and server:serving modes (i.e., through RPC client imported state port 1022 and RPC server imported state port 1004 respectively), dedicated RPC coordinator 1000 is not allowed to alter these values to comply. In fact, none of these predicates is explicitly enforced by a runtime system. However, the last two can be used as requirements and guarantees for interface type-checking.

7. System-Level Execution

Coordination-centric design methodology lets system specifications be executed directly, according to the semantics described above. When components and coordinators are composed into higher-order structures, however, it becomes essential to consider hazards that can affect system behavior. Examples include conflicting constraints, in which local resolution semantics may either leave the system in an inconsistent state or make it cycle forever, and conflicting actions that undo one another's behavior. In the remainder of this section, the effect of composition issues on system-level executions is explained.

A. System Control Configurations

A configuration is the combined control state of a system-basically, the set of active modes at a point in time. In other words, a configuration in coordination-centric design is a bit vector containing one bit for each mode in the system. The bit representing a control state is true when the control state is active and false when the control state is inactive. Configurations representing the complete system control state facilitate reasoning on system properties and enable several forms of static analysis of system behavior.

B. Action-Trigger Propagation

Triggers are formal parameters for events. As mentioned earlier, there are two types of triggers: (1) control triggers, invoked by control events such as mode change requests, and (2) data flow triggers, invoked by data events such as message arrivals or departures. Components and coordinators can both request mode changes (on the modes visible to them) and generate new messages (on the message ports visible to them). Using actions, these events can be propagated through the components and coordinators in the system, causing a cascade of data transmissions and mode change requests, some of which can cancel other requests. When the requests, and secondary requests implied by them, are all propagated through the system, any requests that have not been canceled are confirmed and made part of the system's new configuration.

Triggers can be immediately propagated through their respective actions or delayed by a scheduling step. Recall that component actions can be either transparent or opaque. Transparent actions typically propagate their triggers immediately, although it is not absolutely necessary that they do so. Opaque actions typically must always delay propagation.

1. Immediate Propagation

Some triggers must be immediately propagated through actions, but only on certain types of transparent actions. Immediate propagation can often involve static precomputation of the effect of changes, which means that certain actions may never actually be performed. For example, consider a system with a coordinator that has an action that activates mode A and a coordinator with an action that deactivates mode B whenever A is activated. Static analysis can be used to determine in advance that any event that activates A will also deactivate B; therefore, this effect can be executed immediately without actually propagating it through A.

2. Delayed Propagation

Trigger propagation through opaque actions must typically be delayed, since the system cannot look into opaque actions to precompute their results. Propagation may be delayed for other reasons, such as system efficiency. For example, immediate propagation requires tight synchronization among software components. If functionality is spread among a number of architectural components, immediate propagation is impractical.

C. A Protocol Implemented with a Compound Coordinator

Multiple coordinators are typically needed in the design of a system. The multiple coordinators can be used together for a single, unified behavior. Unfortunately, one coordinator may interfere with another's behavior.

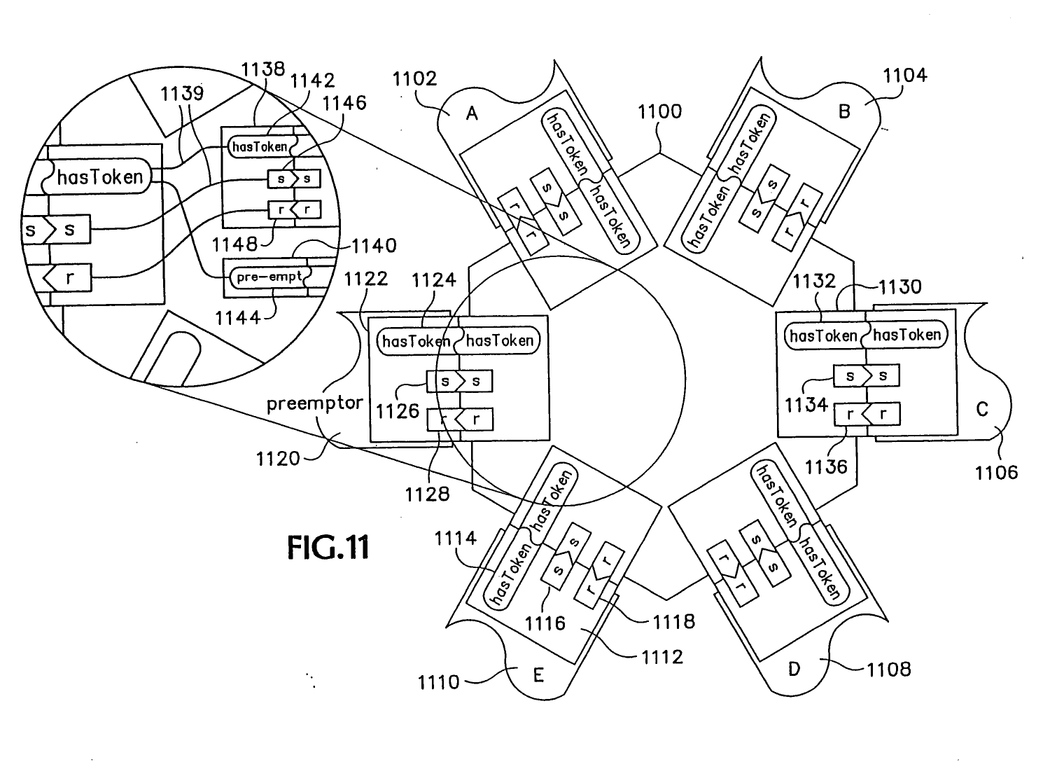

FIG. 11 shows a combined coordinator 1100 with both preemption and round-robin coordination for controlling access to a resource, as discussed above. With reference to FIG. 11, components 1102, 1104, 1106, 1108, and 1110 primarily use round-robin coordination, and each includes a component coordination interface 1112, which has a component arbitrated control port 1114 and a component output message port 1116. However, when a preemptor component 1120 needs the resource, preemptor component 1120 is allowed to grab the resource immediately. Preemptor component 1120 has a preemptor component coordination interface 1122. Preemptor component coordination interface 1122 has a preemptor arbitrated state port 1124, a preemptor output message port 1126, and a preemptor input message port 1128.

All component coordination interfaces 1112 and preemptor component coordination interface 1122 are connected to a complementary combined coordinator coordination interface 1130, which has a coordinator arbitrated state port 1132, a coordinator input message port 1134, and a coordinator output message port 1136. Combined coordinator 1100 is a hierarchical coordinator and internally has a round-robin coordinator (not shown) and a preemption coordinator (not shown). Combined coordinator coordination interface 1130 is connected to a coordination interface to round-robin 1138 and a coordination interface to preempt 1140. Coordinator arbitrated state port 1132 is bound to both a token arbitrated control port 1142, which is part of coordination interface to round-robin 1138, and to a preempt arbitrated control port 1144, which is part of coordination interface to preempt 1140. Coordinator input message port 1134 is bound to an interface to a round-robin output message port 1146, and coordinator output message port 1136 is bound to an interface to round-robin input message port 1148.

Thus preemption interferes with the normal round-robin ordering of access to the resource. After a preemption-based access, the resource moves to the component that in round-robin-ordered access would be the successor to preemptor component 1120. If the resource is preempted too frequently, some components may starve.

D. Mixing Control and Data in Coordinators

Since triggers can be control-based, data-based, or both, and actions can produce both control and data events, control and dataflow aspects of a system are coupled through actions. Through combinations of actions, designers can effectively employ modal data flow, in which relative schedules are switched on and off based on the system configuration.

Relative scheduling is a form of coordination. Recognizing this and understanding how it affects a design can allow a powerful class of optimizations. Many data-centric systems (or subsystems) use conjunctive firing, which means that a component buffers messages until a firing rule is matched. When matching occurs, the component fires, consuming the messages in its buffer that caused it to fire and generating a message or messages of its own. Synchronous data flow systems are those in which all components have only firing rules with constant message consumption and generation.

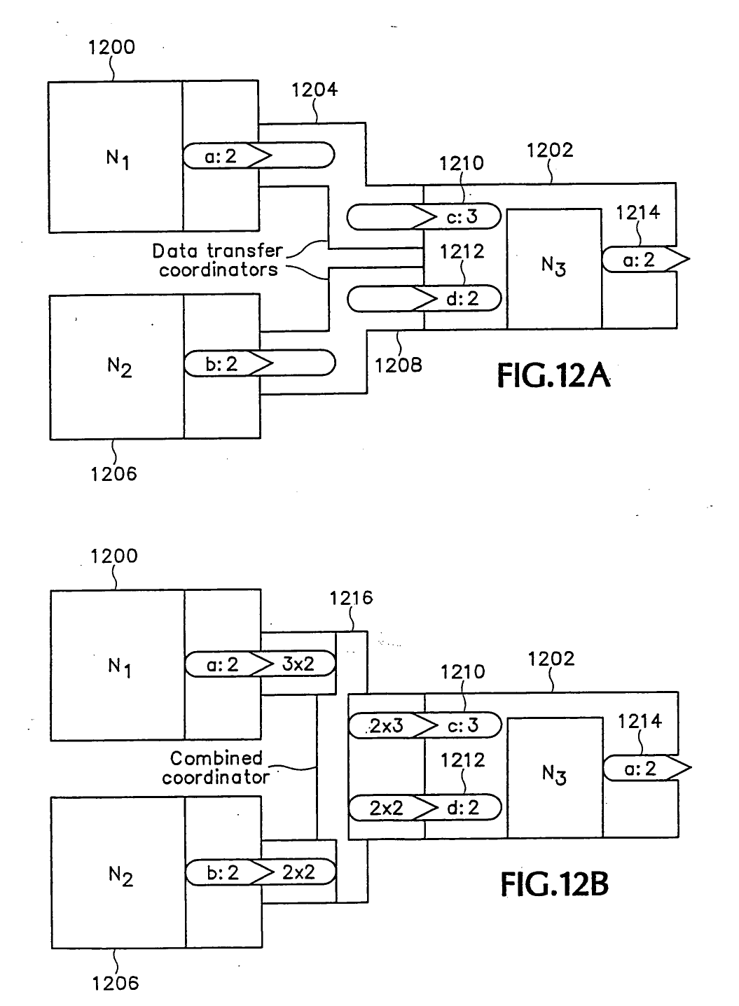

FIG. 12A shows a system in which a component N1 1200 is connected to a component N3 1202 by a data transfer coordinator 1204 and a component N2 1206 is connected to component N3 1202 by a second data transfer coordinator 1208. Component N3 1202 fires when it accumulates three messages on a port c 1210 and two messages on a port d 1212. On firing, component N3 1202 produces two messages on a port o 1214. Coordination control state tracks the logical buffer depth for these components. This is shown with numbers representing the logical queue depth of each port in FIG. 12.

FIG. 12B shows the system of FIG. 12A in which data transfer coordinator 1204 and second data transfer coordinator 1208 have been merged to form a merged data transfer coordinator 1216. Merging the coordinators in this example provides an efficient static schedule for component firing. Merged data transfer coordinator 1216 fires component N1 1200 three times and component N2 1206 twice. Merged data transfer coordinator 1216 then fires component N3 1202 twice (to consume all messages produced by component N1 1200 and component N2 1206).

Message rates can vary based on mode. For example, a component may consume two messages each time it fires in one mode and four each time it fires in a second mode. For a component like this, it is often possible to merge schedules on a configuration basis, in which each configuration has static consumption and production rates for all affected components.

E. Coordination Transformations

In specifying complete systems, designers must often specify not only the coordination between two objects, but also the intermediate mechanism they must use to implement this coordination. While this intermediate mechanism can be as simple as shared memory, it can also be another coordinator; hence coordination may be, and often is, layered. For example, RPC coordination often sits on top of a TCP/IP stack or on an IrDA stack, in which each layer coordinates with peer layers on other processing elements using unique coordination protocols. Here, each layer provides certain capabilities to the layer directly above it, and the upper layer must be implemented in terms of them.

In many cases, control and communication synthesis can be employed to automatically transform user-specified coordination to a selected set of standard protocols. Designers may have to manually produce transformations for nonstandard protocols.

F. Dynamic Behavior with Compound Coordinators

Even in statically bound systems, components may need to interact in a fashion that appears dynamic. For example, RPC-style coordination often has multiple clients for individual servers. Here, there is no apparent connection between client and server until one is forged for a transaction. After the connection is forged, however, the coordination proceeds in the same fashion as dedicated RPC.

Our approach to this is to treat the RPC server as a shared resource, requiring resource allocation protocols to control access. However, none of the resource allocation protocols described thus far would work efficiently under these circumstances. In the following subsections, an appropriate protocol for treating the RPC as a shared resource will be described and how that protocol should be used as part of a complete multiclient RPC coordination class—one that uses the same RPC coordination interfaces described earlier—will be discussed.

1. First Come/First Serve protocol (FCFS)

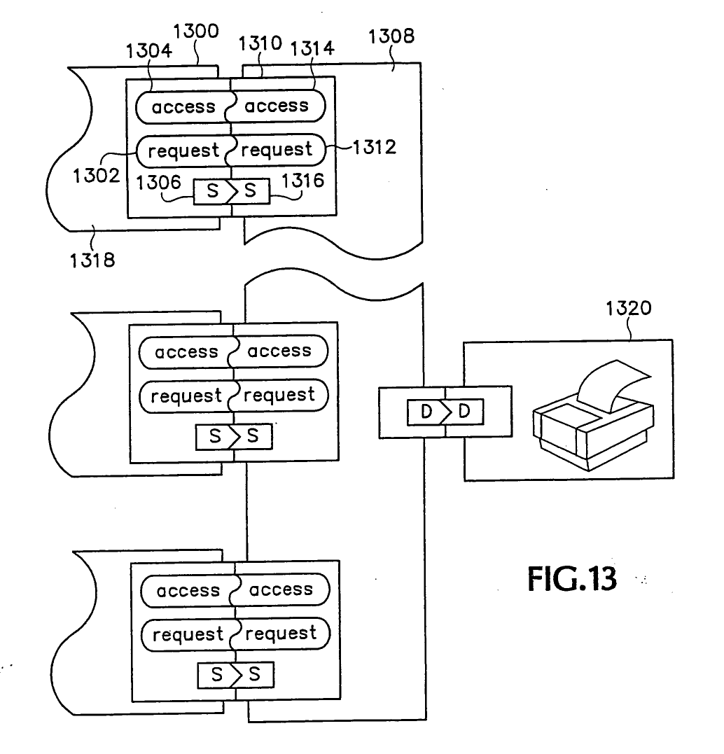

FIG. 13 illustrates a first come/first serve (FCFS) resource allocation protocol, which is a protocol that allocates a shared resource to the requester that has waited longest. With reference to FIG. 13, a FCFS component interface 1300 for this protocol has a request control port 1302, an access control port 1304 and a component outgoing message port 1306. A FCFS coordinator 1308 for this protocol has a set of FCFS interfaces 1310 that are complementary to FCFS component interfaces 1300, having a FCFS coordinator request control port 1312, a FCFS coordinator access port 1314, and a FCFS coordinator input message port 1316. When a component 1318 needs to access a resource 1320, it asserts request control port 1302. When granted access, FCFS coordinator 1308 asserts the appropriate FCFS coordinator access port 1314, releasing FCFS coordinator request control port 1312.

To do this, FCFS coordinator 1308 uses a rendezvous coordinator and two round-robin coordinators. One round-robin coordinator maintains a list of empty slots in which a component may be enqueued, and the other round-robin coordinator maintains a list showing the next component to be granted access. When an FCFS coordinator request control port 1312 becomes active, FCFS coordinator 1308 begins a rendezvous access to a binder action. When activated, this action maps the appropriate component 1318 to a position in the round-robin queues. A separate action cycles through one of the queues and selects the next component to access the server. As much as possible, FCFS coordinator 1308 attempts to grant access to resource 1320 to the earliest component 1318 having requested resource 1320, with concurrent requests determined based on the order in the rendezvous coordinator of the respective components 1318.

2. Multiclient RPC

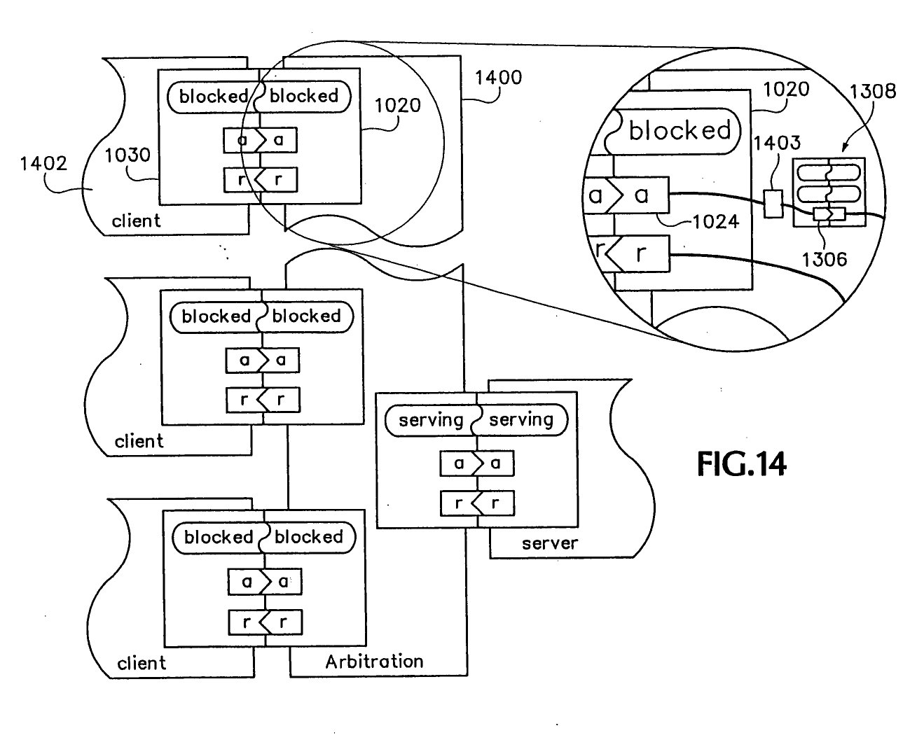

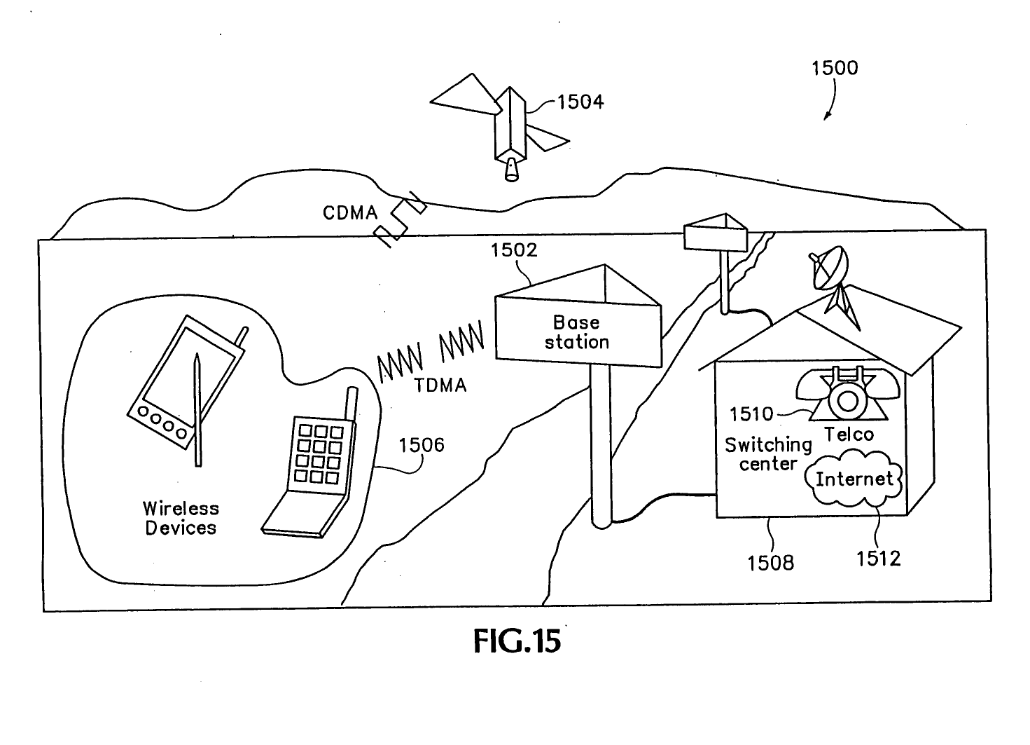

FIG. 14 depicts a multiclient RPC coordinator 1400 formed by combining FCFS coordinator 1308 with dedicated RPC coordinator 1000. With reference to FIG. 14, a set of clients 1402 have a set of client coordination interfaces 1030, as shown in FIG. 10. In addition, multiclient RPC coordinator 1400 has a set of RPC client coordination interfaces 1020, as shown in FIG. 10. For each RPC client coordination interface 1020, RPC client input message port 1024, of RPC client coordination interface 1020, is bound to the component outgoing message port 1306 of FCFS coordinator 1308. Message transfer action 1403 serves to transfer messages between RPC client input message port 1024 and component outgoing message port 1306. For coordinating the actions of multiple clients 1402, multiclient RPC coordinator 1400 must negotiate accesses to a server 1404 and keep track of the values returned by server 1404.

G. Monitor Modes and Continuations

Features such as blocking behavior and exceptions can be implemented in the coordination-centric design methodology with the aid of monitor modes. Monitor modes are modes that exclude all but a selected set of actions called continuations, which are actions that continue a behavior started by another action.

1. Blocking Behavior

With blocking behavior, one action releases control while entering a monitor mode, and a continuation resumes execution after the anticipated response event. Monitor mode entry must be immediate (at least locally), so that no unexpected actions can execute before they are blocked by such a mode.

Each monitor mode has a list of actions that cannot be executed when it is entered. The allowed (unlisted) actions are either irrelevant or are continuations of the action that caused entry into this mode. There are other conditions, as well. This mode requires an exception action if forced to exit. However, this exception action is not executed if the monitor mode is turned off locally.

When components are distributed over a number of processing elements, it is not practical to assume complete synchronization of the control state. In fact, there are a number of synchronization options available as detailed in Chou, P “Control Composition and Synthesis of Distributed Real-Time Embedded Systems”, Ph.D. dissertation, University of Washington, 1998.

2. Exception Handling

Exception actions are a type of continuation. When in a monitor mode, exception actions respond to unexpected events or events that signal error conditions. For example, multiclient RPC coordinator 1400 can bind [symbol] client.blocked to a monitor mode and set an exception action on +server.serving. This will signal an error whenever the server begins to work when the client is not blocked for a response.

8. A Complete System Example

FIG. 15 depicts a large-scale example system under the coordination-centric design methodology. With reference to FIG. 15, the large scale system is a bimodal digital cellular network 1500. Network 1500 is for the most part a simplified version of a GSM (global system for mobile communications) cellular network. This example shows in greater detail how the parts of coordination-centric design work together and demonstrates a practical application of the methodology. Network 1500 has two different types of cells, a surface cell 1502 (also referred to as a base station 1502) and a satellite cell 1504. These cells are not only differentiated by physical position, but by the technologies they use to share network 1500. Satellite cells 1504 use a code division multiple access (CDMA) technology, and surface cells 1502 use a time division multiple access (TDMA) technology. Typically, there are seven frequency bands reserved for TDMA and one band reserved for CDMA. The goal is for as much communication as possible to be conducted through the smaller TDMA cells, here surface cells 1502, because power requirements for a CDMA cells, here satellite cell 1504, increase with the number of users in the CDMA cell. Mobile units 1506, or wireless devices, can move between surface cells 1502, requiring horizontal handoffs between surface cells 1502. Several surface cells 1502 are typically connected to a switching center 1508. Switching center 1508 is typically connected to a telephone network or the Internet 1512. In addition to handoffs between surface cells 1502, the network must be able to hand off between switching centers 1508. When mobile units 1506 leave the TDMA region, they remain covered by satellite cells 1504 via vertical handoffs between cells. Since vertical handoffs require changing protocols as well as changing base stations and switching centers, they can be complicated in terms of control.

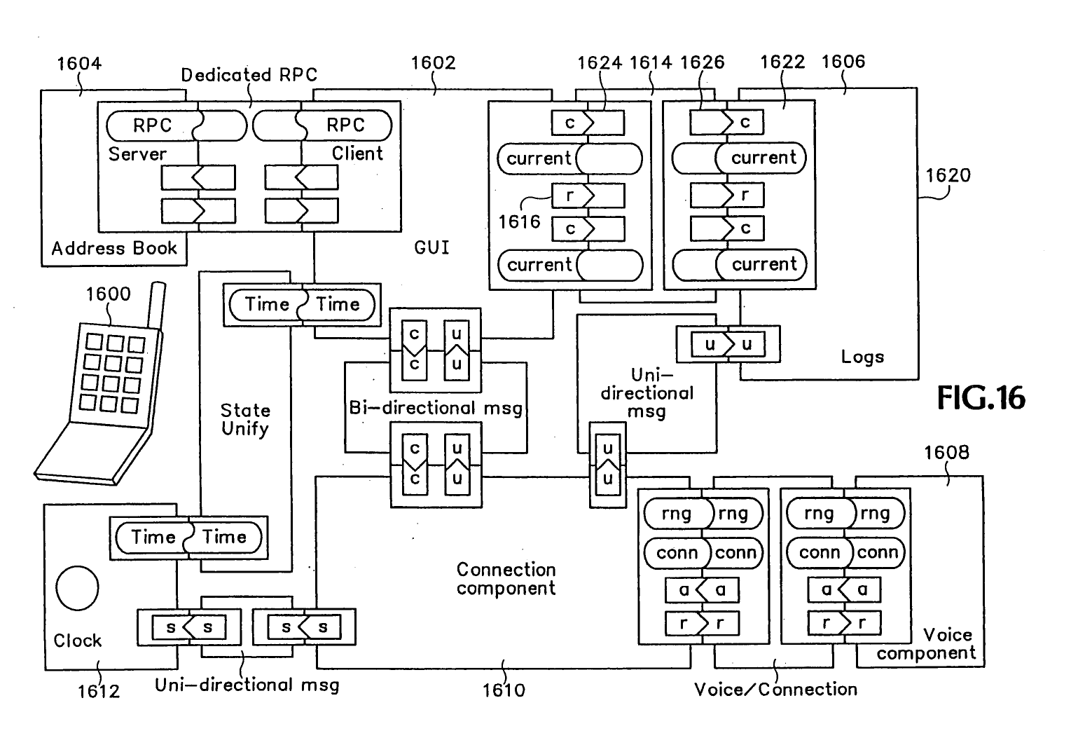

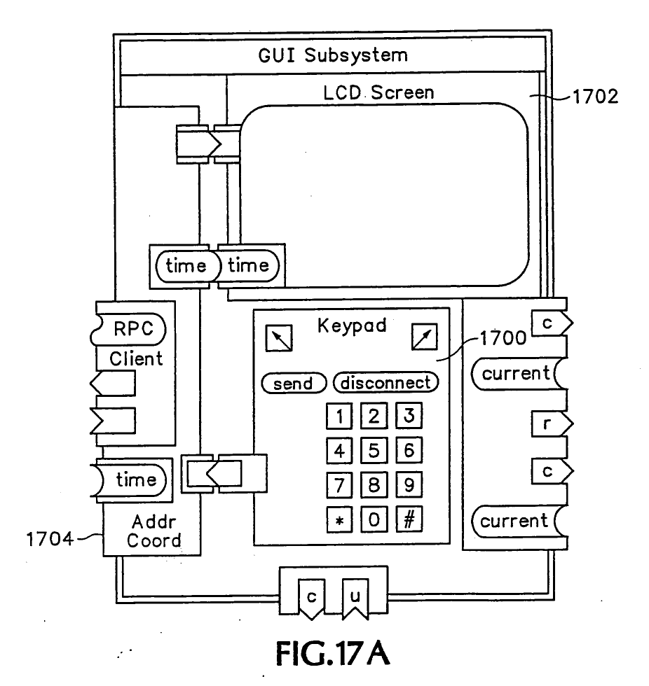

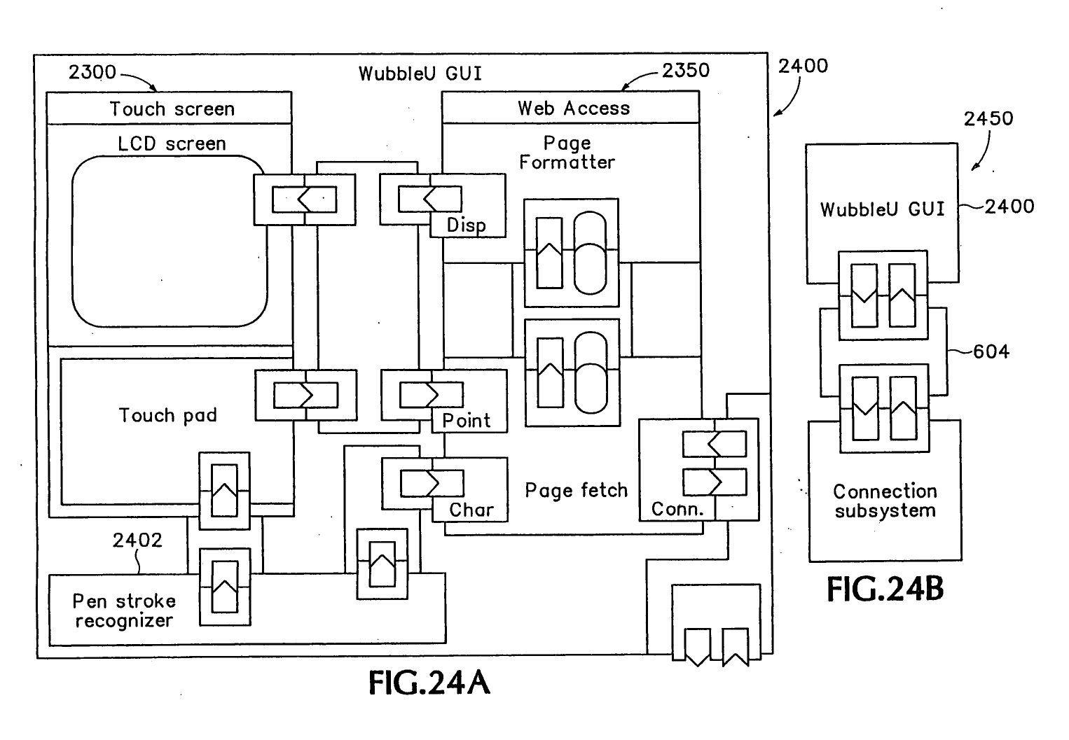

Numerous embedded systems comprise the overall system. For example, switching center 1508 and base stations, surface cells 1502, are required as part of the network infrastructure, but cellular phones, handheld Web browsers, and other mobile units 1506 may be supported for access through network 1500. This section concentrates on the software systems for two particular mobile units 1506: a simple digital cellular phone (shown in FIG. 16) and a handheld Web browser (shown in FIG. 24). These examples require a wide variety of coordinators and reusable components. Layered coordination is a feature in each system, because a function of many subsystems is to perform a layered protocol. Furthermore, this example displays how the hierarchically constructed components can be applied in a realistic system to help manage the complexity of the overall design.

To begin this discussion, we describe the cellular phone in detail, focusing on its functional components and the formalization of their interaction protocols. We then discuss the handheld Web browser in less detail but highlight the main ways in which its functionality and coordination differ from those of the cellular phone. In describing the cellular phone, we use a top-down approach to show how a coherent system organization is preserved, even at a high level. In describing the handheld Web browser, we use a bottom-up approach to illustrate component reuse and bottom-up design.

A. Cellular Phone

FIG. 16 shows a top-level coordination diagram of the behavior of a cell phone 1600. Rather than using a single coordinator that integrates the components under a single protocol, we use several coordinators in concert. Interactions between coordinators occur mainly within the components to which they connect.

With reference to FIG. 16, cell phone 1600 supports digital encoding of voice streams. Before it can be used, it must be authenticated with a home master switching center (not shown). This authentication occurs through a registered master switch for each phone and an authentication number from the phone itself. There are various authentication statuses, such as full access, grey-listed, or blacklisted. For cell phone 1600, real-time performance is more important than reliability. A dropped packet is not retransmitted, and a late packet is dropped since its omission degrades the signal less than its late incorporation.

Each component of cell phone 1600 is hierarchical. A GUI 1602 lets users enter phone numbers while displaying them and query an address book 1604 and a logs component 1606. Address book 1604 is a database that can map names to phone numbers and vice versa. GUI 1602 uses address book 1604 to help identify callers and to look up phone numbers to be dialed. Logs 1606 track both incoming and outgoing calls as they are dialed. A voice component 1608 digitally encodes and decodes, and compresses and decompresses, an audio signal. A connection component 1610 multiplexes, transmits, receives, and demultiplexes the radio signal and separates out the voice stream and caller identification information.

Coordination among the above components makes use of several of the coordinators discussed above. Between connection component 1610 and a clock 1612, and between logs 1606 and connection component 1610, are unidirectional data transfer coordinators 600 as described with reference to FIG. 6A. Between voice component 1608 and connection component 1610, and between GUI 1602 and connection component 1610, are bidirectional data transfer coordinators 604, as described with reference to FIG. 6B. Between clock 1612 and GUI 1602 is a state unification coordinator 606, as described with reference to FIG. 6C. Between GUI 1602 and address book 1604 is a dedicated RPC coordinator 1000 as described with reference to FIG. 10, in which address book 1604 has client 1028 and GUI 1602 has server 1010.

There is also a custom GUI/log coordinator 1614 between logs 1606 and GUI 1602. GUI/log coordinator 1614 lets GUI 1602 transfer new logged information through an r output message port 1616 on a GUI coordination interface 1618 to an r input message port 1620 on a log coordination interface 1622. GUI/log coordinator 1614 also lets GUI 1602 choose current log entries through a pair of c output message ports 1624 on GUI coordination interface 1618 and a pair of c input message ports 1626 on log coordination interface 1622. Logs 1606 continuously display one entry each for incoming and outgoing calls.

1. GUI Component

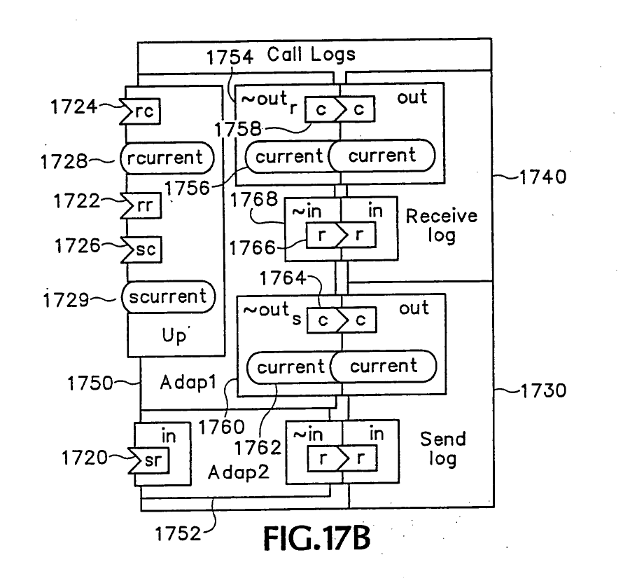

FIG. 17A is a detailed view of GUI component 1602, of FIG. 16. With reference to FIG. 17A, GUI component 1602 has two inner components, a keypad 1700 and a text-based liquid crystal display 1702, as well as several functions of its own (not shown). Each time a key press occurs, it triggers an action that interprets the press, depending on the mode of the system. Numeric presses enter values into a shared dialing buffer. When a complete number is entered, the contents of this buffer are used to establish a new connection through connection component 1610. Table 5 shows the action triples for GUI 1602.

| Mode | Trigger | Action |
|---|---|---|
| Idle | 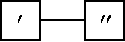 | numBuffer.append(keypress.val) |
| | Send | radio.send(num.Buffer.val) |
| | | +outgoingCall |
| | Disconnect | Nil |
| | Leftarrow | AddressBook.forward() |
| | | +lookupMode |
| | Rightarrow | log.lastcall() |
| | | +outlog |
| LookupMode | Leftarrow | AddressBook.forward() |
| | Rightarrow | AddressBook.backward() |

An “Addr Coord” coordinator 1704 includes an address book mode (not shown) in which arrow key presses are transformed into RPC calls.

2. Logs Component

FIG. 17B is a detailed view of logs component 1606, which tracks all incoming and outgoing calls. With reference to FIG. 17B, both GUI component 1602 and connection component 1610 must communicate with logs component 1606 through specific message ports. Those specific message ports include a transmitted number message port 1720, a received number message port 1722, a change current received message port 1724, a change current transmitted message port 1726, and two state ports 1728 and 1729 for presenting the current received and current transmitted values, respectively.

Logs component 1606 contains two identical single-log components: a send log 1730 for outgoing calls and a receive log 1740 for incoming calls. The interface of logs component 1606 is connected to the individual log components by a pair of adapter coordinators, Adap1 1750 and Adap2 1752. Adap1 1750 has an adapter receive interface 1754, which has a receive imported state port 1756 and a receive output message port 1758. Adap1 1750 further has an adapter send interface 1760, which has a send imported state port 1762 and a send output message port 1764. Within Adap1, state port 1728 is bound to receive imported state port 1756, change current received message port 1724 is bound to receive output message port 1758, received number message port 1722 is bound to a received interface output message port 1766 on a received number coordination interface 1768, change current transmitted message port 1726 is bound to send output message port 1764, and state port 1729 is bound to Up.rc is bound to send imported state port 1762.

3. Voice Component

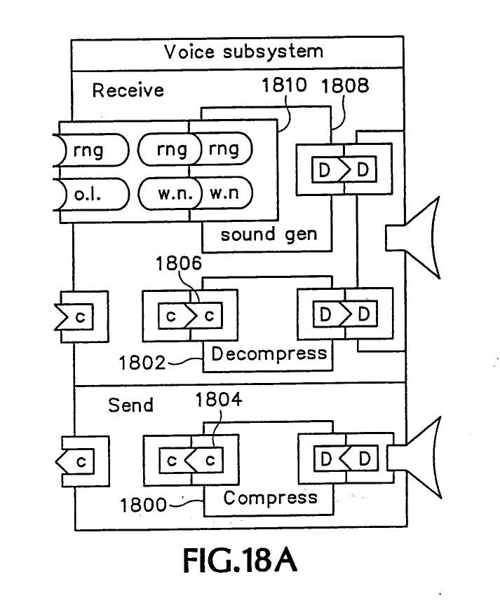

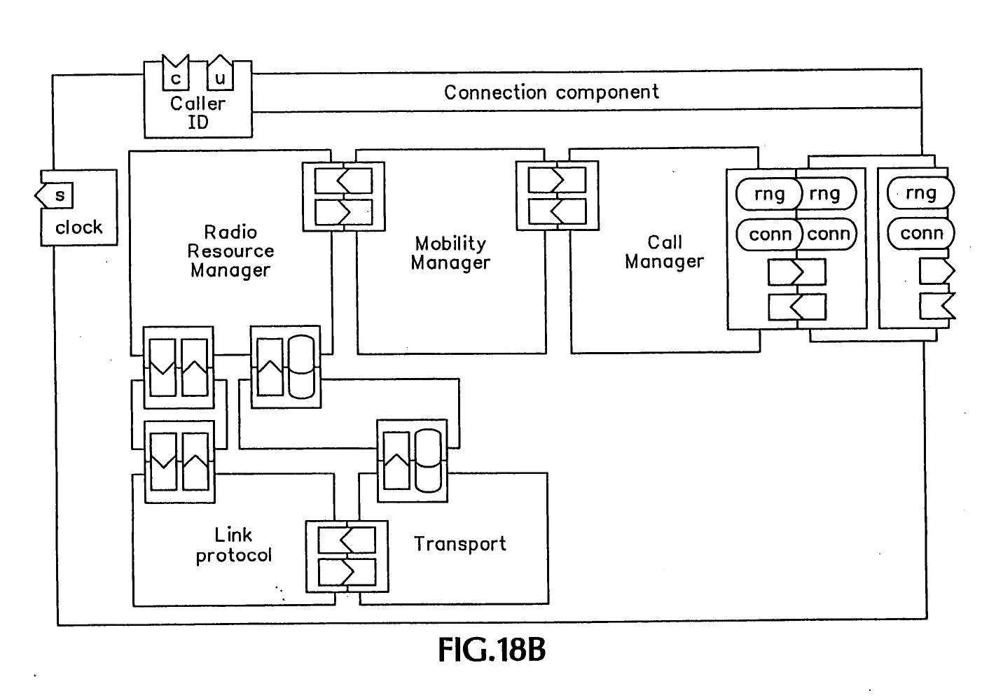

FIG. 18A is a detailed view of voice component 1608 of FIG. 16. Voice component 1608 has a compression component 1800 for compressing digitized voice signals before transmission, a decompression component 1802 for decompressing received digitized voice signals, and interfaces 1804 and 1806 to analog transducers (not shown) for digitizing sound to be transmitted and for converting received transmissions into sound. Voice component 1608 is a pure data flow component containing sound generator 1808 which functions as a white-noise generator, a ring tone generator, and which has a separate port for each on sound generator interface 1810, and voice compression functionality in the form of compression component 1800 and decompression component 1802.

4. Connection Component

FIG. 18B is a detailed view of connection component 1610 of FIG. 16. With reference to FIG. 18B, connection component 1610 coordinates with voice component 1608, logs component 1606, clock 1612, and GUI 1602. In addition, connection component 1610 is responsible for coordinating the behavior of cell phone 1600 with a base station that owns the surface cell 1502 (shown in FIG. 15), a switching center 1508 (shown in FIG. 15), and all other phones (not shown) within surface cell 1502. Connection component 1610 must authenticate users, establish connections, and perform handoffs as needed—including appropriate changes in any low-level protocols (such as a switch from TDMA to CDMA).

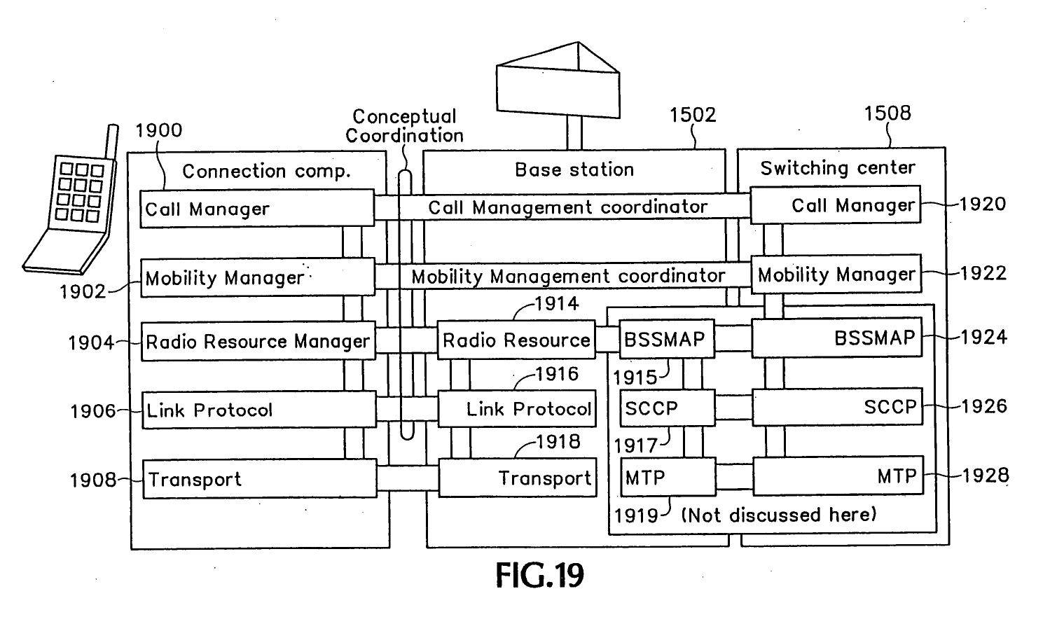

FIG. 19 depicts a set of communication layers between connection component 1610 of cell phone 1600 and base station 1502 or switching center 1508. With reference to FIG. 19, has several subcomponents, or lower-level components, each of which coordinates with an equivalent, or peer, layer on either base station 1502 or switching center 1508. The subcomponents of connection component 1610 include a cell phone call manager 1900, a cell phone mobility manager 1902, a cell phone radio resource manager 1904, a cell phone link protocol manager 1906, and a cell phone transport manager 1908 which is responsible for coordinating access to and transferring data through the shared airwaves TDMA and CDMA coordination. Each subcomponent will be described in detail including how each fits into the complete system.

Base station 1502 has a call management coordinator 1910, a mobility management coordinator 1912, a radio resource coordinator 1914 (BSSMAP 1915), a link protocol coordinator 1916 (SCCO 1917), and a transport coordinator 1918 (MTP 1919). Switching center 1508 has a switching center call manager 1920, a switching center mobility manager 1922, a BSSMAP 1924, a SCCP 1926, and an MTP 1928.

a. Call Management

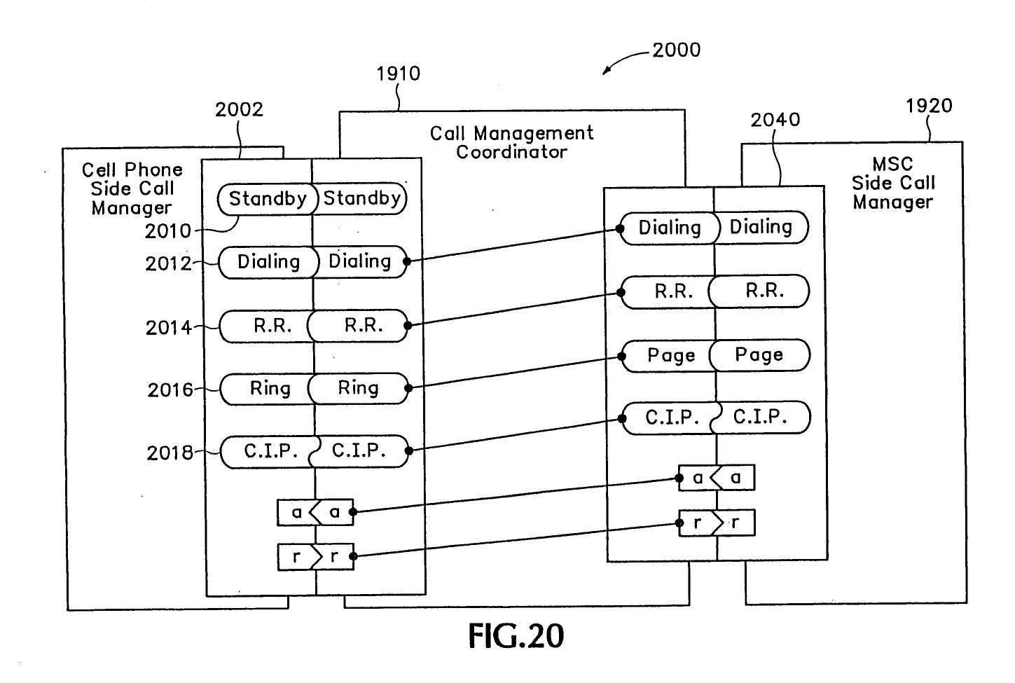

FIG. 20 is a detailed view of a call management layer 2000 consisting of cell phone call manager 1900, which is connected to switching center call manager 1920 by call management coordinator 1910. With reference to FIG. 20, call management layer 2000 coordinates the connection between cell phone 1600 and switching center 1508. Call management layer 2000 is responsible for dialing, paging, and talking. Call management layer 2000 is always present in cell phone 1600, though not necessarily in Internet appliances (discussed later). Cell phone call manager 1900 includes a set of modes (not shown) for call management coordination that consists of the following modes:
Standby
Dialing
RingingRemote
Ringing
CallInProgress
   Cell phone call manager 1900 has a cell phone call manager interface 2002. Cell phone call manager interface 2002 has a port corresponding to each of the above modes. The standby mode is bound to a standby exported state port 2010. The dialing mode is bound to a dialing exported state port 2012. The RingingRemote mode is bound to a RingingRemote imported state port 2014. The Ringing mode is bound to a ringing imported state port 2016. The CallInProgress mode is bound to a CallInProgress arbitrated state port 2018.

Switching center call manager 1920 includes the following modes (not shown) for call management coordination at the switching center:
Dialing
RingingRemote
Paging
CallInProgress
   Switching center call manager 1920 has a switching center call manager coordination interface 2040, which includes a port for each of the above modes within switching center call manager 1920.

When cell phone 1600 requests a connection, switching center 1508 creates a new switching center call manager and establishes a call management coordinator 1910 between cell phone 1600 and switching center call manager 1920.

b. Mobility Management

A mobility management layer authenticates mobile unit 1506 or cell phone 1600. When there is a surface cell 1502 available, mobility manager 1902 contacts the switching center 1508 for surface cell 1502 and transfers a mobile unit identifier (not shown) for mobile unit 1506 to switching center 1508. Switching center 1508 then looks up a home motor switching center for mobile unit 1506 and establishes a set of permissions assigned to mobile unit 1506. This layer also acts as a conduit for the call management layer. In addition, the mobility management layer performs handoffs between base stations 1502 and switching centers 1508 based on information received from the radio resource layer.

c. Radio Resource

In the radio resource layer, radio resource manager 1904, chooses the target base station 1502 and tracks changes in frequencies, time slices, and CDMA codes. Cell phones may negotiate with up to 16 base stations simultaneously. This layer also identifies when handoffs are necessary.

d. Link Protocol

The link layer manages a connection between cell phone 1600 and base station 1502. In this layer, link protocol manager 1906 packages data for transfer to base station 1502 from cell phone 1600.

e. Transport

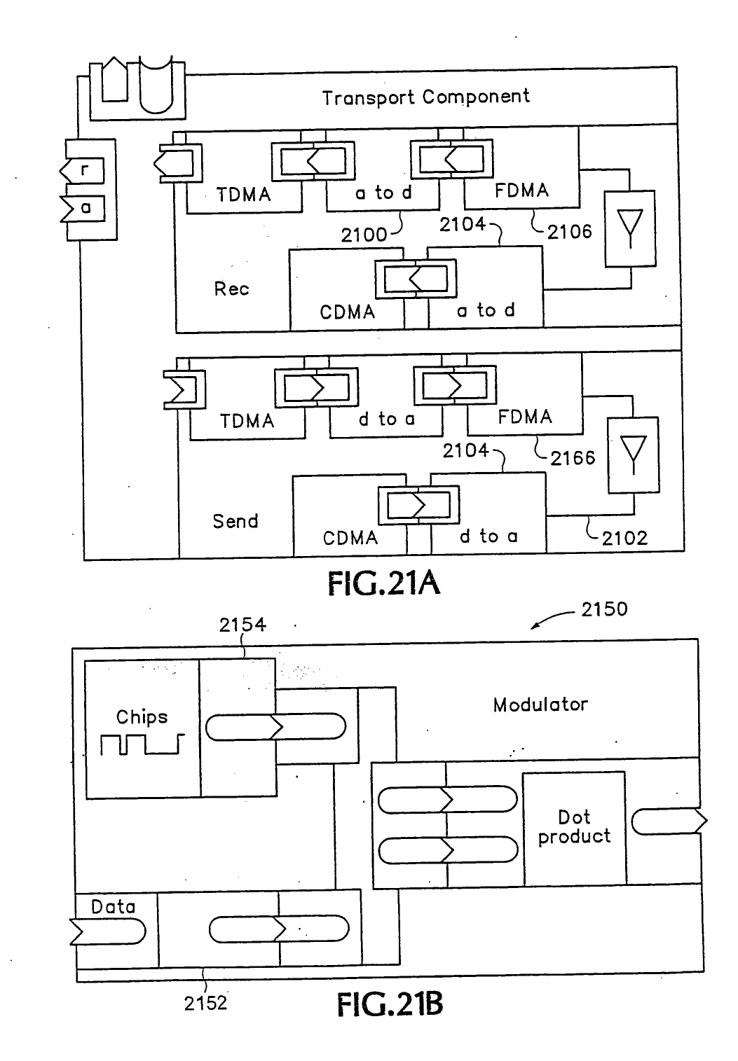

FIG. 21A is a detailed view of transport component 1908 of connection component 1610. Transport component 1908 has two subcomponents, a receive component 2100 for receiving data and a transmit component 2102 for transmitting data. Each of these subcomponents has two parallel data paths a CDMA path 2104 and a TDMA/FDMA path 2106 for communicating in the respective network protocols.

FIG. 21B is a detailed view of a CDMA modulator 2150, which implements a synchronous data flow data path. CDMA modulator 2150 takes the dot-product of an incoming data signal along path 2152 and a stored modulation code for cell phone 1600 along path 2154, which is a sequence of chips, which are measured time signals having a value of −1 or +1.

Transport component 1908 uses CDMA and TDMA technologies to coordinate access to a resource shared among several cell phones 1600, i.e., the airwaves. Transport components 1908 supersede the FDMA technologies (e.g., AM and FM) used for analog cellular phones and for radio and television broadcasts. In FDMA, a signal is encoded for transmission by modulating it with a carrier frequency. A signal is decoded by demodulation after being passed through a band pass filter to remove other carrier frequencies. Each base station 1502 has a set of frequencies—chosen to minimize interference between adjacent cells. (The area covered by a cell may be much smaller than the net range of the transmitters within it.)

TDMA, on the other hand, coordinates access to the airwaves through time slicing. Cell phone 1600 on the network is assigned a small time slice, during which it has exclusive access to the media. Outside of the small time slice, cell phone 1600 must remain silent. Decoding is performed by filtering out all signals outside of the small time slice. The control for this access must be distributed. As such, each component involved must be synchronized to observe the start and end of the small time slice at the same instant.

Most TDMA systems also employ FDMA, so that instead of sharing a single frequency channel, cell phones 1600 share several channels. The band allocated to TDMA is broken into frequency channels, each with a carrier frequency and a reasonable separation between channels. Thus user channels for the most common implementations of TDMA can be represented as a two-dimensional array, in which the rows represent frequency channels and the columns represent time slices.

CDMA is based on vector arithmetic. In a sense, CDMA performs inter-cell-phone coordination using data flow. Instead of breaking up the band into frequency channels and time slicing these, CDMA regards the entire band as an n-dimensional vector space. Each channel is a code that represents a basis vector in this space. Bits in the signal are represented as either 1 or −1, and the modulation is the inner product of this signal and a basis vector of mobile unit 1506 or cell phone 1600. This process is called spreading, since it effectively takes a narrowband signal and converts it into a broadband signal.

Demultiplexing is simply a matter of taking the dot-product of the received signal with the appropriate basis vector, obtaining the original 1 or −1. With fast computation and the appropriate codes or basis vectors, the signal can be modulated without a carrier frequency. If this is not the case, a carrier and analog techniques can be used to fill in where computation fails. If a carrier is used, however, all units use the same carrier in all cells.

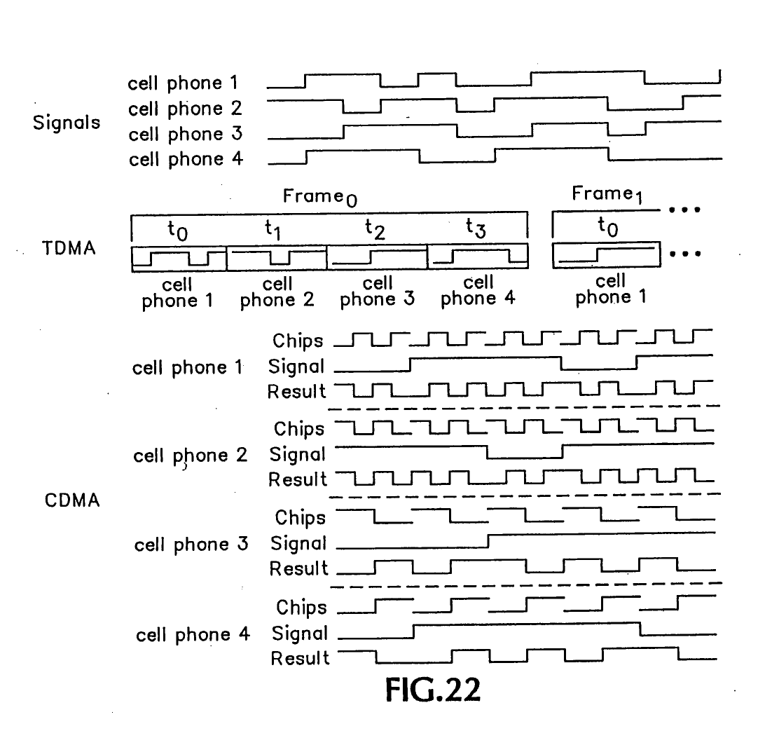

FIG. 22 shows TDMA and CDMA signals for four cell phones 1600. With reference to FIG. 22, for TDMA, each cell phone 1600 is assigned a time slice during which it can transmit. Cell phone 1 is assigned time slice to, cell phone 2 is assigned time slice t1, cell phone 3 is assigned time slice t2, and cell phone 4 is assigned time slice t3. For CDMA, each cell phone 1600 is assigned a basis vector that it multiplies with its signal. Cell phone 1 is assigned the vector:

$$( \begin{matrix}- 1 \\ 1 \\ - 1 \\ 1\end{matrix} )$$

Cell phone 2 is assigned the vector:

$$( \begin{matrix}1 \\ - 1 \\ 1 \\ - 1\end{matrix} )$$

Cell phone 3 is assigned the vector:

$$( \begin{matrix}1 \\ 1 \\ - 1 \\ - 1\end{matrix} )$$

Cell phone 4 is assigned the vector:

$$( \begin{matrix}- 1 \\ - 1 \\ 1 \\ 1\end{matrix} )$$

Notice that these vectors form an orthogonal basis.

B. Handheld Web Browser

In the previous subsection, we demonstrated our methodology on a cell phone with a top-down design approach. In this subsection, we demonstrate our methodology with a bottom-up approach in building a handheld Web browser.

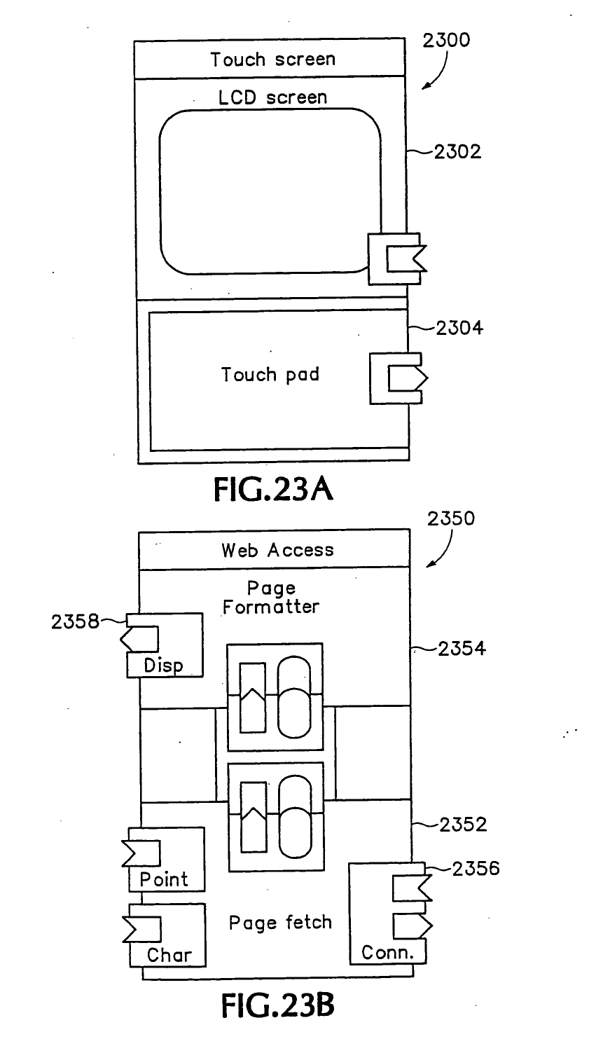

FIG. 23A is a LCD touch screen component 2300 for a Web browser GUI (shown in FIG. 24A) for a wireless device 1506. With reference to FIG. 23A, a LCD touch screen component 2300, has an LCD screen 2302 and a touch pad 2304.

FIG. 23B is a Web page access component 2350 for fetching and formatting web pages. With reference to FIG. 23B, web access component 2350 has a page fetch subcomponent 2352 and a page format subcomponent 2354. Web access component 2350 reads hypertext markup language (HTML) from a connection interface 2356, sends word placement requests to a display interface 2358, and sends image requests to the connection interface 2356. Web access component 2350 also has a character input interface to allow users to enter page requests directly and to fill out forms on pages that have forms.

FIG. 24A shows a completed handheld Web browser GUI 2400. With reference to FIG. 24A, handheld Web browser GUI 2400, has LCD touch screen component 2300, web access component 2350, and a pen stroke recognition component 2402 that translates pen strokes entered on touch pad 2304 into characters.

FIG. 24B shows the complete component view of a handheld Web browser 2450. With reference to FIG. 24B, handheld Web browser 2450 is formed by connecting handheld Web browser GUI 2400 to connection component 1610 of cell phone 1600 (described with reference to FIG. 16) with bidirectional data transfer coordinator 604 (described with reference to FIG. 6B). Handheld Web browser 2450 is an example of mobile unit 1506, and connects to the Internet through the cellular infrastructure described above. However, handheld Web browser 2450 has different access requirements than does cell phone 1600. For handheld Web browser 2450, reliability is more important than real-time delivery. Dropped packets usually require retransmission, so it is better to deliver a packet late than to drop it. Real-time issues primarily affect download time and are therefore secondary. Despite this, handheld Web browser 2450 must coordinate media access with cell phones 1600, and so it must use the same protocol as cell phones 1600 to connect to the network. For that reason, handheld Web browser 2450 can reuse connection component 1610 from cell phone 1600.

Debugging Techniques

In concept, debugging is a simple process. A designer locates the cause of undesired behavior in a system and fixes the cause. In practice, debugging—even of sequential software—remains difficult. Embedded systems are considerably more complicated to debug than sequential software, due to factors such as concurrence, distributed architectures, and real-time concerns. Issues taken for granted in sequential software, like a schedule that determines the order of all events (the program), are nonexistent in a typical distributed system. Locating and fixing bugs in these complex systems requires many factors, including an understanding of the thought processes underpinning the design.

Prior art research into debugging distributed systems is diverse and eclectic and lacks any standard notations. This application uses a standardized notation both to describe the prior art and the present invention. As a result of this standardized notation, the principles in the prior art follow those published in the referenced works. However, the specific notation, theorems, etc., may differ.

The two general classes of debugging techniques are event-based debugging and state-based debugging. Most debugging techniques for general-purpose distributed systems are event based. Event-based debugging techniques operate by collecting event traces from individual system components and causally relating those event traces. These techniques require an ability to determine efficiently the causal ordering among any given pair of events. Determining the causal order can be difficult and costly.

Events may be primitive, or they may be hierarchical clusters of other events. Primitive events are abstractions of individual local occurrences that might be important to a debugger. Examples of primitive events in sequential programs are variable assignments and subroutine entries or returns. Primitive events for distributed systems include message send and receive events.

State-based debugging techniques are less commonly used in debugging distributed systems. State-based debugging techniques typically operate by presenting designers with views or snapshots of a process state. Distributed systems are not tightly synchronized, and so these techniques traditionally involve only the state of individual processes. However, state-based debugging techniques can be applied more generally by relaxing the concept of an “instant in time” so that it can be effectively applied to asynchronous processes.

1. Event-Based Debugging

In this section, prior art systems for finding and tracking meaningful event orderings, despite limits in observation, are described. Typical ways in which event orderings are used in visualization tools through automated space/time diagrams are then described.

A. Event Order Determination and Observation

The behavior of a software system is determined by the events that occur and the order in which they occur. For sequential systems, this seems almost too trivial to mention; of course, a given set of events, such as
{x:=2, x:=x*2, x:=5, y:=x},
   arranged in two different ways may describe two completely different behaviors. However, since a sequential program is essentially a complete schedule of events, ordering is explicit. Sequential debugging tools depend on the invariance of this event schedule to let programmers reproduce failures by simply using the same inputs. In distributed systems, as in any concurrent system, it is neither practical nor efficient to completely schedule all events. Concurrent systems typically must be designed with flexible event ordering.

Determining the order in which events occur in a distributed system is subject to the limits of observation. An observation is an event record collected by an observer. An observer is an entity that watches the progress of an execution and records events but does not interfere with the system. To determine the order in which two events occur, an observer must measure them both against a common reference.

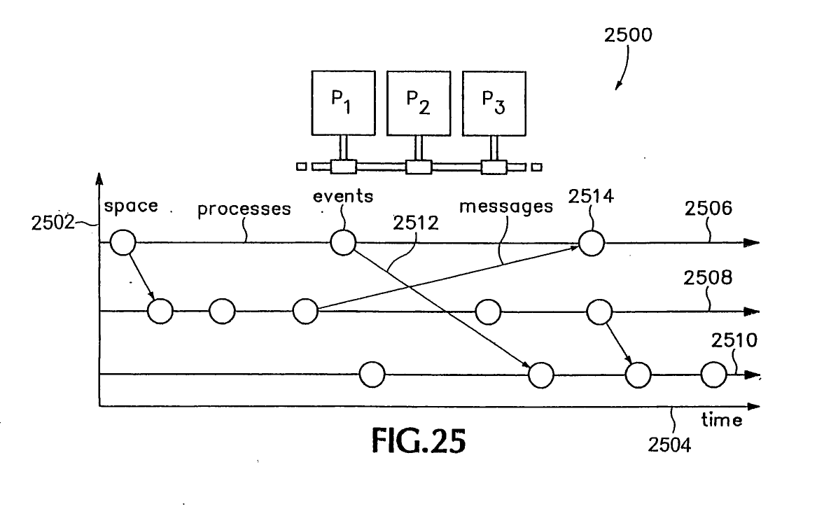

FIG. 25 shows a typical space/time diagram 2500, with space represented on a vertical axis 2502 and time represented on a horizontal axis 2504. With reference to FIG. 25, space/time diagram 2500 provides a starting point for discussing executions in distributed systems. Space/time diagram 2500 gives us a visual representation for discussing event ordering and for comparing various styles of observation. A set of horizontal world lines 2506, 2508, and 2510 each represent an entity that is stationary in space. The entities represented by horizontal world lines 2506, 2508, and 2510 are called processes and typically represent software processes in the subject system. The entities can also represent any entity that generates events in a sequential fashion. The spatial separation in the diagram, along vertical axis 2502, represents a virtual space, since several processes might execute on the same physical hardware. A diagonal world line 2512 is called a message and represents discrete communications that pass between two processes. A sphere 2514 represents an event. In subsequent figures vertical axis 2502 and horizontal axis 2504 are omitted from any space/time diagrams, unless vertical axis 2502 and horizontal axis 2504 provide additional clarity to a particular figure.

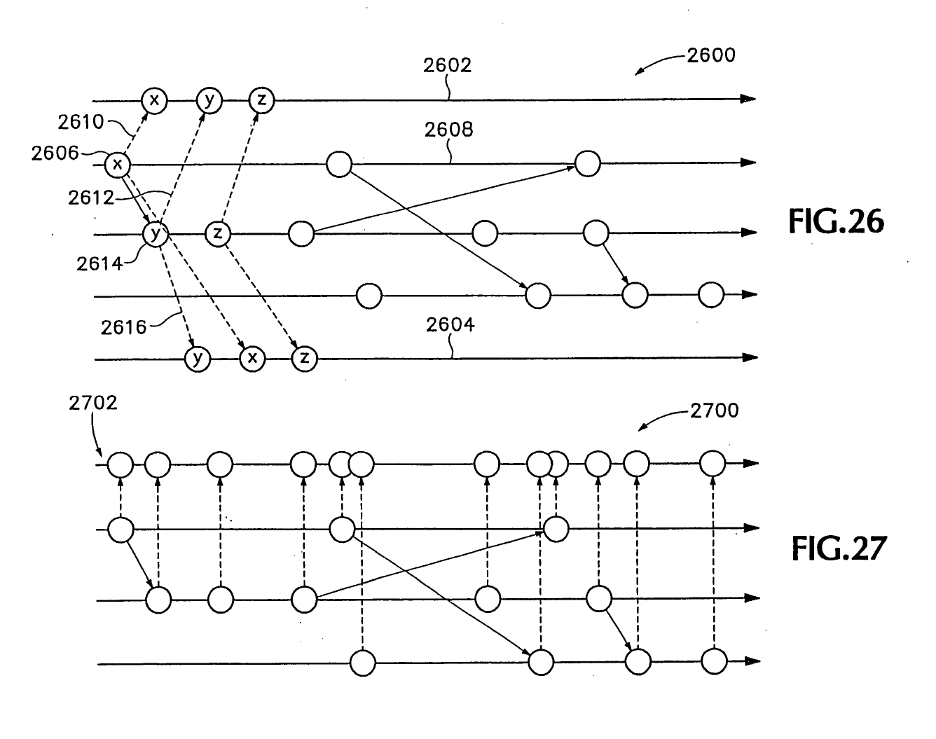

FIG. 26 shows a space/time diagram 2600 of two different observations of a single system execution, taken by a first observer 2602 and a second observer 2604. With reference to FIG. 26, first observer 2602 and second observer 2604 are entities that record event occurrence. First observer 2602 and second observer 2604 must each receive distinct notifications of each event that occurs and each must record the events in some total order. First observer 2602 and second observer 2604 are represented in space/time diagram 2600 as additional processes, or horizontal world lines. Each event recorded requires a signal from its respective process to both first observer 2602 and second observer 2604. The signals from an event x 2606 on a process 2608 to both first observer 2602 and second observer 2604 are embodied in messages 2610 and 2612, respectively. First observer 2602 records event x 2606 as preceding an event y 2614. However, second observer 2604 records event y 2614 as preceding event x 2606. Such effects may be caused by nonuniform latencies within the system.

However, the observations of first observer 2602 and second observer 2604 are not equally valid. A valid observation is typically an observation that preserves the order of events that depend on each other. Second observer 2604 records the receipt of a message 2616 before that message is transmitted. Thus the observation from second observer 2604 is not valid.

FIG. 27 shows a space/time diagram 2700 for a special, ideal observer, called the real-time observer (RTO) 2702. With reference to FIG. 27, RTO 2702 can view each event immediately as it occurs. Due to the limitations of physical clocks, and efficiency issues in employing them, it is usually not practical to implement RTO 2702. However, RTO 2702 represents an upper bound on precision in event-order determination.

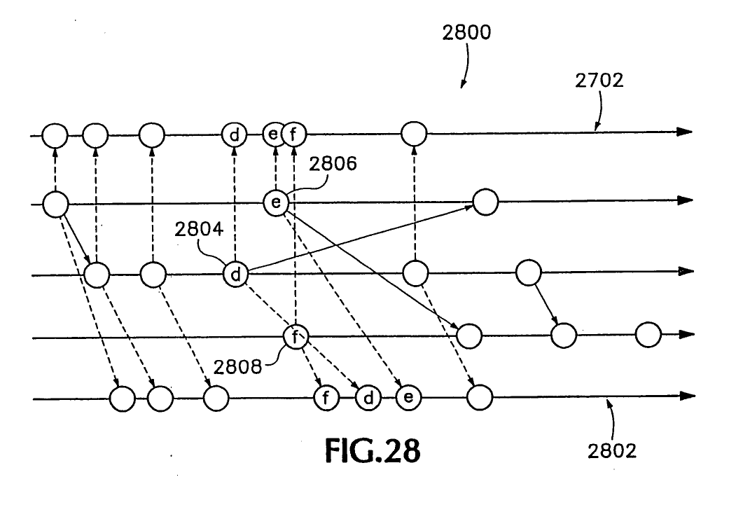

FIG. 28 shows a space/time graph 2800 showing two valid observations of a system taken by two separate observers: RTO 2702 and a third observer 2802. With reference to FIG. 28, there is nothing special about the ordering of the observation taken by RTO 2702. Events d 2804, e 2806, and f 2808 are all independent events in this execution. Therefore, the observation produced by RTO 2702 and the observation produced by third observer 2802 can each be used to reproduce equivalent executions of the system. Any observation in which event dependencies are preserved is typically equal in value to an observation by RTO 2702. However, real-time distributed systems may need additional processes to emulate timing constraints.

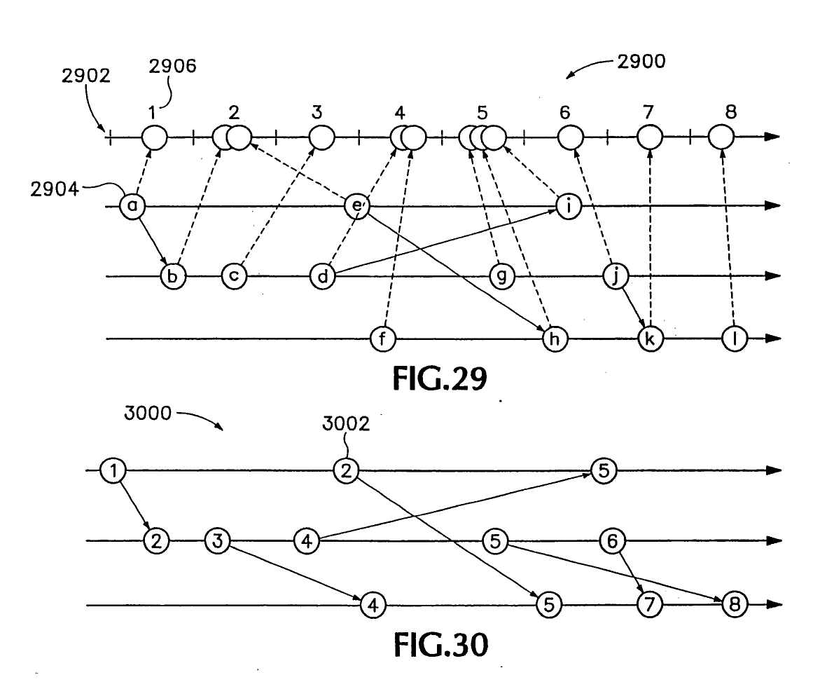

FIG. 29 is a space/time diagram 2900 of a methodological observer, called the discrete Lamport Observer (DLO) 2902, that records each event in a set of ordered bins. With reference to FIG. 29, DLO 2902 records an event 2904 in an ordered bin 2906 based on the following rule: each event is recorded in the leftmost bin that follows all events on which it depends. DLO 2902 views events discretely and does not need a clock. DLO 2902 does, however, require explicit knowledge of event dependency. To determine the bin in which each event must be placed, DLO 2902 needs to know the bins of the immediately preceding events. The observation produced by DLO 2902 is also referred to as a topological sort of the system execution's event graph.

In the following, E is the set of all events in an execution. The immediate predecessor relation, [symbol] ∪E×E, includes all pairs (eₐ, e_{b}) such that:
a) If eₐ and e_{b} are on the same process, eₐ precedes e_{b} with no intermediate events.
b) If e_{b} is a receive event, eₐ is the send event that generated the message.
   Given these conditions, eₐ is called the immediate predecessor of e_{b}.

Each event has at most two immediate predecessors. Therefore, DLO 2902 need only find the bins of at most two records before each placement. The transitive closure of the immediate predecessor relation forms a causal relation. The causal relation, [symbol] ∪E×E, is the smallest transitive relation such that eᵢ→eⱼ [symbol] [symbol] eⱼ.

This relation defines a partial order of events and further limits the definition of a valid observation. A valid observation is an ordered record of events from a given execution, i.e., (R, [symbol] ), where eεE [symbol] (record(e)) εR and [symbol] is an ordering operator. A valid observation has:
eᵢ; eⱼεE, eᵢ [symbol] eⱼ [symbol] record (eᵢ) [symbol] record (eⱼ)

The dual of the causal relation is a concurrence relation. The concurrence relation, E×E, includes all pairs (eₐ, e_{b}) such that neither eₐ [symbol] e_{b} nor e_{b} [symbol] eₐ. While the causal relation is transitive, the concurrence relation is not. The concurrence relation is symmetric, while the causal relation is not.

B. Event-Order Tracking

Debugging typically requires an understanding of the order in which events occur. Above, observers were presented as separate processes. While that treatment simplified the discussion of observers it is typically not a practical implementation of an observer. When the observer is implemented as a physical process, the signals to indicate events would have to be transformed into physical messages and the system would have to be synchronized to enable all messages to arrive in a valid order.

FIG. 30 depicts a space/time graph 3000 with each event having a label 3002. With reference to FIG. 30, DLO 2902 can accurately place event records in their proper bins—even if received out of order—as long as it knows the bins of the immediate predecessors. If we know the bins in which events are recorded, we can determine something about their causality. Fortunately, it is easy to label each event with the number of its intended bin. Labels 3002 are analogous to time and are typically called Lamport timestamps.

A Lamport timestamp is an integer t associated with an event eᵢ such that
eᵢ [symbol] eⱼ [symbol] t(eᵢ)<t(eⱼ)
Lamport timestamps can be assigned as needed, provided the labels of an event's immediate predecessors are known. This information can be maintained with a local counter, called a Lamport clock (not shown), t_{Pi}, on each process, Pᵢ. The clock's value is transmitted with each message Mⱼ as t_{Mj}. Clock value tpi is updated with each event, as follows:

$$tpi = \{ \begin{matrix}max ( tMj , tpi ) + 1 ; & if e is a receive event \\ tpi + 1 ; & otherwise\end{matrix} \}$$

A labeling mechanism is said to characterize the causal relation if, based on their labels alone, it can be determined whether two events are causal or concurrent. Although Lamport timestamps are consistent with causality (if t(eᵢ)≧t(eⱼ), then eᵢeⱼ), they do not characterize the causal relation.

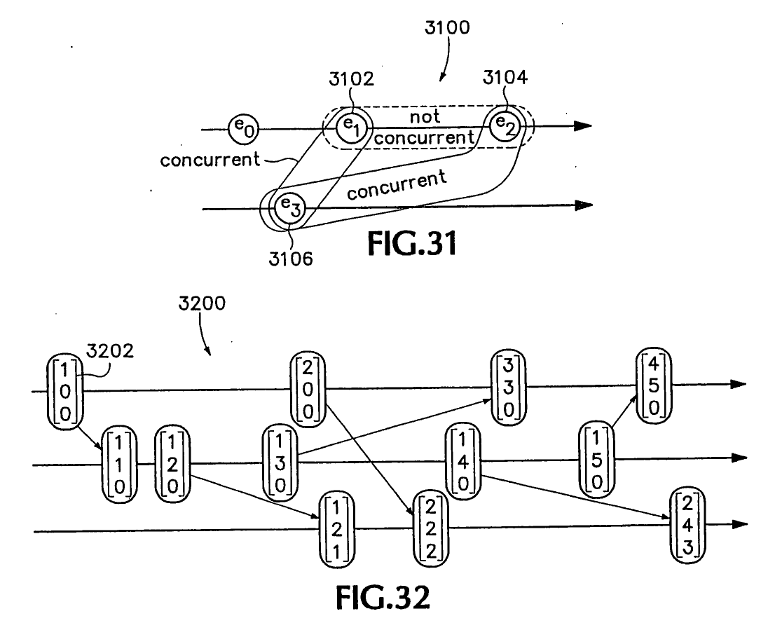

FIG. 31 is a space/time graph 3100 that demonstrates the inability of scalar timestamps to characterize causality between events. With reference to FIG. 31, space/time graph 3100 shows event e₁ 3102, event e₂ 3104, and event e₃ 3106. e₁ 3102 causes e₂ 3104, and also e₁ 3102 is concurrent with e₃3106 e₂ 3104 is concurrent with e₃ 3106 and it can be shown that e₃ 3106 appears, when scalar timestamps are used, concurrent with both e₁ 3102 and e₂ 3104. However, since e₁ 3102 [symbol] e₂ 3104 it is not possible for e₃ 3106 to be concurrent with both.

Event causality can be tracked completely using explicit event dependence graphs, with directed edges from each event to its immediate predecessors. Unfortunately, this method cannot store enough information with each record to determine whether two arbitrarily chosen events are causally related without traversing the dependence graph.

Other labeling techniques, such as vector timestamps, can characterize causality. The typical formulation of vector timestamps is based on the cardinality of event histories. A basis for vector timestamp is established based on the following definitions and theorems. An event history, H(eⱼ), of an event eⱼ is the set of all events, eᵢ, such that either since eᵢ [symbol] eⱼ or eᵢ [symbol] eᵢ=eⱼ. The event history can be projected against specific processes. For a process Pⱼ: the Pⱼ history projection of H(eᵢ), H_{Pj} (eᵢ), is the intersection of H(eᵢ) and the set of events local to Pⱼ. The event graph represented by a space/time diagram can be partitioned into equivalence classes, with one class for each process. The set of events local to Pⱼ is just the Pⱼ equivalence class.

The intersection of any two projections from the same process is identical to at least one of the two projections. Two history projections from a single process, Hp(a) and Hp(b), must satisfy one of the following:
a) Hp(a)⊂Hp(b)
b) Hp(a)=Hp(b)
c) Hp(a)⊃Hp(b)
   The cardinality of H_{Pj} (eᵢ) is thus the number of events local to Pⱼ that causally precede eᵢ and eᵢ itself. Since local events always occur in sequence, we can uniquely identify an event by its process and the cardinality of its local history. For events eₐ; e_{b} with eₐ≠e_{b}, H_{Pea}(eₐ)⊂H_{Pea}(e_{b}) [symbol] eₐ [symbol] e_{b}

FIG. 32 shows a space/time diagram 3200 with vector timestamped events. A vector timestamp 3202 is a vector label, tₑ, assigned to each event, eεE, such that the i^{th} element represents [H_{Pi}(e)]. Given two events, e₁ and e₂, we can determine their causal ordering: if vector tₑᵢ has a smaller value for its own process's entry than the other, tₑⱼ, has at that same position, then ei [symbol] ej. If both vectors have larger values for their own process entries, then eᵢ∥eⱼ. It is not possible for both events to have smaller values for their own entries because for events eₐ and e_{b}, eₐe_{b} implies H_{Pea}(eₐ)⊃H_{Pea}(e_{b}). It is not necessary to know the local processes of events to determine their causal order using vector timestamps.

The causal order of two vector timestamped events, ea and eb, from unknown processes can be determined with an element-by-element comparison of their vector timestamps:

$${{⋀}^{n}}_{i = 1} {t}_{ea} [ i ] \leq {t}_{ea} [ i ] ⇒ {e}_{a} -> {e}_{a}$$

$$⫬ {{⋀}^{n}}_{i = 1} {t}_{ea} [ i ] \leq {t}_{eb} [ i ] ⋀ \\ ⫬ {{⋀}^{n}}_{i = 1} {t}_{eb} [ i ] \leq {t}_{ea} [ i ] ⇒ {e}_{a} ‖ {e}_{b}$$

Thus vector timestamps both fully characterize causality and uniquely identify each event in an execution.

Computing vector timestamps at runtime is similar to Lamport timestamp computation. Each process (Pₛ) contains a vector clock (\hat{t}_{Ps}) with elements for every process in the system, where \hat{t}_{Ps}[S] always equals the number of events local to Pₛ. Snapshots of this vector counter are used to label each event, and snapshots are transmitted with each message. The recipient of a message with a vector snapshot can update its own vector counter (\hat{t}_{Pr}) by replacing it with sup(\hat{t}_{Ps}, \hat{t}_{Pr}), the element-wise maximum of \hat{t}_{Ps} and \hat{t}_{Pr}.

This technique places enough information with each message to determine message ordering. It is performed by comparing snapshots attached to each message. However, transmission of entire snapshots is usually not practical, especially if the system contains a large number of processes.

Vector clocks can however be maintained without transmitting complete snapshots. A transmitting process, Pₛ, can send a list that includes only those vector clock values that have changed since its last message. A recipient, Pᵣ, then compares the change list to its current elements and updates those that are smaller. This requires each process to maintain several vectors: one for itself and one for each process to which it has sent messages. However, change lists do not contain enough information to independently track message order.

The expense of maintaining vector clocks can be a strong deterrent to employing them. Unfortunately, no technique with smaller labels can characterize causality. It has been proven that the dimension of the causal relation for an N-process distributed execution is N, and hence N-element vectors are the smallest labels characterizing causality.

The problem results from concurrence, without which Lamport time would be sufficient. Concurrence can be tracked with concurrency maps where each event keeps track of all events with which it is concurrent. Since the maps characterize concurrency, adding Lamport time lets them also characterize causality (the concurrency information disambiguates the scalar time). Unfortunately, concurrency maps can only be constructed after-the-fact, since doing so requires an examination of events from all processes.

In some situations, distinguishing between concurrency and causality is not a necessity, but merely a convenience. There are compact labeling techniques that allow better concurrence detection than Lamport time. One such technique uses interval clocks in which each event record is labeled with its own Lamport time and the Lamport time of its earliest successor. This label then represents a Lamport time interval, during which the corresponding event was the latest known by the process. This gives each event a wider region with which to detect concurrence (indicated by overlapping intervals).

In cases in which there is little or no cross-process causality (few messages), interval timestamps are not much better than Lamport timestamps. In cases with large numbers of messages, however, interval timestamps can yield better results.

C. Space/Time Displays in Debugging Tools

Space/time diagrams have typically proven useful in discussing event causality and concurrence. Space/time diagrams are also often employed as the user display in concurrent program debugging tools.

The Los Alamos parallel debugging system uses a text based time-process display, and Idd uses a graphic display. Both of these, however, rely on an accurate global real-time clock (impractical in most systems).

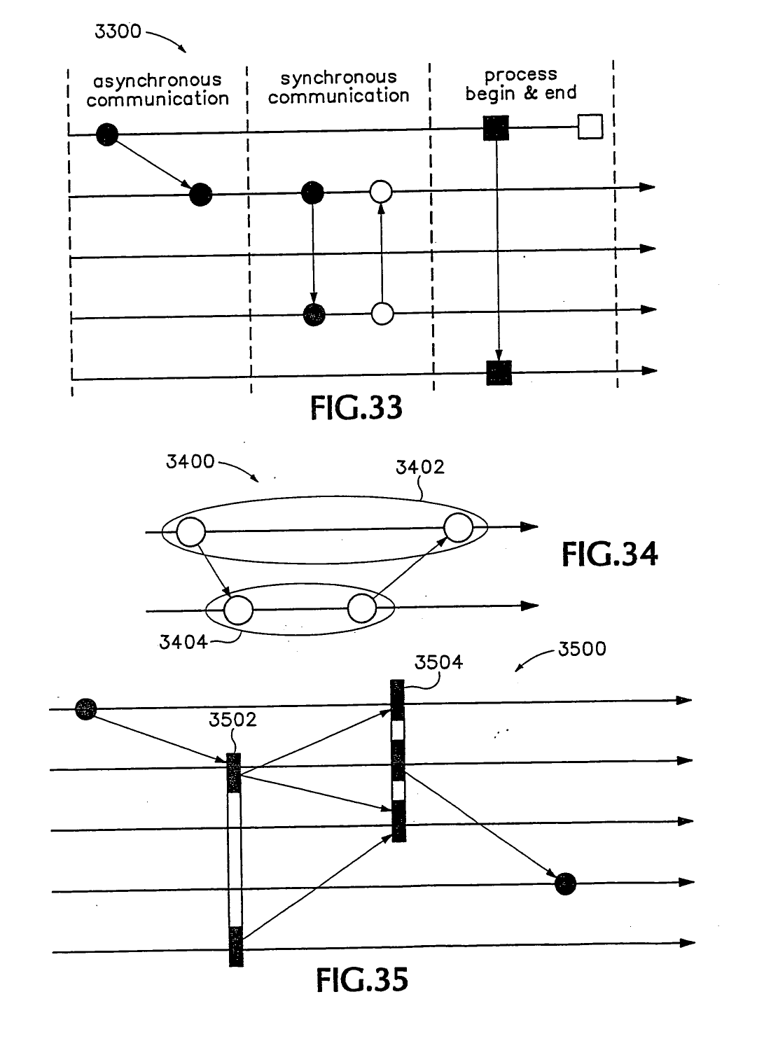

FIG. 33 shows a partial order event tracer (POET) display 3300. The partial order event tracer (POET) system supports several different languages and run-time environments, including Hermes, a high-level interpreted language for distributed systems, and Java. With reference to FIG. 33, POET display 3300 distinguishes among several types of events by shapes, shading, and alignment of corresponding message lines.

A Distributed Program Debugger (DPD) is based on a Remote Execution Manager (REM) framework. The REM framework is a set of servers on interconnected Unix machines in which each server is a Unix user-level process. Processes executing in this framework can create and communicate with processes elsewhere in the network as if they were all on the same machine. DPD uses space/time displays for debugging communication only, and it relies on separate source-level debuggers for individual processes.

2. Abstraction in Event-Based Debugging

Simple space/time displays can be used to present programmers with a wealth of information about distributed executions. Typically, however, space/time diagrams are too abstract to be an ultimate debugging solution. Space/time diagrams show high-level events and message traffic, but they do not support designer interaction with the source code. On the other hand, simple space/time diagrams may sometimes have too much detail. Space/time diagrams display each distinct low-level message that contributes to a high-level transaction without support for abstracting the transaction.

FIG. 34 is a space/time diagram 3400 having a first compound event 3402 and a second compound event 3404. With reference to FIG. 34, even though a pair of primitive events are either causally related or concurrent, first and second compound events 3402 and 3404, or any other pair of compound events, might be neither causally related nor concurrent. Abstraction is typically applied across two dimensions—events and processes—to aid in the task of debugging distributed software. Event abstraction represents sequences of events as single entities. A group of events may occasionally have a specific semantic meaning that is difficult to recognize, much as streams of characters can have a meaning that is difficult to interpret without proper spacing and punctuation. Event abstraction can in some circumstances complicate the relationships between events.

Event abstraction can be applied in one of three ways: filtering, clustering, and interpretation. With event filtering, a programmer describes event types that the debugger should ignore, which are then hidden from view. With clustering, the debugger collects a number of events and presents the group as a single event. With interpretation, the debugger parses the event stream for event sequences with specific semantic meaning and presents them to a programmer.

Process abstraction is usually applied only as hierarchical clustering. The remainder of this section discusses these specific event and process abstraction approaches.

A. Event Filtering and Clustering

Event filtering and clustering are techniques used to hide events from a designer and thereby reduce clutter. Event filters exclude selected events from being tracked in event-based debugging techniques. In most cases, this filtering is implicit and cannot be modified without changing the source code because the source code being debugged is designed to report only certain events to the debugger. When deployed, the code will report all such events to the tool. This approach is employed in both DPD and POET, although some events may be filtered from the display at a later time.

An event cluster is a group of events represented as a single event. The placement of an event in a cluster is based on simple parameters, such as virtual time bounds and process groups. Event clusters can have causal ambiguities. For example, one cluster may contain events that causally precede events in a second cluster, while other events causally follow certain events in the second cluster.

FIG. 35 shows a POET display 3500 involving a first convex event cluster 3502 and a second convex event cluster 3504. POET uses a virtual-time-based clustering technique that represents convex event clusters as single abstract events. A convex event cluster is a set of event instances, C, such that for events
a, b, cεE with a, cεC, a [symbol] b\hat{ }b [symbol] c [symbol] bεC
   Convex event clusters, unlike generic event clusters, cannot overlap.

B. Event Interpretation (Specific Background for Behavioral Abstraction)

The third technique for applying event abstraction is interpretation, also referred to as behavioral abstraction. Both terms describe techniques that use debugging tools to interpret the behavior represented by sequences of events and present results to a designer. Most approaches to behavioral abstraction let a designer describe sequences of events using expressions, and the tools recognize the sequence of events through a combination of customized finite automata followed by explicit checks. Typically, matched expressions generate new events.

1. Event Description Language (EDL)

One of the earliest behavioral abstraction technique was Bates's event description language (EDL) in which event streams are pattern-matched using shuffle automata. A match produces a new event that can, in turn, be part of another pattern. Essentially, abstract events are hierarchical and are built from the bottom up.

This approach can recognize event patterns that contain concurrent events. There are, however, several weaknesses in this approach. First, shuffle automata match events from a linear stream, which is subject to a strong observational bias. In addition, even if the stream constitutes a valid observation, interleaving may cause false intermediates between an event and its immediate successor. Finally, concurrent events appear to occur in some specific order.

Bates partially compensates for these problems in three ways. First, all intermediates between two recognized events are ignored—hence, false intermediates are skipped. Unfortunately, true intermediates are also skipped, making error detection difficult. Second, the shuffle operator, Δ, is used to identify matches with concurrent events. Unfortunately, shuffle recognizes events that occur in any order, regardless of whether they are truly ordered in the corresponding execution. For example, e₁Δe₂ can match with either e₁ [symbol] e₂ or e₂ [symbol] e₁ in the event stream, but this means the actual matches could be: e₁ [symbol] e₂, e₂ [symbol] e₁, in addition to the e₁∥e₂ that the programmer intended to match. Third, the programmer can prescribe explicit checks to be performed on each match before asserting the results. However, the checks allowed do not include causality or concurrence checks.

2. Chain Expressions

Chain expressions, used in the Ariadne parallel debugger, are an alternate way to describe distributed behavior patterns that have both causality and concurrence. These behavioral descriptions are based on chains of events (abstract sequences not bound to processes), p-chains (chains bound to processes), and pt-chains (composed p-chains). The syntax for describing chain expressions is fairly simple, with <a b> representing two causally related events and |[a b]| representing two concurrent events.

The recognition algorithm has two functions. First, the algorithm recognizes the appropriate event sequence from a linear stream, using a nondeterminate finite automaton (NFA). Second, the algorithm checks the relationships between specific events

For example, when looking for sequences that match the expression <|[a b]| c> (viz., a and b are concurrent, and both causally precede c), Ariadne will find the sequence a b c and then verify the relationships among them. Unfortunately, the fact that sequences are picked in order from a linear stream before relationships are checked can cause certain matches to be missed. For example, |[a b]| and |[b a]| should have the same meaning, but they do not cause identical matches. This is because Ariadne uses NFAs as the first stage in event abstraction. In the totally ordered stream to which an NFA responds, either a will precede b, preventing the NFA for the second expression from recognizing the string, or b will precede a, preventing the NFA for the first expression from recognizing the string.

3. Distributed Abstraction

The behavioral abstraction techniques described so far rely on centralized abstraction facilities. These facilities can be distributed, as well. The BEE (Basis for distributed Event Environments) project is a distributed, hierarchical, event-collection system, with debugging clients located with each process.

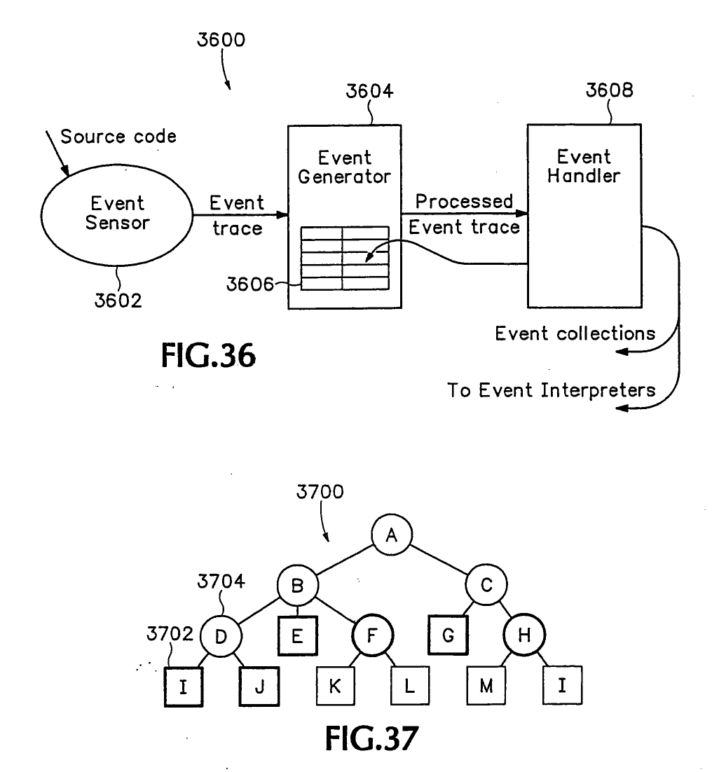

FIG. 36 show a Basis for distributed Event Environments (BEE) abstraction facility 3600 for a single client. With reference to FIG. 36, event interpretation is performed at several levels. The first is an event sensor 3602, inserted into the source of the program under test and invoked whenever a primitive event occurs during execution. The next level is an event generator 3604, where information—including timestamps and process identifiers—is attached to each event. Event generator 3604 uses an event table 3606 to determine whether events should be passed to an event handler 3608 or simply dropped. Event handler 3608 manages event table 3606 within event generator 3604. Event handler 3608 filters and collects events and routes them to appropriate event interpreters (not shown). Event interpreters (not shown) gather events from a number of clients (not shown) and aggregate them for presentation to a programmer. Clients and their related event interpreters are placed together in groups managed by an event manager (not shown). A weakness of this technique is that it does not specifically track causality. Instead, this technique relies on the real-timestamps attached to specific primitive or abstract events. However, as discussed above these timestamps are not able to characterize causality.

C. Process Clustering

Most distributed computing environments feature flat process structures, with few formally stated relationships among processes. Automatic process clustering tools can partially reverse-engineer a hierarchical structure to help remove spurious information from a debugger's view. Intuitively, a good cluster hierarchy should reveal, at the top level, high-level system behavior, and the resolution should improve proportionally with the number of processes exposed. A poor cluster hierarchy would show very little at the top level and would require a programmer to descend several hierarchical levels before getting even a rough idea about system behavior. Process clustering tools attempt to identify common interaction patterns—such as client-server, master-slave, complex server, layered system, and so forth. When these patterns are identified, the participants are clustered together. Clusters can then serve as participants in interaction patterns to be further clustered. These cluster hierarchies are strictly trees, as shown in FIG. 37, which depicts a hierarchical construction of process clusters 3700. With reference to FIG. 37, a square node 3702 represents a process (not shown) and a round node 3704 represents a process cluster (not shown).

Programmers can choose a debugging focus, in which they specify the aspects and detail levels they want to use to observe an execution. With reference to FIG. 37, a representative debugging focus that includes nodes I, J, E, F, G, and H is shown. One drawback of this approach is that when a parent cluster is in focus, none of its children can be. For example, if we wanted to look at process K in detail, we would also need to expose at least as much detail for processes E and L and process cluster D.

Each process usually participates in many types of interactions with other processes. Therefore, the abstraction tools must heuristically decide between several options. These decisions have a substantial impact on the quality of a cluster hierarchy. In “Abstract Behaviour of Distributed Executions with Applications to Visualization,” Ph.D. thesis, Technische Hochschule Darmstadt, Darmstadt, Germany, May 1994, by T. Kunz, the author evaluates the quality of his tool by measuring the cohesion, which though expressed quantitatively is actually a qualitative measurement (the higher the better) within a cluster and the coupling, a qualitative measure of the information clusters must know about each other (the higher the worse), between clusters. For a cluster P of m processes, cohesion is quantified by:

$$Cohesion ( P ) = \frac{{\sum }_{i < j} {Sim}_{f} ( {p}_{i} , {p}_{j} )}{m ( m - 1 ) / 2}$$

where Sim_{f} (P₁,P₂) is a similarity metric that equals:

$${Sim}_{f} = \frac{A 〈 {\hat{C}}_{{P}_{1}} \vert {\hat{C}}_{{P}_{2}} 〉}{‖ {\hat{C}}_{{P}_{1}} ‖ \cdot ‖ {\hat{C}}_{{P}_{2}} ‖}$$

Here, <â|\hat{b}> denotes the scaler product of vectors â and \hat{b}, and ∥â∥ denotes the magnitude of vector â. C_{P1} and C_{P2} are process characteristic vectors—in them, each element contains a value between 0 and 1 that indicates how strongly a particular characteristic manifests itself in each process. Characteristics can include keywords, type names, function references, etc. A is a value that equals 1 if any of the following apply:
P₁ and P₁ are instantiations of the same source.
P₁ and P₂ are unique instantiations of their own source.
P₁ and P₂ communicate with each other.

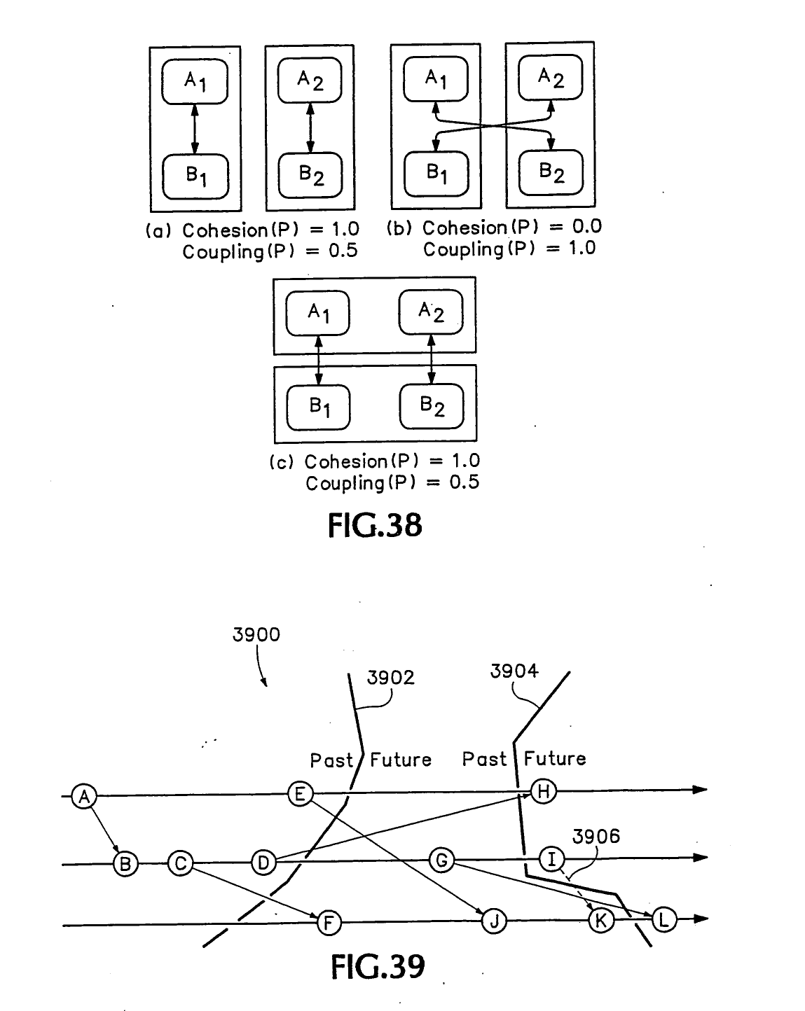

A equals 0 if none of these is true (e.g., P₁ and P₂ are nonunique instantiations of separate source that do not communicate with each other). Coupling is quantified by:

$$Coupling ( P ) = \frac{{\sum }_{ij} {Sim}_{f} ( {p}_{i} , {q}_{j} )}{mn}$$

where qⱼεQ, Q is the complement of P, and n=|Q|. The quality of a cluster is quantified as its Coupling minus its Cohesion. In many cases, these metrics match many of the characteristics that intuitively differentiate good and poor clusters, as shown in FIGS. 38A, B, and C. With reference to FIGS. 38A and C, Cohesion is high where clusters correspond to heavy communication and where clusters correspond to processes instantiated from the same source code. Coupling is shown to be low in each of the above cases. With reference to FIG. 38B, Coupling is high when clusters do not correspond to heavily communicating processes or to instances of the same source code. It is not clear, however, that the cluster in FIG. 38C should be assigned the same quality value as the cluster in FIG. 38A. Using these metrics, Kunz achieved qualities of between :15 and :31 for his clustering techniques. However, it is hard to tell what this means in terms of cluster usefulness.
3. State-Based Debugging

State-based debugging techniques focus on the state of the system and the state changes caused by events, rather than on events themselves. The familiar source-level debugger for sequential program debugging is state-based. This source-level debugger lets designers set breakpoints in the execution of a program, enabling them to investigate the state left by the execution to that point. This source-level debugger also lets programmers step through a program's execution and view changes in state caused by each step.

Concurrent systems have no unique meaning for an instant in execution time. Stopping or single-stepping the whole system can unintentionally, but substantially, change the nature of interactions between processes.

A. Consistent Cuts and Global State

In distributed event-based debugging, the concept of causality is typically of such importance that little of value can be discussed without a firm understanding of causality and its implications. In distributed state-based debugging, the concept of a global instant in time is equally important.

Here again, it may seem intuitive to consider real-time instants as the global instants of interest. However, just as determining the real-time order of events is not practical or even particularly useful, finding accurate real-time instants makes little sense. Instead, a global instant is represented by a consistent cut. A consistent cut is a cut of an event dependency graph representing an execution that (a) intersects each process exactly once and (b) points all dependencies crossing the cut in the same direction. Like real-time instants, consistent cuts have both a past and a future. These are the subgraphs on each side of the cut.

FIG. 39 shows that consistent cuts can be represented as a jagged line across the space/time diagram that meets the above requirements. With reference to FIG. 39, a space/time graph 3900 is shown having a first cut 3902 and a second cut 3904. All events to the left of either first cut 3902 or second cut 3904 are in the past of each cut, and all events to the right are in the future of each cut, respectively. First cut 3902 is a consistent cut because no message travels from the future to the past. Second cut 3904, however, is not consistent because a message 3906 travels from the future to the past.

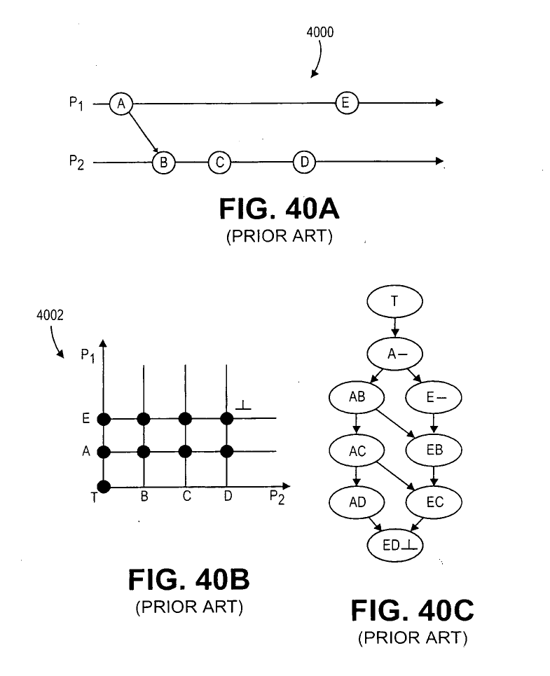

FIGS. 40A, B, and C show that a distributed execution shown in a space/time diagram 4000 can be represented by a lattice of consistent cuts 4002, in which [symbol] is the start of the execution and ⊥ is system termination. With reference to FIGS. 40A, B, and C, lattice of consistent cuts 4002 represents the global statespace traversed by a single execution. Since lattice of consistent cuts 4002's size is on the order of |E|^{|P|}, it, unlike space/time diagrams, is never actually constructed. In the remainder of this chapter, to describe properties of consistent cut lattices, the symbol [symbol] relates cuts such that one immediately precedes the other and [symbol] relates cuts between which there is a path.

B. Single Stepping in a Distributed Environment

Controlled stepping, or single-stepping, through regions of an execution can help with an analysis of system behavior. The programmer can examine changes in state at the completion of each step to get a better understanding of system control flow. Coherent single-stepping for a distributed system requires steps to align with a path through a normal execution's consistent cut lattice.

DPD works with standard single-process debuggers (called client debuggers), such as DBX, GDB, etc. Programmers can use these tools to set source-level break-points and single-step through individual process executions. However, doing so leaves the other processes executing during each step, which can yield unrealistic executions.

Zernic gives a simple procedure for single-stepping using a post-mortem traversal of a consistent cut lattice. At each point in the step process, there are two disjoint sets of events: the past set, or events that have already been encountered by the stepping tool, and the future set, or those that have yet to be encountered. To perform a step, the debugger chooses an event, eᵢ, from the future such that any events it depends on are already in the past, i.e., there are no future events, e_{f}, such that e_{f} [symbol] eᵢ. This ensures that the step proceeds between two consistent cuts related by

$${⟶}^{l} .$$

The debugger moves this single event to the past, performing any necessary actions.

To allow more types of steps, POET's support for single-stepping uses three disjoint sets: executed, ready, and nonready. The executed set is identical to the past set in “Using Visualization Tools to Understand Concurrency,” by D. Zernik, M. Snir, and D. Malki, IEEE Software 9, 3 (1992), pp. 87-92. The ready set contains all events that are fully enabled by events in the future, and the contents of the nonready set have some enabling events in either the ready or nonready sets. Using these sets, it is possible to perform three different types of steps: global-step, step-over, and step-in. Global-step and step-over may progress between two consistent cuts not related

$${⟶}^{l}$$

(i.e., there may be several intermediate cuts between the step cuts).

A global-step is performed by moving all events from the ready set into the past. Afterwards, the debugger must move to the ready set all events in the nonready set whose dependencies are in the executed set. A global-step is useful when the programmer wants information about a system execution without having to look at any process in detail.

The step-over procedure considers a local, or single-process, projection of the ready and nonready sets. To perform a step, it moves the earliest event from the local projections into the executed set and executes through events on the other processes until the next event in the projection is ready. This ensures that the process in focus will always have an event ready to execute in the step that follows.

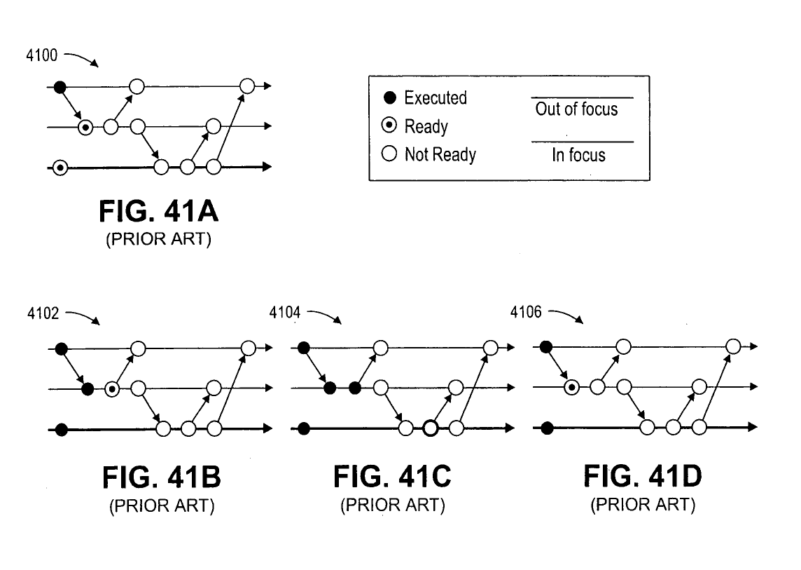

Step-in is another type of local step. Unlike step-over, step-in does not advance the system at the completion of the step; instead, the system advance is considered to be a second step. FIGS. 41A, B, C, and D show a space/time diagram before a step 4100 and a resulting space/time diagram after performing a global-step 4102, a step-over 4104, and a step-in 4106.

C. Runtime Consistent Cut Algorithms

It is occasionally necessary to capture consistent cuts at runtime. To do so, each process performs some type of cut action (e.g., state saving). This can be done with barrier synchronization, which erects a temporal barrier that no process can pass until all processes arrive. Any cut taken immediately before, or immediately after, the barrier is consistent. However, with barrier synchronization, some processes may have a long wait before the final process arrives.

A more proactive technique is to use a process called the cut initiator to send perform-cut messages to all other system processes. Upon receiving a perform-cut message, a process performs its cut action, sends a cut-finished message to the initiator, and then suspends itself. After the cut initiator receives cut-finished messages from all processes, it sends each of them a message to resume computation.

The cut obtained by this algorithm is consistent: no process is allowed to send any messages from the time it performs its own cut action until all processes have completed the cut. This means that no post-cut messages can be received by processes that have yet to perform their own cut action. This algorithm has the undesirable characteristic of stopping the system for the duration of the cut. The following algorithms differ in that they allow some processing to continue.

1. Chandy-Lamport Algorithm

The Chandy-Lamport algorithm does not require the system to be stopped. Once again, the cut starts when a cut initiator sends perform-cut messages to all of the processes. When a process receives a perform-cut message, it stops all work, performs its cut action, and then sends a mark on each of its outgoing channels; a mark is a special message that tells its recipient to perform a cut action before reading the next message from the channel. When all marks have been sent, the process is free to continue computation. If the recipient has already performed the cut action when it receives a mark, it can continue working as normal.

Each cut request and each mark associated with a particular cut are labeled with a cut identifier, such as the process ID of the cut initiator and an integer. This lets a process distinguish between marks for cuts it has already performed and marks for cuts it has yet to perform.

2. Color-Based Algorithms

The Chandy-Lamport algorithm works only for FIFO (First In First Out) channels. If a channel is non-FIFO, a post-cut message may outrun the mark and be inconsistently received before the recipient is even aware of the cut, i.e., it is received in the cut's past. The remedy to this situation is a color-based algorithm. Two such algorithms are discussed below.

The first is called the two-color, or red-white, algorithm. With this algorithm, information about the cut state is transferred with each message. Each process in the system has a color. Processes not currently involved in a consistent cut are white, and all messages transmitted are given a white tag. Again, there is a cut initiator that sends perform-cut messages to all system processes. When a process receives this request, it halts, performs the cut action, and changes its color to red. From this point on, all messages transmitted are tagged with red to inform the recipients that a cut has occurred.

Any process can accept a white message without consequence, but when a white process receives a red message, it must perform its cut action before accepting the message. Essentially, white processes treat red messages as cut requests. Red processes can accept red messages at any time, without consequence.

A disadvantage of the two-color algorithm is that the system must reset all of the processes back to white after they have completed their cut action. After switching back, each process must treat red messages as if they were white until they are all flushed from the previous cut. After this, each process knows that the next red message it receives signals the next consistent cut.

This problem is addressed by the three-color algorithm, which resembles the two-color algorithm in that every process changes color after performing a cut; it differs in that every change in color represents a cut. For colors zero through two, if a process with the color c receives a message with the color (c−1) mod 3, it registers this as a message-in-flight (see below). On the other hand, if it receives a message with the color (c+1) mod 3, it must perform its cut action and switch color to (c+1) mod 3 before receiving the message. Of course, this can now be generalized to n-color algorithms, but three colors are usually sufficient.

Programmers may need to know about messages transmitted across the cut, or messages-in-flight. In the two-color algorithm, messages-in-flight are simply white messages received by red processes. These can all be recorded locally, or the recipient can report them to the cut initiator. In the latter case, each red process simply sends the initiator a record of any white messages received.

It is not safe to switch from red to white in the two-color algorithm until the last message-in-flight has been received. This can be detected by associating a counter with each process. A process increments its counter for each message sent and decrements it for each message received. When the value of this counter is sent to the initiator at the start of each process's cut action, the initiator can use the total value to determine the total number of messages-in-flight. The initiator simply decrements this count for each message-in-flight notification it receives.

D. State Recovery-Rollback and Replay

Since distributed executions tend to be nondeterministic, it is often difficult to reproduce bugs that occur during individual executions. To do so, most distributed debuggers contain a rollback facility that returns the system to a previous state. For this to be feasible, all processes in the system must occasionally save their state. This is called checkpointing the system. Checkpoints do not have to save the entire state of the system. It is sufficient to save only the changes since the last checkpoint. However, such incremental checkpointing can prolong recovery.

DPD makes use of the UNIX fork system call to perform checkpointing for later rollback. When fork is called, it makes an exact copy of the calling process, including all current states. In the DPD checkpoint facility, the newly forked process is suspended and indexed. Rollback suspends the active process and resumes an indexed process. The problem with this approach is that it can quickly consume all system memory, especially if checkpointing occurs too frequently. DPD's solution is to let the programmer choose the checkpoint frequency through use of a slider in its GUI.

Processes must sometimes be returned to states that were not specifically saved. In this case, the debugger must do additional work to advance the system to the desired point. This is called replay and is performed using event trace information to guide an execution of the system. In replay, the debugger chooses an enabled process (i.e., one whose next event has no pending causal requirements) and executes it, using the event trace to determine where the process needs to block for a message that may have arrived asynchronously in the original execution. When the process blocks, the debugger chooses the next enabled process and continues from there. In this way, a replay is causally identical to the original execution.

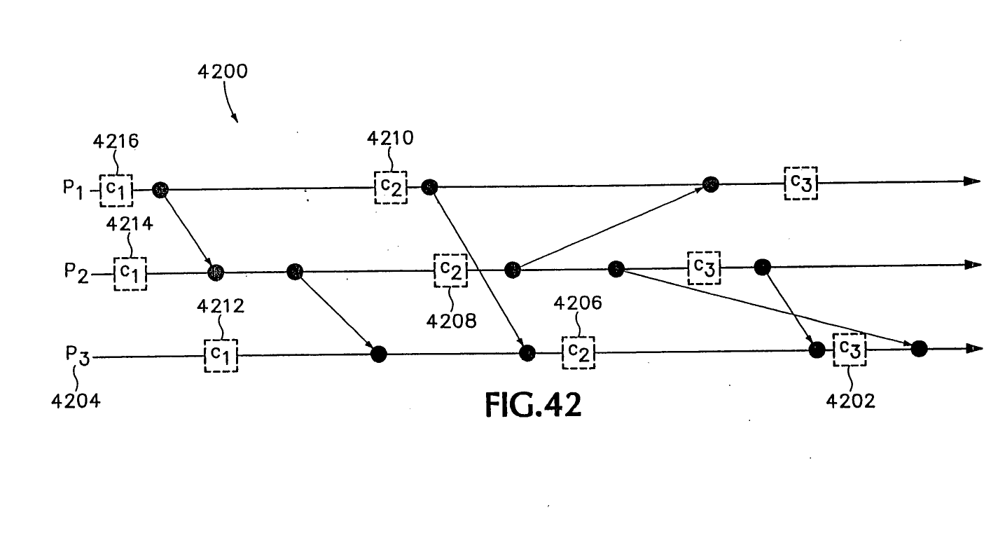

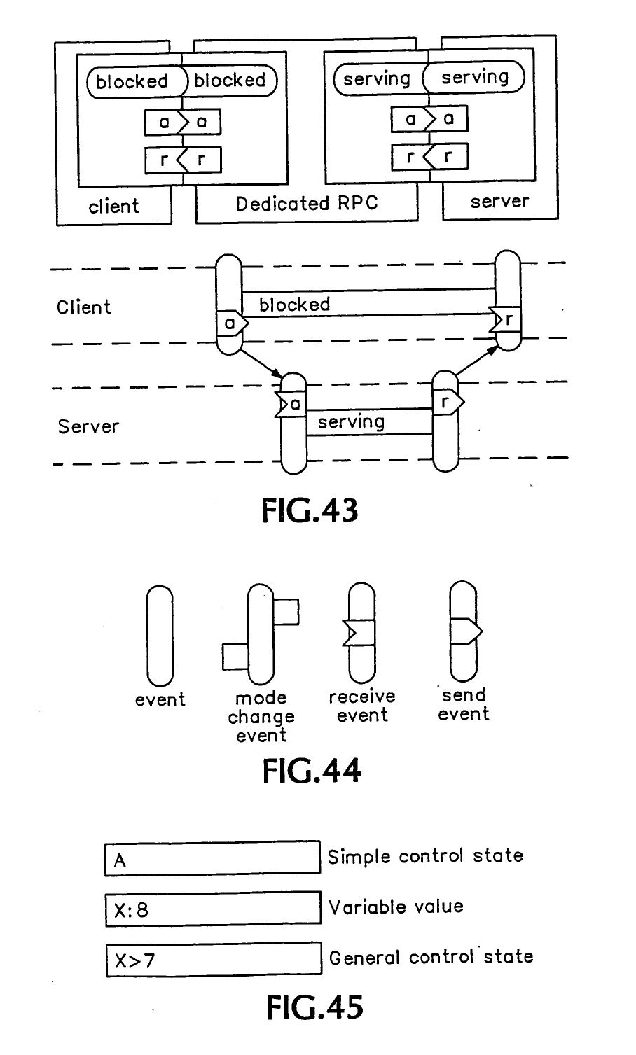

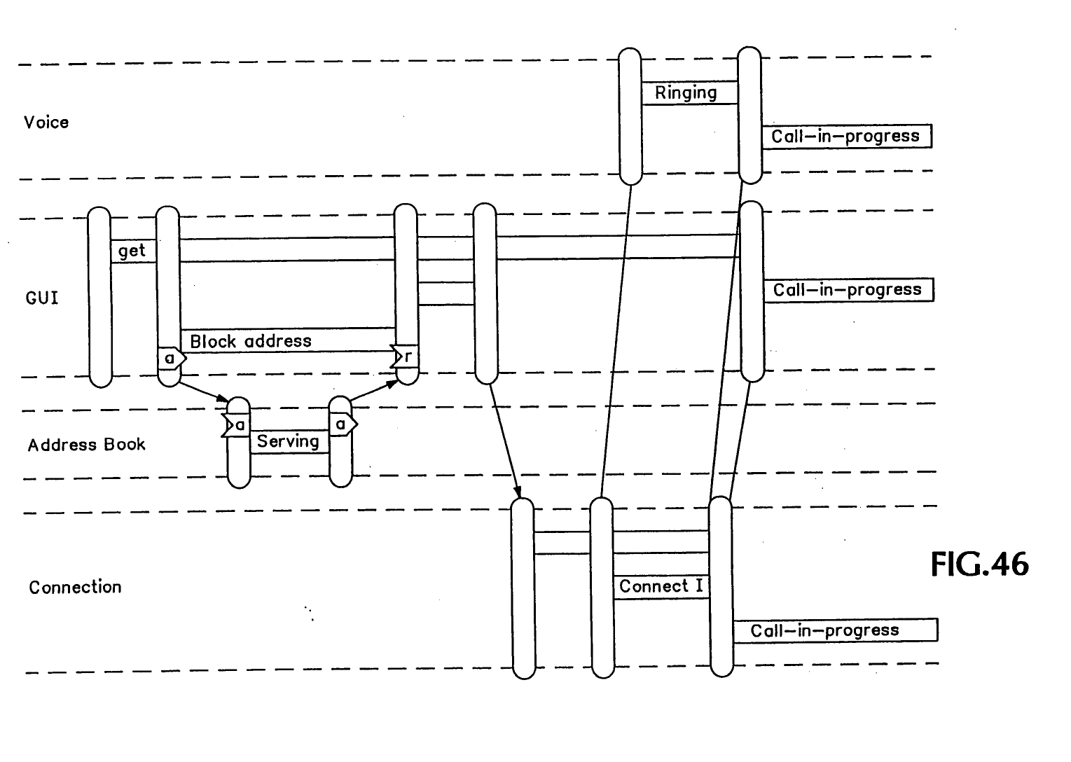

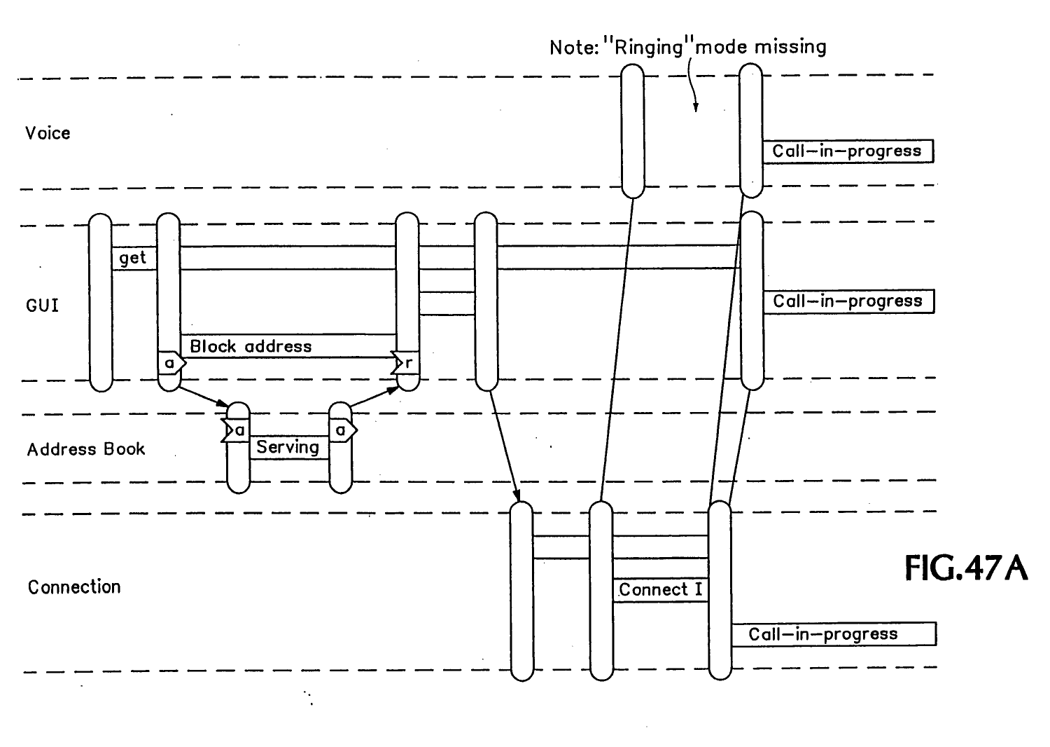

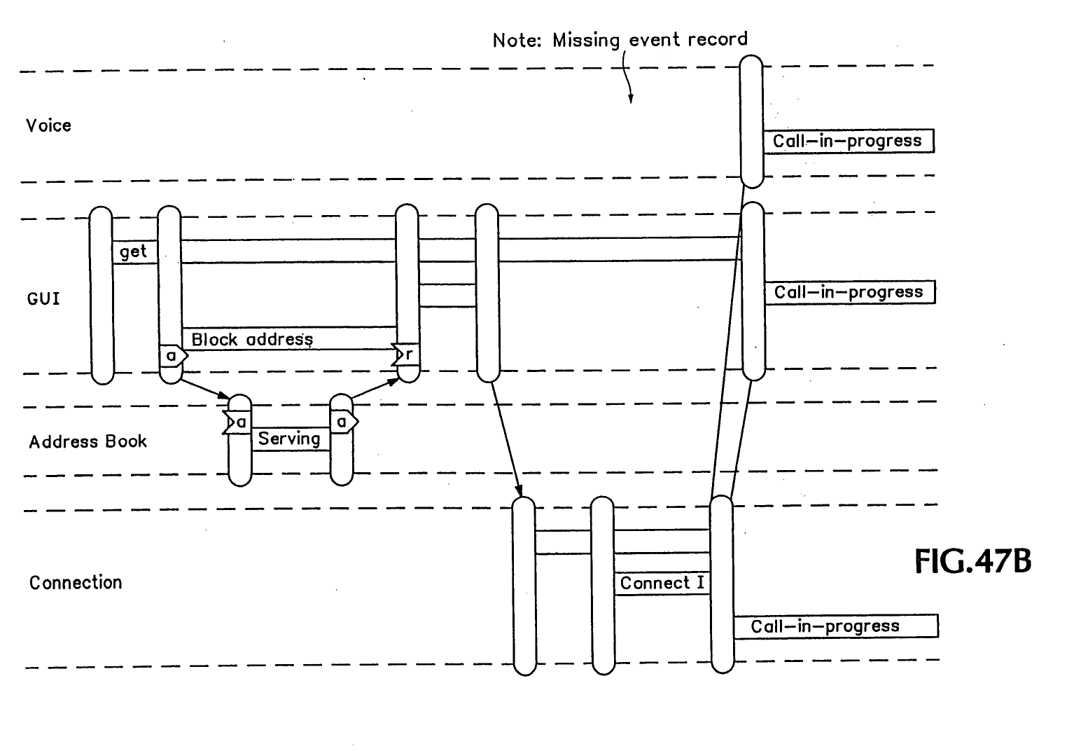

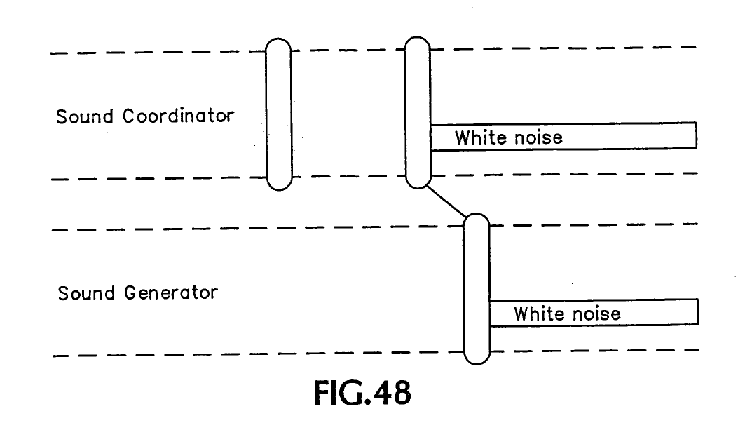

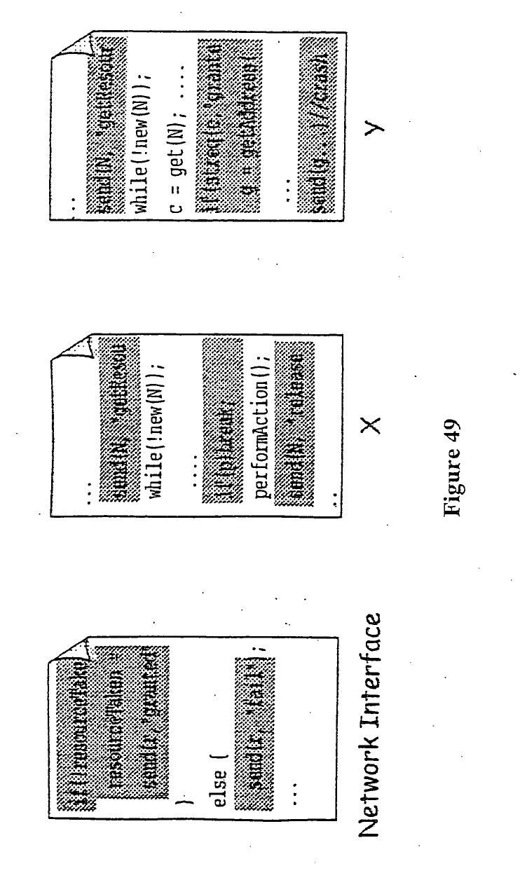

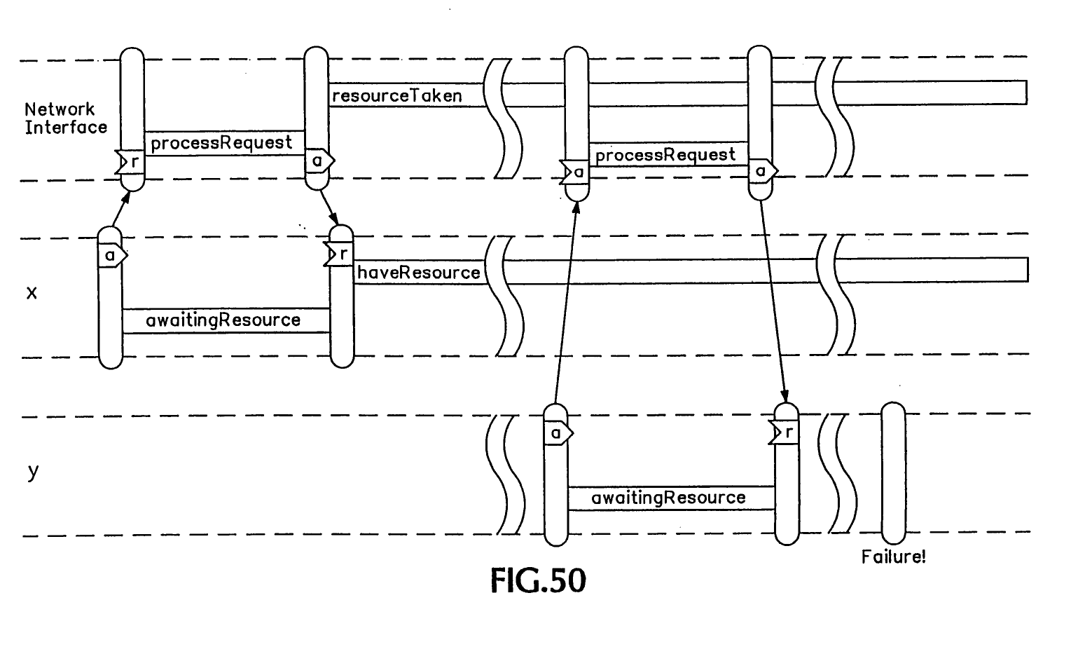

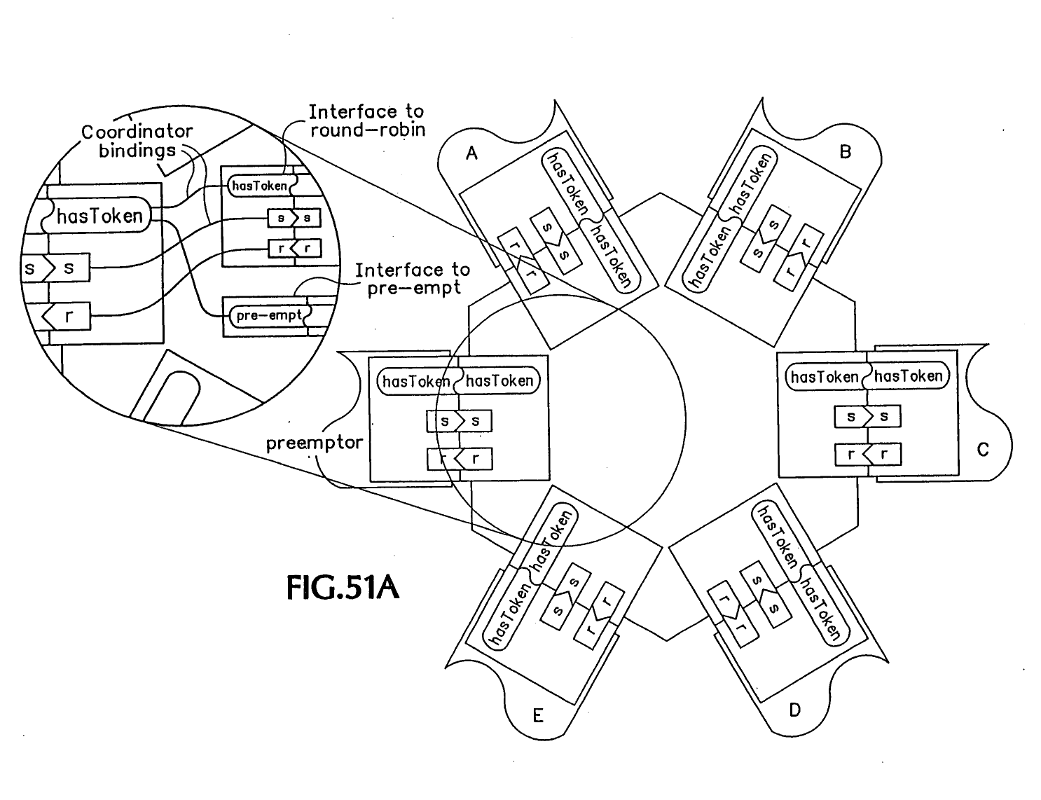

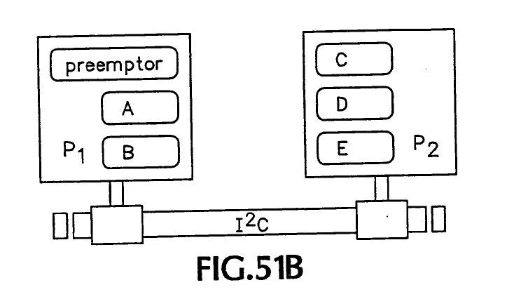

Checkpoints must be used in a way that prevents domino effects. The domino effect occurs when rollbacks force processes to restore more than one state. Domino effects can roll the system back to the starting point. FIG. 42 shows a space time diagram 4200 for a system that is subject to the domino effect during rollback. With reference to FIG. 42, if the system requests a rollback to checkpoint c₃ 4202 of process P₃ 4204, all processes in the system must roll back to c₁ (i.e., roll back to P₃. c₂ 4206 requires a roll back to P₂. c₂ 4208, which requires a roll back to P₁. c₂ 4210, which requires a roll back to P₃. c₁ 4212, which requires a roll back to P₂. c₁ 4214, which requires a final roll back to P₁. c₁ 4216). The problem is caused by causal overlaps between message transfers and checkpoints. Performing checkpoints only at consistent cuts avoids a domino effect.

E. Global State Predicates

The ability to detect the truth value of predicates on global state yields much leverage when debugging distributed systems. This technique lets programmers raise flags when global assertions fail, set global breakpoints, and monitor interesting aspects of an execution. Global predicates are those whose truth value depends on the state maintained by several processes. They are typically denoted with the symbol φ. Some examples include (Σᵢcᵢ>20) and (c₁<20\hat{ }c₂5), where cᵢ is some variable in process Pᵢ that stores positive integers. In the worst case (such as when (Σᵢ cᵢ>20) is false for an entire execution), it may be necessary to get the value of all such variables in all consistent cuts. In the following discussion, we use the notation Cₐ |=φ to indicate that φ is true in consistent cut Cₐ.

At this point, it is useful to introduce branching time temporal logic. Branching time temporal logic is predicate logic with temporal quantifiers, P, F, G, H, A, and E. Pφ is true in the present if φ was true at some point in the past; Fφ is true in the present if φ will be true at some point in the future; Gφ is true in the present if φ will be true at every moment in the future; and Hφ is true in the present if φ was true at every moment of the past. Notice that Gφ is the same as [symbol] F [symbol] φ, and Hφ is the same as [symbol] P [symbol] φ.

Since global time passage in distributed systems is marked by a partially ordered consistent cut lattice rather than by a totally ordered stream, we need the quantifiers A, which precedes a predicate that is true on all paths, and E, which precedes a predicate that is true on at least one path. So, AFφ is true in the consistent cut representing the present if φ is true at least once on all paths in the lattice leaving this cut. EPφ is true in the consistent cut representing the present if φ is true on at least one path leading to this cut.

A monotonic global predicate is a predicate φ such that Cₐ|=φ [symbol] Cₐ|=AGφ. A monotonic global predicate is one that remains true after becoming true. An unstable global predicate, on the other hand, is a predicate φ such that Cₐ|=φ [symbol] Cₐ|=EG [symbol] φ. An unstable global predicate is one that may become false after becoming true.

1. Detecting Monotonic Global Predicates

Monotonic predicates can be detected any time after becoming true. One algorithm is to occasionally take consistent cuts and evaluate the predicate at each. In fact, it is not necessary to use consistent cuts since any transverse cut whose future is a subset of the future of the consistent cut in which the predicate first became true will also show the predicate true.

2. Detecting Unstable Global Predicates

Detecting arbitrary unstable global predicates can take at worst |E|^{|P|} time, where |E|^{|P|} is the size of an execution's consistent cut lattice, [E] is the number of events in the execution, and [P] is the number of processes. This is so, because it may be necessary to test for the predicate in every possible consistent cut. However, there are a few special circumstances that allow |E| time algorithms.

Some unstable global predicates are true on only a few paths through the consistent cut lattice, while others are true on all paths. Cooper and Marzullo describe predicate qualifiers definitely φ for predicates that are true on all paths (i.e., [symbol] |=AFφ) and possibly φ for those that are true on at least one path (i.e., [symbol] |=>E Fφ).

The detection of possibly φ for weak conjunctive predicates, or global predicates that can be expressed as conjunctions of local predicates, is φ (|E|). The algorithm for this is to walk a path through the consistent cut lattice that aligns with a single process, Pₜ, until either (1) the process's component of φ is true or (2) there is no way to proceed without diverging from Pₜ. In either case, the target process is switched and the walk continued. This algorithm continues until it reaches a state in which all components of the predicate are true or until it reaches ⊥. In this way, if there are any consistent cuts where all parts of the predicate simultaneously hold, the algorithm will encounter at least one.

Detection of possibly φ for weak disjunctive predicates, or global predicates that can be expressed as disjunctions of local predicates, is also φ(|E|); it is the same algorithm as above, except it halts at the first node where any component is true. However, weak conjunctive and disjunctive predicates constitute only a small portion of the types of predicates that could be useful in debugging distributed systems.

4. Conclusions

Complicating the debugging of heterogenous embedded systems are designs composed of concurrent and distributed processes. Most of the difficulty in debugging distributed systems results from concurrent processes with globally unscheduled and frequently asynchronous interactions. Multiple executions of a system can produce wildly varying results—even if they are based on identical inputs. The two main debugging approaches for these systems are event based and state based.

Event-based approaches are monitoring approaches. Events are presented to a designer in partially ordered event displays, called space/time displays. These are particularly good at showing inter-process communication over time. They can provide a designer with large amounts of information in a relatively small amount of space.

State-based approaches focus locally on the state of individual processes or globally on the state of the system. Designers can observe individual system states, set watches for specific global predicates, step through executions, and set breakpoints based on global state predicates. These approaches deal largely with snapshots, considering temporal aspects only as differences between snapshots.

As distributed systems increase in size and complexity, the sheer volume of events generated during an execution grows to a point where it is exceedingly difficult for designers to correctly identify aspects of the execution that may be relevant in locating a bug. For distributed system debugging techniques to scale to larger and faster systems, behavioral abstraction will typically become a necessity to help designers identify and interpret complicated behavioral sequences in a system execution. Finally, embedded systems must execute in a separate environment from the one in which they were designed and embedded systems may also run for long periods of time without clear stopping points. Debugging them requires probes to report debugging information to a designer during the execution. These probes inevitably alter system behavior, which can mask existing bugs or create new bugs that are not present in the uninstrumented system. While it is not possible to completely avoid these probe effects, they can be minimized through careful placement, or masked through permanent placement.

Debugging Tools and Techniques for Coordination-Centric Software Designs

1. Evolution Diagrams

Evolution diagrams are visual representations of a system's behavior over time. They resemble the space/time diagrams discussed in Chapter 2, but they explicitly include information related to component behavior and changes in behavior caused by events. Evolution diagrams take advantage of the exposure provided by coordination interfaces to present more complete views of system executions than can be obtained from space/time diagrams.

Evolution diagrams explicitly show events, message traffic between components, changes in component behavior, and correlations between local behavior changes. Through them, designers can easily spot transaction failures and components operating outside of their expected model. Essentially, evolution diagrams are event graphs interpreted in the context of the system being debugged. While evolution diagrams do not aid the debugging of individual lines of action code, they can help designers pinpoint the specific action to debug. In Section 4.5.2, we discuss how source-level debuggers can be integrated coherently with evolution diagrams.

FIG. 43 portrays the evolution of a dedicated RPC transaction. It has traces for both components 4310 (bars enclosed by dashed lines), interface states 4312 (shown by solid horizontal bars), and events 4314 (shown by vertical ovals spanning the space affected by the event). The figure displays all essential aspects of an RPC transaction.

The remainder of this section describes event and state representations, event dependencies, the use of evolution diagrams with high-level simulation to detect transaction failures and inappropriate component behavior, and debugging issues that become evident at synthesis (“synthesis effects”).

Event Representations

Event representations display all event types described earlier (e.g., transmission and reception of data, changes in control state, and changes in more general shared state). Event representations have a name and can also have a visual cue, or icon, such as those shown in FIG. 44.

The design methodology described above clearly identifies the types of events that can be generated by each component. Although there are many more specific types than shown in FIG. 44, each specific type must be derived from one of those shown. For example, both RPC.Client.argument.send and RPC.server.return.send are derived from the primitive send event.

State Representations

Modes and other types of state are displayed as horizontal bars annotated with the name of the state and, where appropriate, the value. These bars extend across the duration of the mode or the value. See FIG. 43. Through state views, designers can monitor component behavior changes over time.

The types of state that can be displayed are the values of exported variables and control state. FIG. 45 shows illustrative primitive state types.

Event Dependencies

Events on different components may be connected explicitly by messages traveling between them or implicitly by coordinator constraints and actions, as described earlier. Explicit connections are displayed as arrows between transmit and receive events. Implicit connections are displayed as diagonal lines without arrows, where the event on the left side is the immediate predecessor of the event on the right side. These connections indicate dependencies in the underlying event graph. See the discussion above regarding FIG. 25, et seq.

Debugging with Evolution Diagrams

Evolution diagrams can be integrated with high-level simulation, letting designers fix many bugs before synthesis and mapping to a hardware architecture. FIG. 46 shows the evolution diagram of a correct lookup and an initiate call transaction for the mobile telephone example. This diagram shows the top level of the design hierarchy for the cell phone itself. The transaction begins when a user looks up a number in the address book. When the number is selected, the GUI sends it to the connection subsystem with a send action, which generates a send event 4604. It then waits for the connection to go through. This demonstrates the use of design hierarchy to hide information; many aspects of the GUI and connection subsystem's interaction are hidden from view, but the information presented gives a general idea about what is going on inside the system. The connection subsystem then contacts the call recipient and starts the ring signal in the voice subsystem 4608. When the recipient answers the phone, the GUI, the connection subsystem, and the voice subsystem all switch to the call-in-progress mode 4610 and begin the corresponding behavior.

If part of the transaction fails (for example, if the phone never plays a ring-back tone), the designer can often find the source of the problem in an evolution diagram. If the problem is caused by a control failure, the voice subsystem does not enter ringing mode, and designers would see something like the evolution diagrams shown in FIG. 47. FIG. 47A shows the results of a local control failure, where the voice subsystem receives the appropriate trigger 4710 but does not respond appropriately by moving into ring mode. FIG. 47B shows the same transaction, except that the problem is in the distributed control structure.

Selective Focus in Debugging

Selective focus describes techniques by which designers can limit the data presented based on its relevance at any point in time. Selective focus plays an important role in debugging with evolution diagrams. For example, designers begin debugging the 47 problem needing only high-level information about the system's behavior. Once the high-level source of the problem is found, designers can descend the design hierarchy to pinpoint the cause. FIG. 48 shows an expanded view of the voice subsystem, where, at the point of failure, the sound coordinator fails to switch on the “ringing” mode. A designer can now investigate the specific action responsible for this. With selective focus, the designer can quickly bore into the affected region to help identify the bug's cause.

Selective focus is also useful in debugging problems with layered coordination. Recall from FIG. 20 that there are several coordination layers between the call managers on the cell phone and the switching center, but that there is conceptual coordination between peer layers. This conceptual coordination enables a form of selective focus.

Consider an example where designers discover that a cell phone drops calls at random moments. Using standard good troubleshooting procedure, they begin debugging at the layer nearest the detected problem: call management. Using evolution diagrams and selective focus, the designers can investigate the bug on the call management layer without requiring details from lower layers. They can review the progress of the phone call up until the moment of the drop.

Assume the cause of the bug is elsewhere (for example, the radio resource layer sometimes fails when performing handoffs between cells), finding no specific problem in the call management layer, designers can proceed down the protocol stack to the mobility management layer and, finding no problem there, move on to the radio resource layer. At the radio resource layer, designers will find that, at the time of the drop off, the radio resource component was in the midst of executing a handoff, wherein the problem lies. Thus, they may immediately suspect that the cause of the problem was related to the handoff.

Correlating Disparate Behaviors

Consider a bug that manifests itself in interactions among several components. FIG. 49 shows the source code for components X, Y, and Network Interface, shading the aspects that participate in the bug. As shown, these participating sections of code are scattered across three files. Because of this scattering, and because the relevant sections of code do not execute at the same time, a designer is unlikely to spot the bug easily through source-level debugging techniques.

FIG. 50 shows an evolution diagram of a bug from a system built with the present methodology. At the point of failure, the evolution diagram shows that the network interface's resource is taken, and that X is clearly holding the resource. Scrolling back, we find that when Y tried to obtain the resource, it could not because X was still holding it. Scrolling back further, we may find a number of such repeated attempts, each with similar failures. And finally, scrolling back to the beginning, we find that grabbed the resource before Y's first attempt, and that never released it. We now know that X was the primary cause of the problem, and the problem is now reduced to debugging a single component.

Event Persistence

In each of the examples described above, it was necessary to review portions of the system execution several times to track down a bug. For the ring failure bug, we needed to review the failure to obtain detailed information about the voice component's behavior. For the call dropping bug, we needed to review the execution at least three times to trace the bug through the call management, mobility management, and radio resource layers. For the resource allocation bug, we needed to examine the behavior of component X in the vicinity of the bug to determine why it never released the resource. Repeated executions of a concurrent system with the same inputs can produce greatly varying results. Specific interactions may differ on each new execution, preventing designers from making progress in debugging.

To avoid this, and ensure that each execution is identical to the last, it is necessary to: (1) maintain a store of an execution's events and the relationships among them, and (2) provide our debugging tools with the means to traverse this store many times with differing perspectives. We can operate directly on this store, as described later.

Synthesis Effects

Designers inevitably make assumptions about relative timing that are not necessarily borne out by the implementation. Unfortunately, idealized simulation without regard for architectural issues can give designers a skewed perspective. It is only at synthesis that the actual timing between events and the relative timing between actions congeals. Solidifying timing concerns affects event orders and timing constraints. The synthesized system must be tested and validated by a designer.

An example of synthesis effects can be seen in the use of the round-robin/preempt coordinator described earlier. In this protocol, components usually take turns with the resource, but one of the components is a preemptor that can take over without waiting for its turn. A potential source of problems is that after preemption, control always returns to the component that follows the preemptor in the ring, not to the component that was preempted. This may still be a reasonable design decision, since distributed tracking of the preempted component can be expensive. However, in the mapping shown in FIG. 51, this combined protocol performs poorly.

As shown in FIG. 52A, before synthesis, this system approximates fair access to the resource. After synthesis, as shown in FIG. 52B, preemption seems to occur more frequently than expected. This results in components C, D, and E getting few or no chances to access the resource. In this case, a bug fix may be to alter the protocol so that it tracks the component that held the resource before preemption, to try different mappings to alter the situation so that preemption occurs less frequently, or to try different protocols altogether.

Behavioral Perspectives

Design hierarchy is a very important part of managing debugging complexity: it allows designers to observe what is happening in a system or component at a general level, and then further refine the view. Unfortunately, clusters that make sense for design purposes are not always the ones needed for debugging. FIG. 53A shows part of the design decomposition of the GUI module. To compare numbers generated by the keypad with packets sent out through the transport, designers need only be able to put the relevant parts into focus and represent the rest of the system as a cluster, as shown in FIG. 53B.

Behavioral perspectives allow designers to tailor selective focus for their convenience. A behavioral perspective is a set of clusters and filters, some of which may be derived from the design hierarchy, while others may be specified by a designer when the design hierarchy is not sufficient. Special-purpose clusters and filters are described below.

Special-Purpose Clusters

Designers use special-purpose clusters to help reduce the amount of clutter presented in a display without eliminating sources of information. There are three types of special-purpose clusters: component, event, and state. Component clusters combine several component traces into one; event clusters combine sequences of events on a single component into one; and state clusters combine several state traces into one. Designers can form clusters that are separate from the design hierarchy, as shown in FIG. 54.

Clusters can be described in two ways: visually, through selection on an evolution diagram, or textually, through cluster lists (see Listing number 1, as follows).

Listing 1:

```
        ClusterComponent “C1, C2” {
                C1, C2
}
ClusterStates C1. “Z” {
        C1. Q, C1. P
}
```

Special-Purpose Filters

Filters remove specific events, states, and even components from a designer's view. Using filters, designers can observe only the parts of an execution that pertain to a specific debugging objective. Filters work well with clusters to help a designer reduce the total noise in an evolution diagram.

Like clusters, filters can be described both visually and textually. Filter lists can have the form ALL except <event list>. Thus, in cases where there are more event types to be filtered than passed, a designer can use the filter lists to specify only those events that should be shown.

FIGS. 55A and 55B show before and after snapshots, respectively, of an evolution diagram using the filter description shown in Listing number 2, as follows:

Listing 2:

```
Filter {
    Components {
        C3
}
    States {
        ALL except C1.Q, C2.S
    }
Events {
        ALL except C1.a.send,
            C1.r.rec, C2.a.rec,
            C2.r.send
    }
}
```

Event type names in this listing have the form:
component_name.interface.specific_type.

The result of applying this filter clarifies an RPC-like aspect of this coordination. Designers can also use filters to expose events and states that are not normally visible at a particular level of focus.

It will be apparent to those having skill in the art that many changes may be made to the details of the above-described embodiment of this invention without departing from the underlying principles thereof. The scope of the present invention should, therefore, be determined only by the following claims.

2. Visual Prototypes of System Behavior

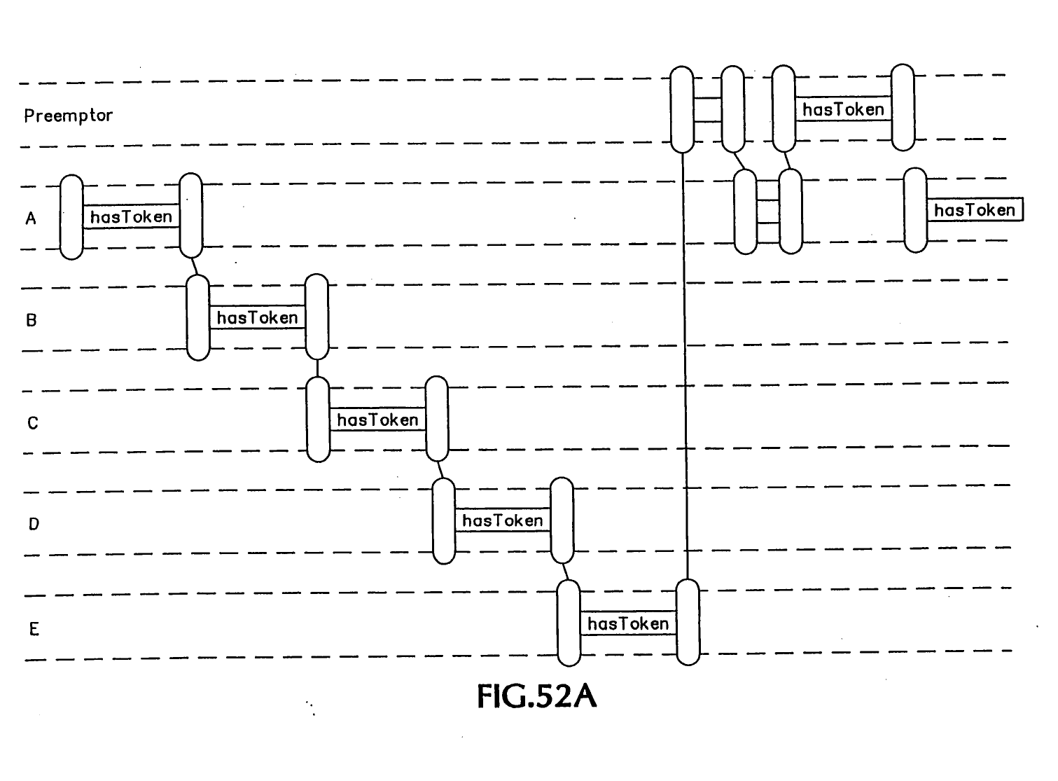

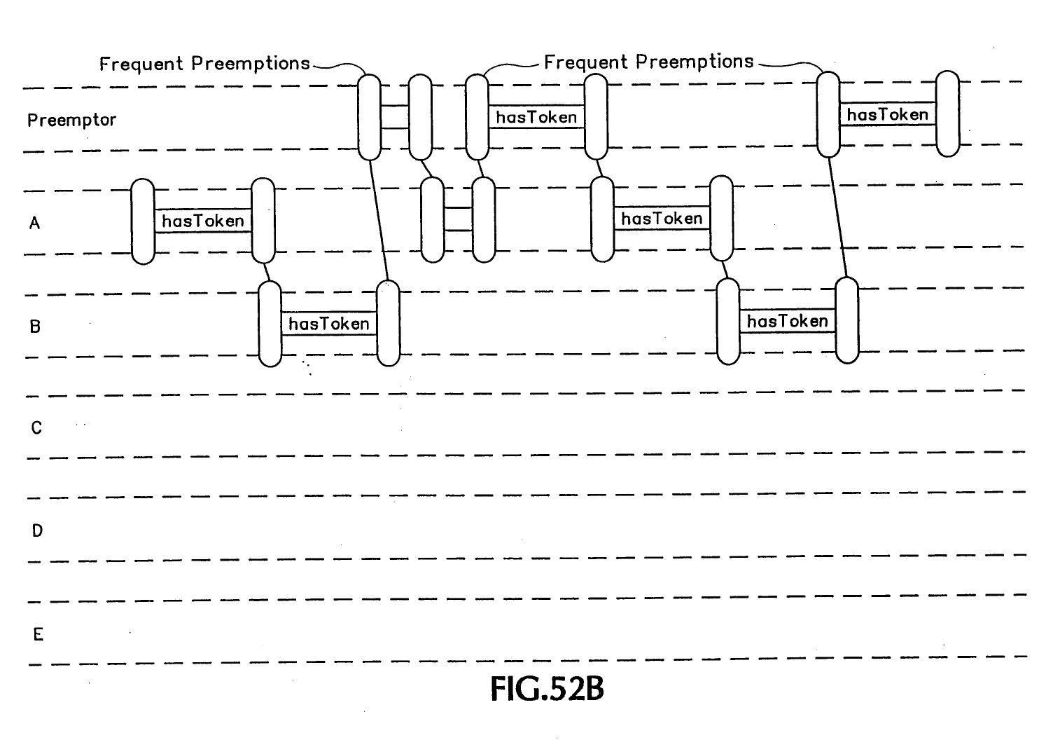

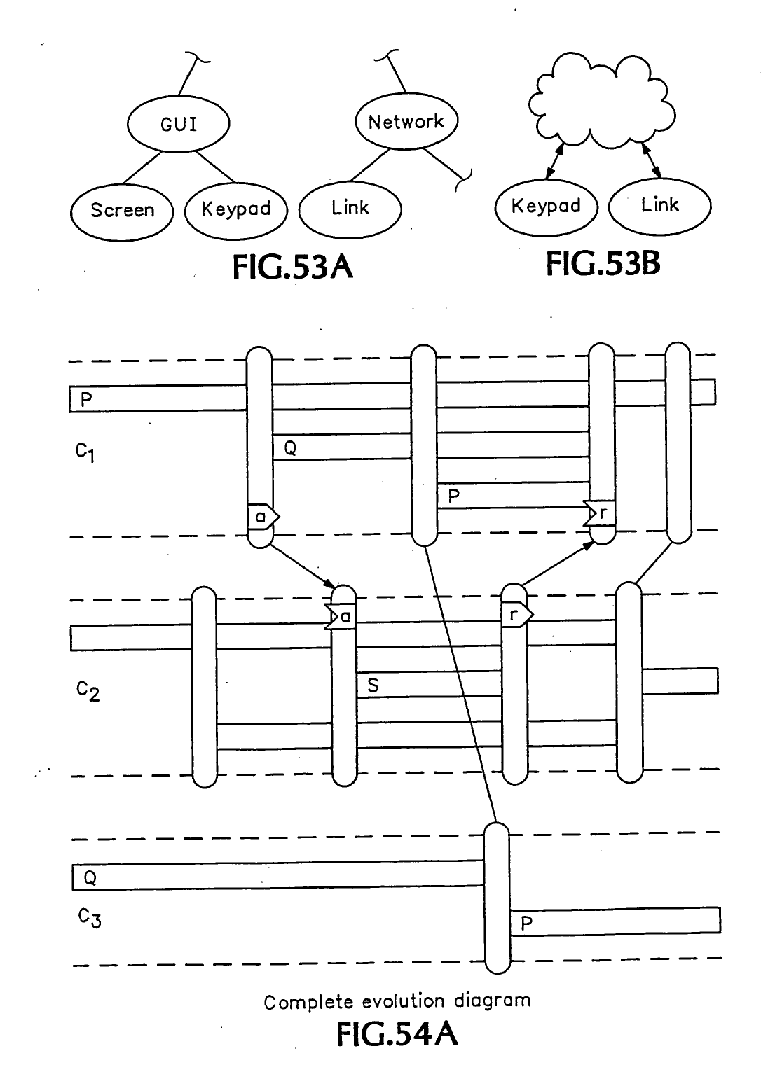

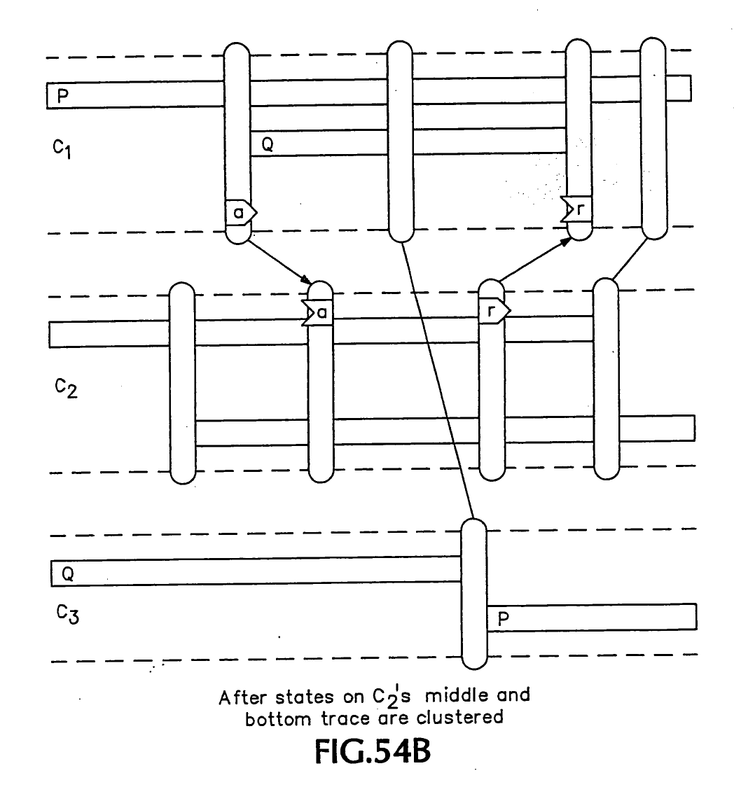

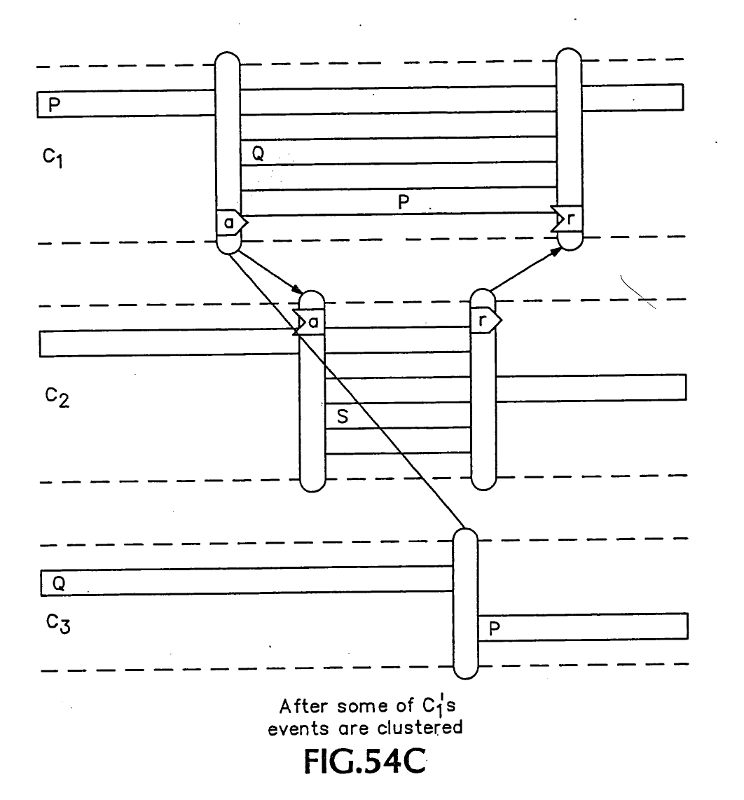

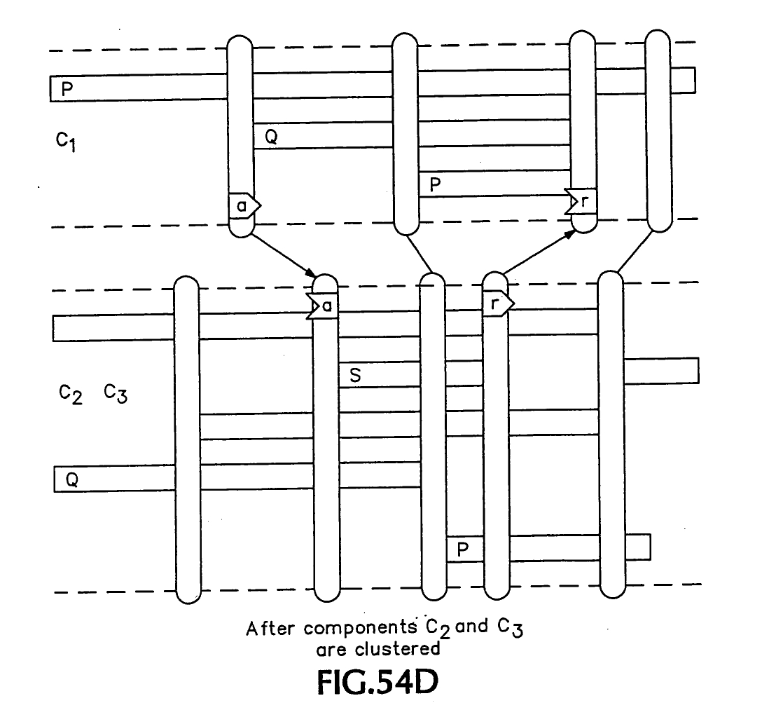

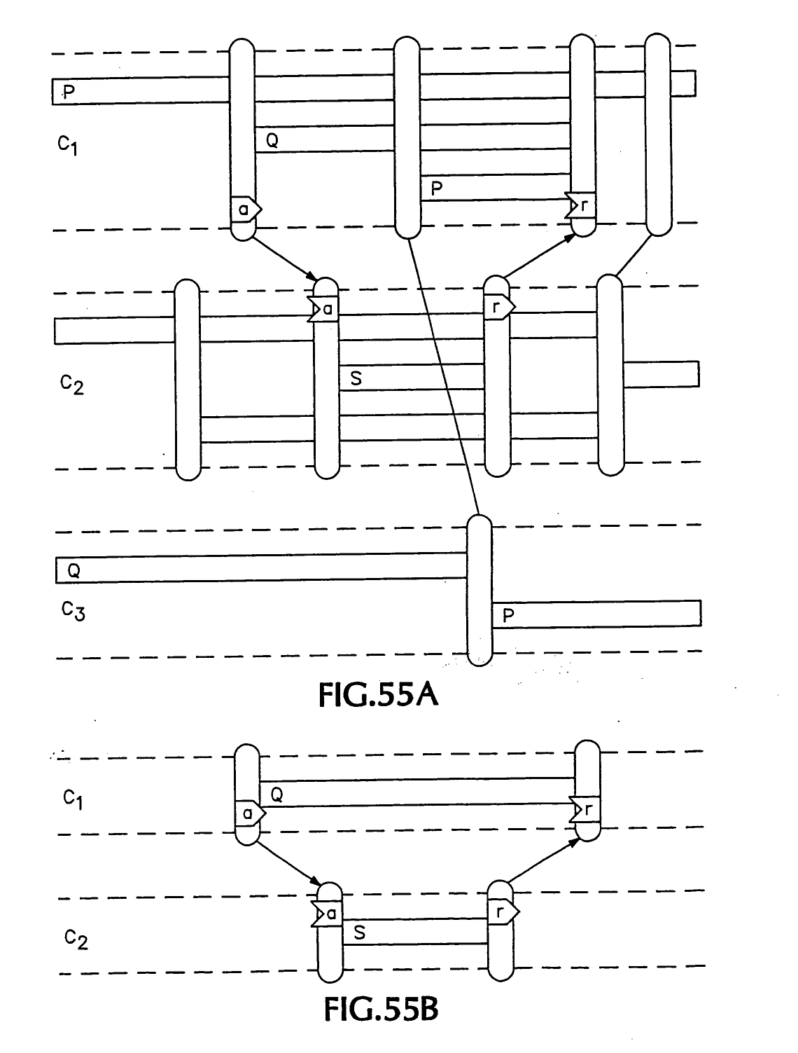

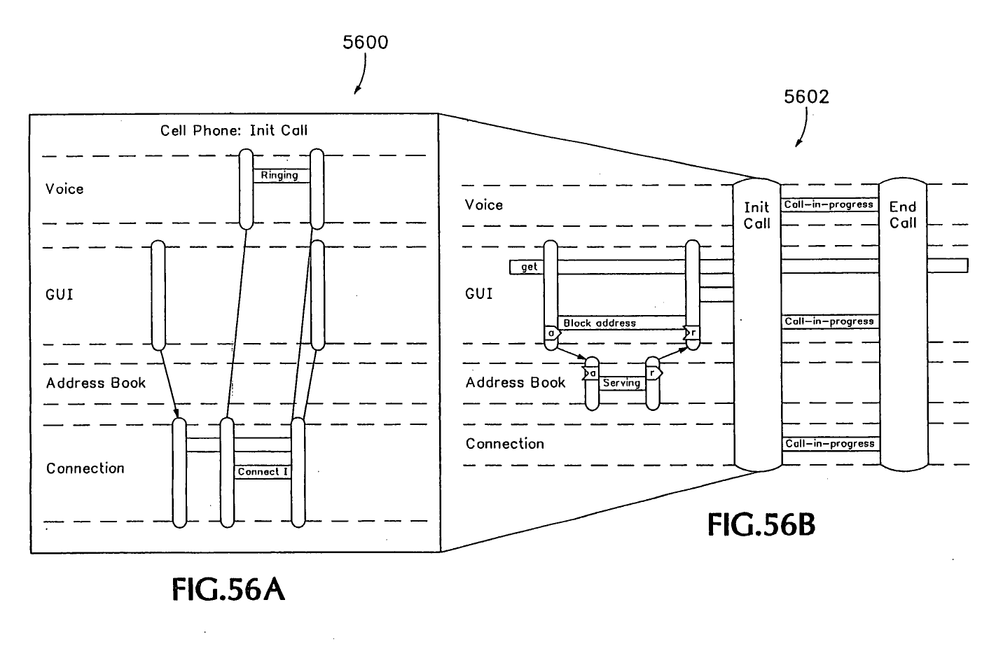

FIGS. 56A and B depict an initiate call transaction 5600 for a cell phone system designed using the coordination-centric design methodology and a visual prototype 5602 for initiate call transaction 5600. In the coordination-centric design methodology a designer can prototype specific behaviors for recognition through the use of a specialized evolution diagram. Component traces are labeled with the names of coordination interface types instead of the name of specific components, and the prototype is given a label. Visual prototypes contain:
Traces for components or component types
Representations of event types
Representations of state types
Implicit causality (ordering of events on a single trace)
Explicit causality (messages and causal links).

Since the form in which behaviors are prototyped resembles the form in which executions are displayed, designers can select sequences of events and states that represent coherent units of behavior and use these as a behavioral model for the debugger to recognize. In some instances the behavioral model may be more specific than the designer wants. To accommodate this situation the designer can detach the behavioral model from specific participants and bind it to components and coordinators whose types can also match the prototype.

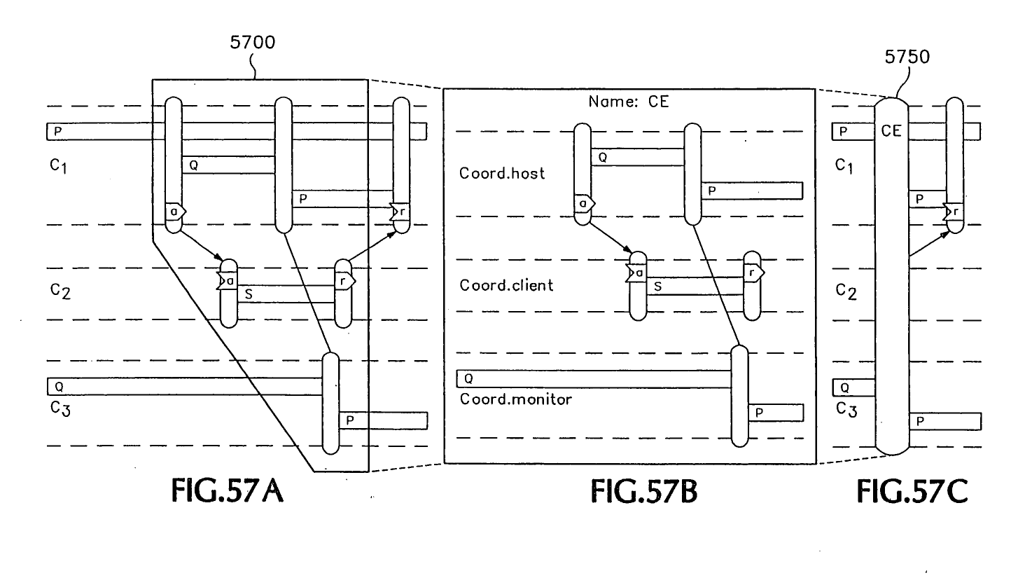

FIGS. 57A, 57B, and 57C show the process of deriving a visual prototype from an execution trace. With reference to FIG. 57A, the designer selects a behavior 5700, made up of a number of events and state changes, representing a particular aspect of the system that is of interest to the designer. With reference to FIG. 57B, the designer refines this behavior by changing the names of specific components to the type names from the relevant coordination interfaces. In this way, the behavior can be abstracted and recognized from any instance of the appropriate coordination interfaces. With reference to FIG. 57C, behavior 5700 is shown as a single event 5750 within the simulator and all instances of behavior 5700 within the evolution diagram of the system simulation will be visually represented in this way. The events that form behavior 5700 and that were selected in FIG. 57A form a convex set of events, meaning no arrows from within the set point outside to causal intermediates for event sequences within the set.

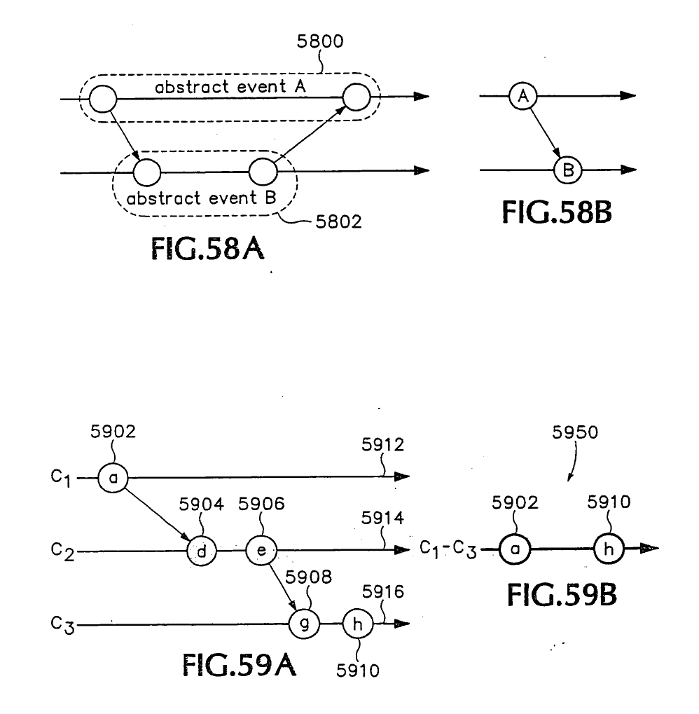

FIGS. 58A and 58B depict a nonconvex set of abstract events: event a 5800 and event b 5802. With reference to FIGS. 58A and 58B, the coordination-centric design methodology allows nonconvex abstract events, unlike the system disclosed in Kunz. In a nonconvex set of abstract events an apparent causal relationship between the set of abstract events is displayed. The abstract event containing the primitive event to the left of the first causal link between two abstract events is considered to be causally to the left, or in the past. Abstract event a 5800 would be presented as causally to the left of abstract event b 5802

Visual prototypes are useful not only for modeling abstract events, but for describing test benches for system executions and for representing real-time constraints.

A. Visual Test Benches

A visual test bench is a series of inputs injected into a system to test the system. An evolution diagram can be used as a test bench to generate test values for debugging and tracking the execution of the system. This allows the simulator to highlight sections where the actual execution differs from the expected execution.

B. Real-Time Information

Real-time information can be included in an evolution diagram as a set of control states. Including this real-time information helps designers determine whether a timing constraint on event separation for the system is being violated and, if so, where the violation is occurring. A variety of types of timing constraints can be represented in an evolution diagram:
Minimum timing separation
Maximum timing separation
Rate

Minimum and maximum timing separation constraints can be visualized in evolution diagrams as system-based modes that span the duration of the constraint, with causal links back to the constrained events. With rate constraints the system or designer considers average distances between several repetitions of a set of events, rather than simply distances between event instance pairs. Although evolution diagrams can be used to represent rate constraints, they are not the preferred tool for rate constraints.

3. Behavioral Expressions

Visual prototypes are typically not expressive enough to represent branching behavior of a system. Branching behavior occurs when more than one partial sequence of primitive events is capable of producing an abstract event or repetitive behavior. A standard form is needed for describing the sequences that comprise abstract events. To allow legible and flexible representations of branching behavior, the coordination-centric design methodology provides a form of lexical expression called behavioral expressions.

A behavioral expression is the underlying representation for behavioral abstraction. A behavioral recognition tool can match behavioral expressions against an execution trace to extract predetermined behaviors that can be presented to a designer. Behavioral expressions are typically more expressive than visual prototypes, because behavioral expressions allow behavioral branches and star operators. Behavioral expressions are expressions on event records. Therefore, state is tracked by recording events that cause state changes.

Each behavioral expression operates within a behavioral perspective, which is a partially ordered set (hereinafter poset) (→E) where → is an immediate predecessor relation and E is a set of events, {e₀, e₁, e₂, . . . eₙ}, from a system trace. Behavioral expressions let designers hide irrelevant causal intermediates. FIG. 59A illustrates causal intermediates in interactions between leaf components a 5902, d 5904, e 5906, g 5908, and h 5910 in a system (not shown) (i.e., components with no hierarchical children).

Behavioral perspectives are used to scope behavioral recognition. Behavioral expressions include any appropriately ordered (consistent with execution occurrence) set of event records from an execution of a system. The absolute perspective, P_{A}, includes all events that can be generated by the system at all levels of hierarchy. Each behavioral expression is matched to events from a system execution trace relative to its specific behavioral perspective. One effect of this is that events that are not immediately causal in the absolute perspective may be recognized as being immediately causal in an individual expression's perspective.

Designers typically choose behavioral perspectives that mask events that are causally related to events in behavioral recognition targets but are irrelevant in the given behaviors. Here, failing to mask could result in missing valid targets, for example, a behavioral perspective may filter out events generated by an RPC server in obtaining a return value that would prevent a behavioral expression from recognizing the RPC transaction. In this case, recognition can also be improved by loosening the causal relationships within a behavior model.

FIG. 59B shows a perspective that clusters the three components C1 5912, C2 5914, and C3 5916 of FIG. 59A and filters events d 5904, e 5906, and g 5908. With reference to FIG. 59B, a new perspective 5950 shows events a 5902 and h 5910 to be immediately causal.

Every visual prototype of a behavior generates a behavioral expression. These expressions can be manually edited by designers; however, these modified expressions cannot always be read back into a visual prototype. This is because prototypes do not support all features of behavioral expressions; alterations in the expression cannot be parsed back into a visual prototype.

Behavioral expressions are similar to regular expressions, but, as shown in Table 6, they can also include the causal operators discussed above.

TABLE 6
Operators for behavioral expressions.

| | |
|---|---|
| Symbol | Description |

Regular operators

| | |
|---|---|
| 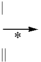 | Boolean OR between expressions Zero or more causal repetitions Zero or more concurrent expressions |
| * | Grouping |
| () | |

Causal operators

| | |
|---|---|
| 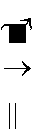 | Causality Immediate causality Concurrence |

The behavioral expression for the interactions prototyped in FIG. 57B is
CE=Coord.host.a.send→((Coord.client.a.rec→Coord.client.r.send)∥(+Coord.host.P→+Coord.monitor.P))

The syntax for behavioral expressions is as follows:
exp::=event
exp::=exp [symbol] exp
exp::=exp→exp
exp::=exp∥exp
exp::=exp|exp
exp::=exp→*
exp::=exp∥*

The causal, immediate causal, and concurrent operators identify the order in which subexpressions should be found; thus these are called ordering operators. Note that the ∥ and the | operators represent two completely different concepts. The syntax exp₁ ∥exp₂ indicates that both exp₁ and exp₂ must be recognized and that there is no causal relationship between them; exp₁|exp₂ means either exp₁ or exp₂ can be recognized, and any causality between them is irrelevant.

A. Expressiveness of Behavioral Expressions

In some ways, behavioral expressions resemble temporal logic predicates as disclosed and discussed above. Both are able to express relationships between system behaviors over periods of time. Behavioral expressions differ from temporal logic in that temporal logic is most useful in expressing relationships between system states (e.g., the state in which a and b are simultaneously true may lead to a state in which a is true and b is false) and behavioral expressions are used to express relationships between events (e.g., event e₁ precedes events e₂ and e₃, which are concurrent).

At some level, all changes in state are caused by events, and all significant events cause changes in state (e.g., message arrival events change the state of the recipient queues). However, it typically makes little sense to represent certain types of events as changes in state or certain states as a set of events that caused the states. For example, if a designer wanted to trace a message receipt event, the designer would need both the state of the queue before the event and the state of the queue after the event.

To express a state relationship with a behavioral expression, the designer describes the state relationship in terms of a relationship between a set of events that cause the state. Typically, it is difficult, if not impossible, to express some very simple concepts, such as concurrent state, in this fashion. For example,
+a∥+b∥+c
   is insufficient to represent an instance in which modes a, b, and c are all active. The modes can be concurrently active even when there are causal relationships between their activation events.

B. Translating Visual Prototypes into Behavioral Expressions

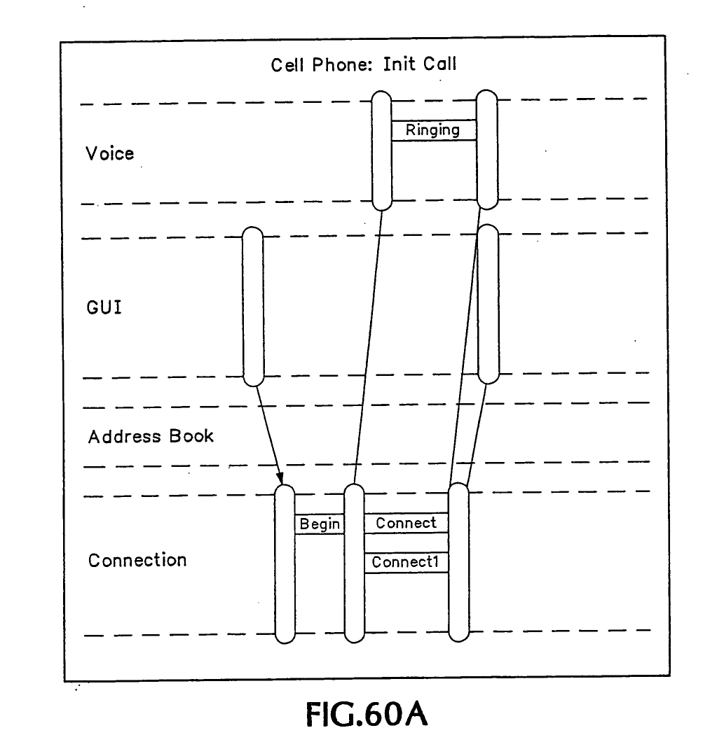

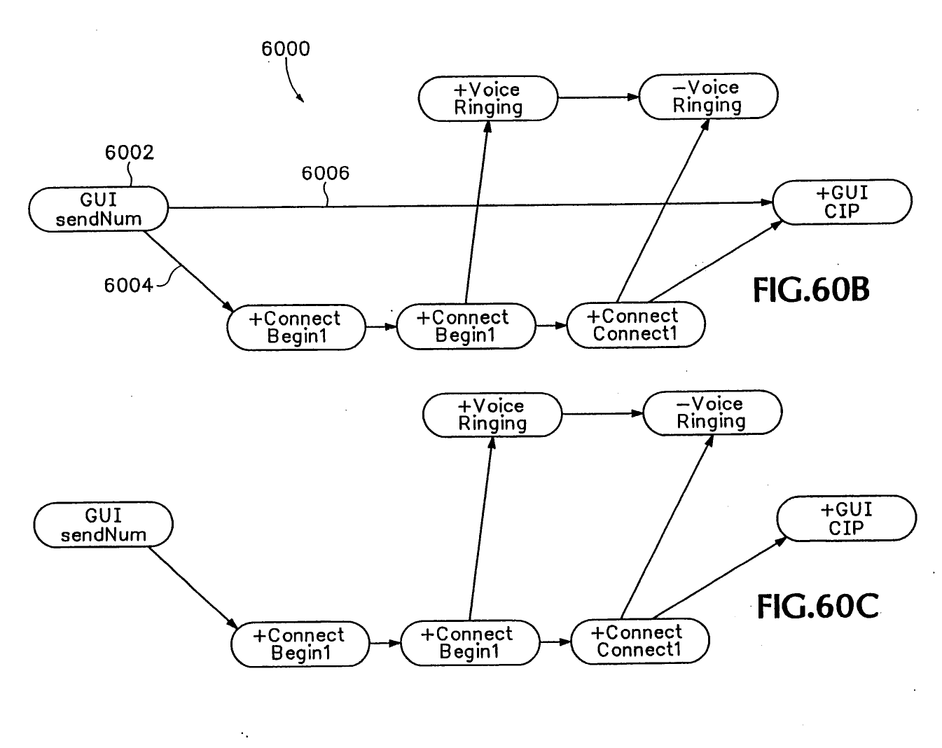

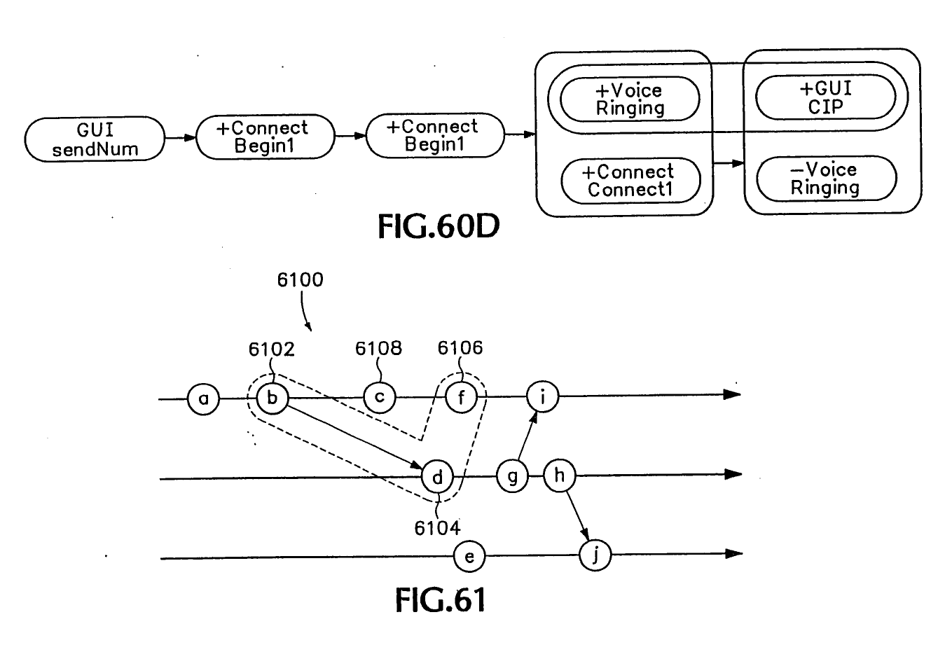

There are four steps in translating visual prototypes into behavioral expressions. FIG. 60A depicts visual prototype 5602 for initiate call transaction 5600. FIGS. 60B, 60C, and 60D show the first three of the four steps for translating visual prototype 5602 into a behavioral expression, respectively. With reference to FIG. 60B, an event causality graph 6000 is created for the visual prototype. Creating the event causality graph involves the following steps: (1) creating an event node 6002 for each event record in the prototype, (2) adding edges 6004 for explicit causality, and (3) adding edges 6006 for implicit causality based on ordering within a component trace.

With reference to FIG. 60C, causally redundant edges in the event graph of FIG. 60B are pruned back. Essentially, any edge 6006 whose absence does not alter the causal relation ( [symbol] ) represented by the event graph in FIG. 60B is removed. This step is performed by checking each event's immediate predecessors to determine whether one is causally related to the other. For example, if event c has a and b for immediate predecessors, and a [symbol] b, then a can be ignored as a predecessor. The edge GUI.SendNum→+GUI.CIP is removed because it is redundant with a sequence of events in the Connect component.

With reference to FIG. 60D, concurrent nodes that progress forward in time are clustered together.

The final step for translating a visual prototype into a behavioral expression is to represent each cluster of nodes as a parenthetical and represent each causal chain in terms of the causal relation, branching for cluster overlap. For the example given in FIGS. 60A, 60B, 60C, and 60D, the final step yields:
Call_Init:=GUI.SendNum →+Connection.Begin→+Connection.Connect →((−Connection.Connect∥+Voice.Ringing) →(−Voice.Ringing∥+GUI.CIP)) |(((−Connection.Connect→+GUI.CIP) ∥+Voice.Ringing)→−Voice.Ringing_{—}

C. Twinned Expressions

Twinned expressions are pairs of related behavioral expressions. A distinguishing factor of twinned events is that they share event instances. Two key issues involved in twinning are (1) identifying events from a single source and (2) ensuring that event instances recognized by each expression are the same instances as in the expressions to which it is twinned. We do this by applying free variable subscripts to event instances. For example, twinning P_Guard: =xₐ [symbol] qa with P:=xₐ→cₐ→qₐ requires that both xₐ's refer to a particular event instance and that both qₐ's refer to one another. In this example, the first expression is known as a guard expression for the second, because it can often indicate a failure when it occurs in isolation.

D. Detecting Behavioral Errors

Behavioral expressions can be very useful in identifying explicit error conditions. Designers can build visual prototypes or behavioral expressions to model error conditions (for example, specific transaction failures).

Overlapping expressions help detect specific failures. For example, the expression for recognizing an RPC transaction is:
RPC.trans:=+client.blocked→client.send→+server.serving→server.send→(−server.serving∥−client.blocked)
However, it is an error if −client.blocked precedes client.receive. We can express this as:
RPC_fail:=+client.blocked [symbol] ((−client.blocked∥client.receive)|(−client.blocked [symbol] client.receive))

Along with overlapping expressions, overly general expressions can be used with expressions for specific sequences to detect variance from expected sequences. For example, in addition to the RPC_trans expression given above, we could also include an expression RPC_gen:=+client.blocked [symbol] −client.blocked, which recognizes all complete, and many incomplete, transactions.

4. Trace Interpretation

The last section introduced behavior models, which describe multipaths through partially ordered concurrent event traces. This section describes a technique for interpreting execution traces to recognize specific behaviors in concurrent, asynchronous event streams. Such trace interpretation is similar to temporal logic verification. However, where verification attempts to determine whether a system can ever enter particular states, and is therefore limited in the size and form of the statespace, trace interpretation is largely independent of these factors.

Although trace interpretation resembles language recognition, where a language defines a set of strings of characters from some alphabet, it differs because language recognition is based on an assumption that strings are found in totally ordered character streams. We must work with partially ordered event streams.

To simplify evaluation semantics, the event parser can still parse events one at a time in linear order (based on a topological sort), but this means that the event parser must also track event causality. FIG. 61 shows a space/time graph 6100 that illustrates that it is not enough to assume that causality follows parse order. With reference to FIG. 61, when the behavioral recognizer seeks a sequence of events b 6102→d 6104→f 6106, the parse order delivers an intermediate event c 6108 between events b 6102 and d 6104. In the underlying graph, however, there is no intermediate, so the sequence should not be rejected on that point. The parse order also delivers event f 6106 immediately after event d 6104. But in space/time graph 6100, there is no causal link between events d 6104 and f 6106. Thus the sequence should be rejected on this point because event d 6104 is not an immediate predecessor of event f 6106 as specified in the behavioral expression.

There are several hazards to be avoided in the linear parsing of partially ordered streams:
False causality—where two events appear related only as an artifact of the parsed observation.
Hidden concurrence—where concurrent events are not detected as being such, even though they may not be detected as causally related either.
Interleaving sensitivities—where the order in which events are interleaved affects recognition.
Intersecting paths—where one event is a member of two valid and present sequences (related to twinning, but the effect may be unintentional).
Multiple immediate successors. In sequential streams, if it is known that a immediately follows an instance of c, we can also assume that b does not immediately follow that instance. However, that assumption cannot be made in a system with concurrent streams.

Many approaches use two recognition phases: (1) linear sequence recognition through finite automata and (2) relational checking. These can run into problems because the automata can reject partially ordered sequences that actually match the high-level specified relationships due to the specific linear order in which events are presented.

To balance these issues, the present invention employs a trace interpretation technique that uses behavioral automata. In the remainder of this section, we define behavioral automata and then describe two implementation details addressed in our implementation: dead traversals and hidden branching.

A. Behavioral Automata

Complex behaviors in evolution diagrams can be recognized through behavioral automata. Behavioral automata differ from automata used in other approaches in that they implicitly check causal relationships. Behavioral expressions can be directly translated into behavioral automata.

We use an evaluation scheme that considers events one at a time. We use Lamport ordering because it is easy to perform on the fly. Although this approach may seem to create the illusion that events are totally ordered, we maintain causality not only by this ordering, but by placing events in explicit dependency graphs and assigning each event a vector time. The explicit dependency graph is necessary to determine immediate precedence, and vector time is required not only to determine general causal relations, but also to determine concurrence.

On recognition of a partially ordered event sequence, a behavioral automaton replaces the recognized events with a replacement sequence. The replacement sequence is typically just a new, higher-level event.

A behavioral automaton is typically an 8-tuple (P, E, Q, δ, B, e₀, F, e_{f}) where:

P is a set of behavioral perspectives, each enabled by configurations.
E is an alphabet of events.
Q is a set of state, labeled with the symbols → or [symbol] .
δ⊂Q×Σ×Q is the transition relation.
B⊂δ×δ s a set of bars (relationships between elements of the transition relation). These are used to represent concurrent event recognition.
eₒ is the initial traversal trigger event.
F is a set of finishing states.
e_{f} is an event generated on finishing.

Node qualification labels are one of {→, [symbol] }∪Ø, which means that no qualified state may be departed by the system unless the event on the outgoing edge is appropriately related to the event on the incoming edge. Each automaton has an initial event. An occurrence of this initial event instantiates an automaton, which then tries to recognize the rest of the behavior. Graphic representations of behavioral automata resemble graphic representations of nondeterministic finite automata (NFA). Nodes represent states, and edges represent terms in the transition relation. Unlike NFAs, however, there is an initial event that begins a traversal but no unique initial state.

An event alphabet includes all primitive events, given the behavioral perspective, but also abstract events generated by other automata. Event records are typed data structures, as shown in Tables 7 and 8. The vector time field is used to determine whether two events are causally related; the immediate predecessors are used to determine whether there are any causal intermediates between two causally related events.

TABLE 7
The fields of an event structure.

| Field | Description |
|---|---|
| event type | class of an event instance |
| source component | component from which it came |
| Name | name of an event instance |
| Data | Accompanying arguments |
| immediate predecessors | pointers to records for events that precede |
| | this |
| vector time | a vector timestamp for this event |
| real time | a real timestamp for this event |

TABLE 8
An event type description.

| | |
|---|---|
| type name | RPC argument send |
| supertype | token send |

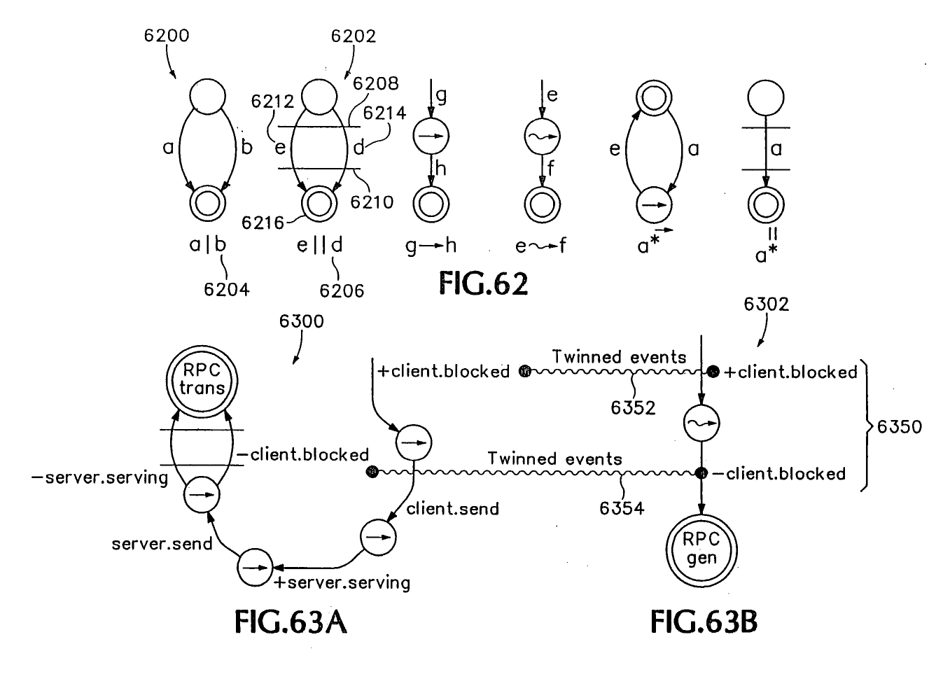

FIG. 62 shows various automata segments along with their corresponding behavioral operator located underneath the automata segments. With reference to FIG. 62, notice the difference between translations 6200 and 6202, respectively, of an | operator 6204 and an ∥ operator 6206. A set of bars 6208 and 6210 connecting an incoming edge e 6212 and an incoming edge d 6214 to a node 6216 indicate a conjunctive join, and node 6216 cannot be entered via a barred edge, either edge e 6212 or edge d 6214, unless edge e 6212 and edge d 6214 are both traversed. Bars connecting outgoing edges on a node indicate causal mutual exclusion, i.e., none of the paths traversed by outgoing edges can have causal dependencies between them. A well-formed automata will match each outgoing bar 6208 with an incoming bar 6210 for common node 6216.

Behavioral abstraction for a complete execution is performed with a system of behavioral automata, which is a three-tuple (B, T, V) where:
B is a set of behavioral automata.
T⊂∪bᵢ, bⱼ Σ_{B} bi.Σ×bⱼ.Σ is the twinning relation between all automata in the system.
V is a set of traversals over automata in B.

FIGS. 63A and B show a full system of behavioral automata 6300 and a generalized system of behavioral automata 6302, respectively, that both recognize an RPC transaction. With reference to FIG. 63A, an entry event 6304 and a terminating node 6306 that signifies an “RPC trans” event generation 6308 are depicted. With reference to FIG. 63B, a generalized system of behavioral automata 6302 that recognizes a relationship +client.blocked [symbol] −client.blocked 6350 is shown. A pair of lines 6352 and 6354 between full system of behavioral automata 6300 and generalized system of behavioral automata 6302 illustrate the twinning relation for this system.

Unlike shuffle automata and standard nondeterministic automata, which both require causality checks after sequence recognition, behavioral automata have built-in causality semantics. Therefore, behavioral automata avoid the hazards described above.

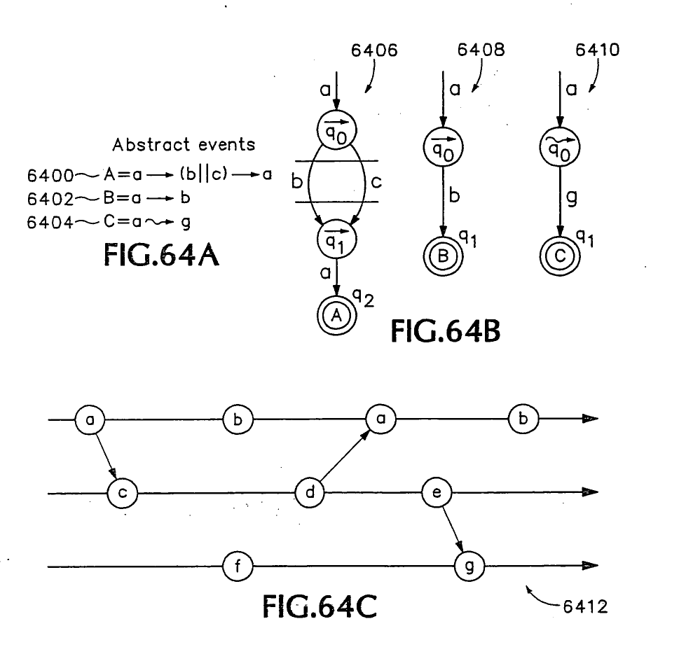

Behavioral automata execute concurrently and nondeterministically. The nondeterminism is modeled by forked traversals. Each time a disjunctive fork is encountered in a behavioral automaton, a new traversal is forked. Since automata traversals do not preserve path information, their time and space requirements are comparable to those of dynamic subset construction algorithms for standard NFAs. As such, each event parsed is used in as many traversals as possible. FIGS. 64A, B, and C show several behavioral expressions A 6400, B 6402, and C6404; their automata 6406, 6408, and 6410, respectively; and a space/time diagram 6412 representing an execution.

To assist in interpreting FIGS. 64A, B, and C, we list in Table 9 the traversals of all automata with respect to the sequence given in FIG. 64C.

TABLE 9
Traversals of automata in FIG. 64.

Traversal

| Event | A₀ | B₀ | C₀ | A₁ | B₁ | C₁ |
|---|---|---|---|---|---|---|
| a₀ | q₀ | q₀ | q₀ | | | |
| f₀ | q₀ | q₀ | q₀ | | | |
| b₀ | cb₀ | q₁ | q₀ | | | |
| c₀ | q₁ | | q₀ | | | |
| d₀ | q₁ | | q₀ | | | |
| a₁ | q₂ | | q₀ | q₀ | q₀ | q₀ |
| e₀ | | | q₀ | q₀ | q₀ | q₀ |
| b₁ | | | q₀ | cb₀ | q₁ | q₀ |
| g₀ | | | q₁ | cb₀ | | q₁ |

B. Removal of Dead Traversals

Each concurrent traversal requires memory, to keep track of its current state, and processing power, to check each new event against its requirements. Therefore, it is essential to remove dead traversals, or traversals waiting for impossible events. One trivial example is a traversal that just generated a finishing abstract event; however, it is also possible for traversals to die before producing their finishing event. For example, in the case of immediate precedence, dead traversals occur when none of the outgoing edges from the leading node is sufficient to allow travel to any of the next nodes. A dead traversal once detected is deleted.

C. Hidden Branching

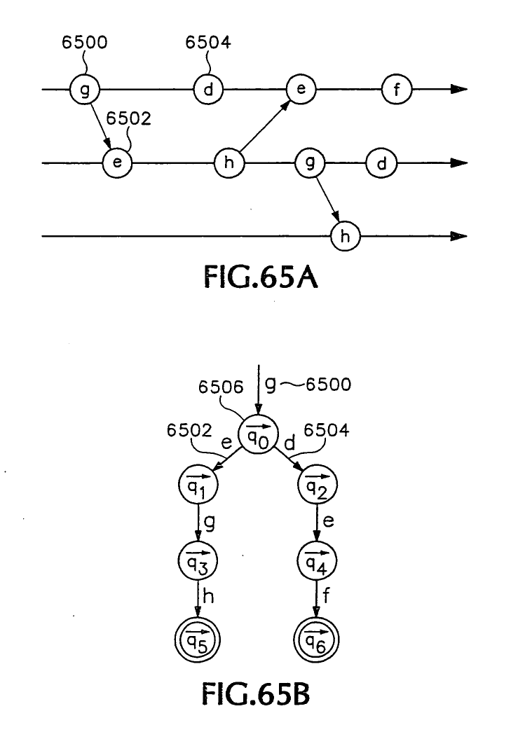

In standard NFAs, it is necessary to branch traversals only when a state's outgoing edges are identically marked. With behavioral automata, branching may be necessary even when outgoing edges are differently marked. FIGS. 65A and B and Table 10 show an example of a system (not shown) in which branching may be necessary even when outgoing edges are differently marked. With reference to FIGS. 65A and B, event g 6500 has two immediate successors, event e 6502 and event d 6504, and the traversal must be branched q0 6506 to allow recognition of the sequence g→d→e→f.

TABLE 10
A hidden branch for a forking automation.

| | Traversal | | |
|---|---|---|---|
| Event | 10 | 20 | 30 |
| g0 | q0 | | |
| e0 | q1 | | |
| d0 | q1 | q2 | |
| e1 | q1 | q4 | |
| h0 | delete | q4 | |
| g1 | | q4 | q0 |
| f0 | | q6 | q0 |
| h1 | | | q0 |
| d1 | | | q2 |

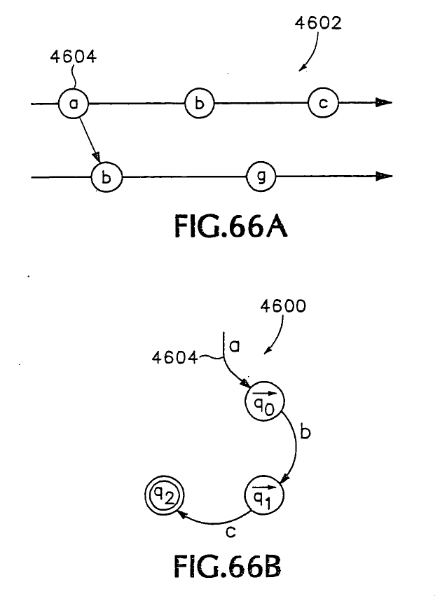

FIGS. 66A and B and Table 11, show that it may be necessary to branch traversals even when no branch exists in a relevant behavioral automaton 6600. With reference to FIG. 66A, space time diagram 6602 shows that event a 6604 has branching behavior even though the relevant automaton 6600 for event a 6604, as shown in FIG. 66B, does not branch. Thus the space required for traversals can grow very rapidly, if not used wisely. Growth is particularly sensitive to a number of factors such as the number of general causal expressions, the number of star operators, and the amount of immediate ambiguity in event tracing.

TABLE 11
A hidden branch in an automaton with no forks.

Traversal

| Event | 10 | 20 |
|---|---|---|
| a0 | q0 | |
| b0 | q1 | |
| b1 | q1 | q1 |
| g0 | delete | q1 |
| c0 | | q1 |

Typically, however, the system reaches a point beyond which there is zero growth. For example, Table 12 shows the number of traversals that are simultaneously active given the cell phone system and the behavioral expressions:
Outgoing_call:=GUI.number.send→
Connection.number. get→Connection.setup.number

TABLE 12
Growth rate over time for cell phone with no errors.

Traversals

| Time | lookup | handoff | Terminate | total |
|---|---|---|---|---|
| t₀ | 1 | — | — | 1 |
| t₁ | 0 | 1 | — | 1 |
| t₂ | 0 | 1 | — | 1 |
| t₃ | 0 | 0 | 1 | 1 |

The table shows that there is no growth in the number of simultaneous traversals required for behavioral abstraction with a single phone. Despite concurrent components, there is little concurrent behavior. For a system with n phones, we would expect traversals on the order of n. This is evidenced by the data in Table 13.

TABLE 13
Growth rate over time for eight cell phones with no errors.

Traversals

| Time | lookup | handoff | terminate | total |
|---|---|---|---|---|
| t₀ | 2 | — | — | 2 |
| t₁ | 0 | 1 | — | 1 |
| t₂ | 3 | 1 | 1 | 5 |
| t₃ | 1 | 2 | 1 | 4 |
| t₄ | 0 | 1 | 0 | 1 |
| t₅ | 2 | 2 | 3 | 7 |
| t₆ | 0 | 1 | 1 | 2 |
| t₇ | 1 | 2 | 1 | 4 |

It will be obvious to those having skill in the art that many changes may be made to the details of the above-described embodiments of this invention without departing from the underlying principles thereof. The scope of the present invention should, therefore, be determined only by the following claims.

1-7. (canceled)

8. A method for transforming a visual prototype into a behavioral expressions comprising:
creating an event causality graph for the visual prototype removing any causally redundant edges in the event causality graph; and
creating a cluster representing any concurrent nodes that progress forward together in time.

9. A method according to claim 8 wherein transforming a visual prototype into a behavioral expression further comprises:
creating a representation for each created cluster of nodes;
representing any causal chains between clusters in terms of a causal relation; and
branching each causal chain, if branching is needed in order to account for any overlapping clusters within the causal chain.

10. A method according to claim 8 wherein creating the event causality graph comprises:
creating an event node for an event record in the visual prototype; and
adding an edge between a first and a second event, from the event record, to represent explicit causality between the first event and the second event.

11. A method according to claim 10 wherein creating the event causality graph further comprises adding an edge between a third and a fourth event, from the record of system events, representing implicit causality between the third and the fourth events based on the ordering of the third and the fourth event within a component trace.

12. A method according to claim 11 wherein removing the causally redundant edge comprises checking the immediate predecessor of each event to determine whether an event is causally related to its immediate predecessor.

13-30. (canceled)

31. A method for transforming a visual prototype into a behavioral expression comprising:
creating an event causality graph for a visual prototype;
pruning back any causally redundant edges in the event causality graph;
creating one or more clusters of nodes by clustering two or more concurrent nodes in the event causality graph that progress forward in time; and
translating the one or more clusters of nodes into a behavioral expression.

32. The method of claim 31, wherein creating the event causality graph comprises:
creating two or more event nodes by creating an event node for each event record in the visual prototype;
adding an edge between the one or more event nodes for explicit causality; and
adding an edge between the one or more event nodes for implicit causality.

33. The method of claim 32, wherein the edges added between the one or more event nodes for implicit causality is based on an ordering within a component trace.

34. The method of claim 31, wherein pruning back any causally redundant edges in the event causality graph comprises removing any edge in the event causality graph whose absence does not alter a causal relation represented by the event causality graph.

35. The method of claim 31, wherein translating the one or more clusters of nodes into a behavioral expression comprises:
creating a representation for each of the one or more clusters of nodes;
representing any causal chains between the one or more clusters of nodes in terms of a causal relation; and
branching each causal chain, if branching is needed in order to account for any overlapping of the one or more clusters of nodes within the causal chain.

36. The method of claim 31, wherein the visual prototype is a user specified evolution diagram.
